(19) United States
(12) Patent Application Publication
(10) Pub. No.: US 2023/0082471 A1
(43) Pub. Date: Mar. 16, 2023

(54) TONER PROCESSING APPARATUS AND TONER PRODUCTION METHOD

(71) Applicant: CANON KABUSHIKI KAISHA, Tokyo (JP)

(72) Inventors: Yasuhiro Hashimoto, Shizuoka (JP); Shotaro Nomura, Shizuoka (JP)

(21) Appl. No.: 17/890,956

(22) Filed: Aug. 18, 2022

(30) Foreign Application Priority Data
Aug. 27, 2021 (JP) 2021-138732

(51) Int. Cl. G03G 9/08; G03G 15/08

(52) U.S. Cl. CPC G03G 9/0808; G03G 15/0887

(57) ABSTRACT

A toner processing apparatus for processing an object comprising a toner particle and an external additive, the toner processing apparatus comprising: a processing chamber in which the object is accommodated; a drive shaft rotatably provided at a bottom of the processing chamber; and a rotating member pivotally supported on the drive shaft; wherein the rotating member comprises a rotating member body; and a protruding portion protruding from an outer peripheral portion of the rotating member body, outward in a radial direction; the rotating member comprises a processing member processing the object by colliding at the protruding portion; the processing member constitutes a part or an entirety of the protruding portion; the rotating member body and the processing member can be separated; the rotating member body comprises a projecting parts protruding in a direction in which the rotating member rotates; and the processing member fits with the projecting parts.

### BACKGROUND OF THE INVENTION

### Field of the Invention

The present disclosure relates to a toner processing apparatus for developing an electrostatic image used for image formation in accordance with an electrophotographic method, and relates to a method for producing the toner.

### Description of the Related Art

The development of electrophotographic systems has been accompanied by a demand for toners that afford higher image quality and higher speeds. Ordinarily, the toner in the form of an external additive is used in a state where fine particles, in particular inorganic fine particles, are fixed to the surface of a toner particle, for the purpose of controlling charging performance and imparting flowability. As a method of causing an external additive to adhere to the surface of a toner particle, an object to be processed comprising the toner particle and the external additive is mixed and caused to collide, by a blade that is stirred at high speed within a processing chamber, to fix the external additive to the surface of the toner particle.

When such an external addition treatment is repeated over a long period of time, the collision portion of the blade that collides with the object to be processed may wear down and deteriorate. As wear progresses, not only the strength of the stirring blade itself decreases, but also it becomes difficult to fix the external additive to the surface of the toner particle with a desired strength.

Image defects derived from lumps of external additive that have not been to deagglomerated may occur in a case where the external addition treatment cannot be performed with the required strength. Moreover, free external additive that is not fixed to the toner particle may contaminate a charging member and so forth, which may give rise to image defects caused by member contamination.

It is therefore necessary to suppress deterioration derived from wear of the external addition treatment device. In order to increase the mechanical strength of the toner production apparatus, crushing equipment has been proposed (Japanese Patent Application Publication No. 2008-100188) that exhibits enhanced wear resistance achieved by treating the surface, of various production apparatus members for instance by plating.

Further, a mixing device comprising a rotating member that performs an external addition treatment has been disclosed (Japanese Patent Application Publication No. 2017-026915) that the rotating member can be separated vertically, at a plane perpendicular to a drive shaft, into a processing portion having a collision portion at which the rotating member collides with the object to be processed, so that the object is processed thereby, and into a rotating member main portion. In the mixing device described above, maintainability can be improved by replacing only the processing portion.

### SUMMARY OF THE INVENTION

In Japanese Patent Application Publication No. 2008-100188, it was found that a large mechanical load is exerted on a crushing machine, and wear deterioration of a stirring blade or the like is accelerated, in an external addition treatment in which there is used a toner having added thereto abrasive particles for image adverse effects such as image smearing, or a magnetic body-comprising toner for one component developing, of high specific gravity. As a consequence of wear degradation, not only the toner cannot undergo an appropriate pulverization treatment, but also it becomes necessary to replace the stirring blade itself, and results in the problems of maintainability and economic efficiency, and also productivity on account of equipment stoppage.

Japanese Patent Application Publication No. 2017-026915 involves the problems of maintainability and economic efficiency over long-term use, and productivity derived from equipment stoppage in a case where the rotating member is used with high rotational speed, or in a case where the amount of additive that is added at the time of the external addition treatment is large.

The present disclosure provides a toner processing apparatus that combines economic efficiency and apparatus durability, and also stabilizes the toner quality, and provides a toner production method in which that apparatus is utilized.

At least one aspect of the present disclosure is directed to providing, a toner processing apparatus for processing an object to be processed comprising a toner particle and an external additive, p the toner processing apparatus comprising:
a processing chamber in which the object to be processed is accommodated;
a drive shaft rotatably provided at a bottom portion of the processing chamber; and
a rotating member pivotally supported on the drive shaft; wherein

the rotating member comprises
a rotating member main portion; and
a protruding portion protruding outward in a radial direction from an outer peripheral portion of the rotating member main portion;

the rotating member comprises a processing member processing the object to be processed by colliding against the object to be processed at the protruding portion;

the processing member constitutes a part of the protruding portion or an entirety of the protruding portion;

the rotating member main portion and the processing member can be separated;

the rotating member main portion comprises a projecting parts protruding in a direction in which the rotating member rotates; and

the processing member fits with the projecting parts.

According to one aspect of the present disclosure, a toner processing apparatus for processing an object to be processed comprising a toner particle and an external additive,

the toner processing apparatus comprising:
a processing chamber in which the object to be processed is accommodated;
a drive shaft rotatably provided at a bottom portion of the processing chamber; and
a rotating member pivotally supported on the drive shaft; wherein,

the rotating member comprises
a rotating member main portion; and
a protruding portion protruding outward in a radial direction from an outer peripheral portion of the rotating member main portion;

the rotating member comprises a processing member processing the object to be processed by colliding against the object to be processed at the protruding portion;

the processing member constitutes a part of the protruding portion or an entirety of the protruding portion;

the rotating member main portion and the processing member can be separated;

the rotating member main portion comprises a projecting parts protruding in at least one direction of a circumferential direction of the rotating member; and

the processing member fits with the projecting parts.

The present disclosure can provide a toner processing apparatus that combines economic efficiency and apparatus durability, and also stabilizes the toner quality.

Further features of the present invention will become apparent from the following description of exemplary embodiments with reference to the attached drawings.

### BRIEF DESCRIPTION OF THE DRAWINGS

FIG. 1 is a schematic diagram of a toner processing apparatus;

FIG. 2 is a schematic diagram of a processing chamber;

FIG. 3A and FIG. 3B are a set of schematic diagrams illustrating an example of a stirring blade as a flip-up means;

FIG. 4A and FIG. 4B are a set of schematic diagrams illustrating an example of a rotating member;

FIG. 5 is a diagram (type 2) describing the dimensions of a rotating member (Example 87);

FIG. 6 is a diagram describing the dimensions of a processing member and the periphery of the processing member;

FIG. 7 is a diagram describing the dimensions of a rotating member (Example 1);

FIG. 8A and FIG. 8B are a set of explanatory diagrams of various portions of a rotating member main portion and of a processing member;

FIG. 9 is a schematic diagram explaining the underlying mechanism of the effect of the present disclosure;

FIG. 10 is a schematic diagram of a case where a processing member is positioned relative to, and fixed to, a rotating member main portion;

FIG. 11 is an explanatory diagram of contact points and so forth of respective portions of a rotating member main portion and of a processing member;

FIG. 12 is an explanatory diagram of contact points, starting points, and end points of respective portions of a rotating member main portion and of a processing member;

FIG. 13A to FIG. 13D are a set of explanatory diagrams of contact points and penetration angles of respective portions of a rotating member main portion and of a processing member;

FIG. 14 is an explanatory diagram of a penetration angle of a processing member into a rotating member main portion;

FIG. 15 is an explanatory diagram of contact points and so forth of respective portions of a rotating member main portion and of a processing member;

FIG. 16-1 is an outline view diagram of a rotating member main portion and of a processing member used in examples;

FIG. 16-2 is an outline view diagram of a rotating member main portion and of a processing member used in examples;

FIG. 16-3 is an outline view diagram of a rotating member main portion and of a processing member used in examples;

FIG. 17 is an outline view diagram of a rotating member used in examples;

FIG. 18 is a diagram illustrating the shape of a processing surface of a protruding portion of a rotating body; and

FIG. 19 is a diagram illustrating the shape of a processing surface of a protruding portion of a rotating member.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In the following description, the same number is assigned in the figures to structures that have the same function, and in some instances a description thereof may be omitted.

Embodiments for carrying out the present disclosure will be specifically illustrated below with reference to accompanying drawings. However, the dimensions, materials, shapes and so forth of the constituent components described in the embodiments are to be modified as appropriate depending on the configuration of the members to which the disclosure is to be applied and depending on various conditions. That is, the scope of the present disclosure is not meant to be limited to the embodiments below.

At least one aspect of the present disclosure is directed to providing, a toner processing apparatus for processing an object to be processed comprising a toner particle and an external additive,

the toner processing apparatus comprising:
a processing chamber in which the object to be processed is accommodated;
a drive shaft rotatably provided at a bottom portion of the processing chamber; and
a rotating member pivotally supported on the drive shaft; wherein

the rotating member comprises
a rotating member main portion; and
a protruding portion protruding outward in a radial direction from an outer peripheral portion of the rotating member main portion;

the rotating member comprises a processing member processing the object to be processed by colliding against the object to be processed at the protruding portion;

the processing member constitutes a part of the protruding portion or an entirety of the protruding portion;

the rotating member main portion and the processing member can be separated;

the rotating member main portion comprises a projecting parts protruding in a direction in which the rotating member rotates; and

the processing member fits with the projecting parts.

According to one aspect of the present disclosure, a toner processing apparatus for processing an object to be processed comprising a toner particle and an external additive,

the toner processing apparatus comprising:
a processing chamber in which the object to be processed is accommodated;
a drive shaft rotatably provided at a bottom portion of the processing chamber; and
a rotating member pivotally supported on the drive shaft; wherein,

the rotating member comprises
a rotating member main portion; and
a protruding portion protruding outward in a radial direction from an outer peripheral portion of the rotating member main portion;

the rotating member comprises a processing member processing the object to be processed by colliding against the object to be processed at the protruding portion;

the processing member constitutes a part of the protruding portion or an entirety of the protruding portion;

the rotating member main portion and the processing member can be separated;

the rotating member main portion comprises a projecting parts protruding in at least one direction of a circumferential direction of the rotating member; and

the processing member fits with the projecting parts.

The above configuration suppresses detachment and deformation of components in a scheme of separating and replacing only a portion of collision with an object to be processed, and the periphery of the that portion, which projects from the outer peripheral surface of the rotating member outward in the radial direction, even when replacing only the collision portion and the periphery thereof. It becomes therefore possible to provide a toner processing apparatus that combines economic efficiency and apparatus durability, and also stabilizes the toner quality.

The inventors conjectured the following as the underlying reasons for the effects elicited above. In a conventional mixing apparatus having a rotating member for performing an external addition treatment, the quality of the toner is not stable because the external addition state of the toner changes when the portion of the rotating member that processes the toner wears down.

Some methods for addressing above problem involve replacing the portion of the rotating member that includes the processing portion of the rotating member; however, the part to be replaced is ordinarily fixed with screws. This method is problematic in that the replacement part comes off or deforms readily on account of the load that is borne by the screw portion.

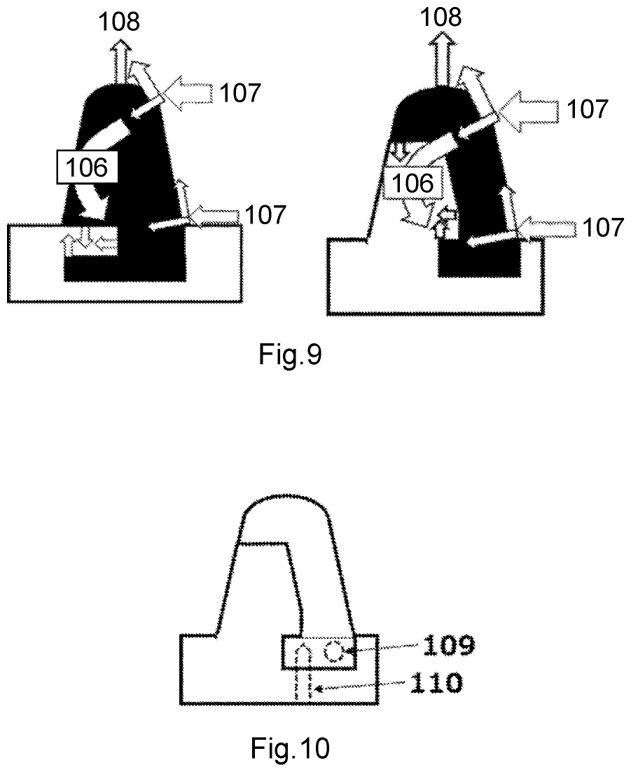

In a scheme that involves separation from a rotating member, and replacement, of only a portion of collision with an object to be processed, and the periphery of the that portion, such that the portion of collision projects from the outer peripheral surface of the rotating member outward in the radial direction, therefore, a configuration is adopted such that the side of the rotating member main portion fits with the portion to be replaced, by way of a specific relief structure. As a result, detachment and deformation of the component can be suppressed even when replacing only the collision portion and the periphery thereof for instance due to the action of the moment of inertia; as a result, both economic efficiency and equipment durability can be achieved, and also stabilizes the toner quality. (FIG. 9)

An explanation follows next, with reference to FIG. 9, on an impact 107 sustained from the object to be processed, the action of a moment of inertia 106 on account of the impact 107, and a centrifugal force 108. Upon rotation of the rotating member, the moment of inertia 106 acts on the processing member on account of the impact 107 derived from the collision with the object to be processed. Thereupon an inward for in the radial direction is exerted onto the rotating member main portion, from the portion of collision with the object to be processed and which projects from the outer peripheral surface of the rotating member outward in the radial direction.

Given that at this time the side of the rotating member main portion towards which the force is exerted has a projecting parts that protrudes in the direction in which the rotating member rotates, a force derived from the moment of inertia 106 acts accordingly, inwardly in the radial direction of the rotating member main portion, on the projecting parts. Since the processing member fits with the projecting parts, a force acts on the projecting parts, so as to pinch the latter it in the radial direction of the rotating member.

As a result, the centrifugal force 108 is countered not only by a force derived from the moment of inertia 106, in the opposite direction to that of the centrifugal force 108, but also by the force acting so as to pinch the projecting parts in the radial direction of the rotating member, elicited by the fitting structure. The processing member becomes firmly fixed to the rotating member in the radial direction on account of these forces, and as a result it becomes possible to prevent the processing member from coming off the rotating member, and to prevent positional deviation of the processing member.

The projecting parts is oriented herein so as to protrude in the direction in which the rotating member rotates, and hence the force derived from the moment of inertia 106 and that acts on the portion, of the fitted processing member that is present furthest inward in the radial direction of the rotating member, is oriented inward in the radial direction of the rotating member. It is deemed that, in consequence, the processing member can be further prevented from coming off the rotating member main portion, and positional deviation of the processing member can be further suppressed.

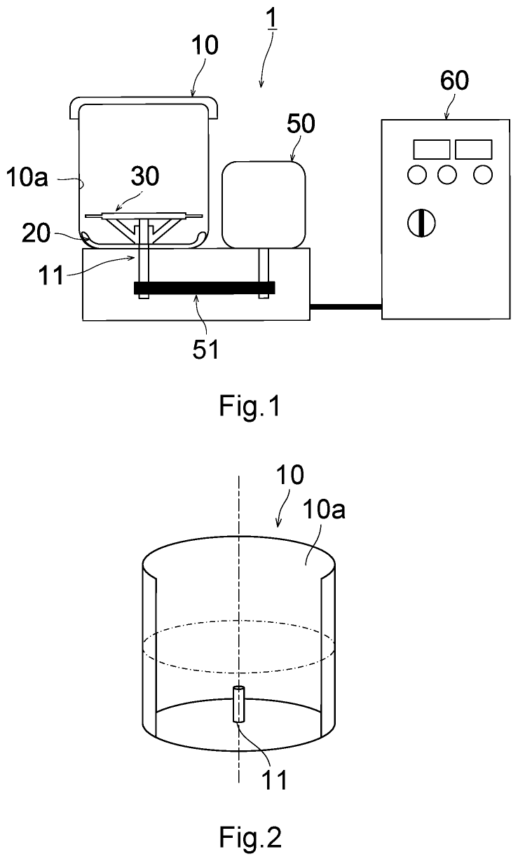

Specifically, the toner processing apparatus following can achieve above effects (FIG. 1, FIG. 2, FIG. 4 and FIG. 8);

A toner processing apparatus for processing an object to be processed comprising a toner particle and an external additive,

the toner processing apparatus comprising:
a processing chamber in which the object to be processed is accommodated;
a drive shaft rotatably provided at a bottom portion of the processing chamber; and
a rotating member pivotally supported on the drive shaft; wherein

the rotating member comprises
a rotating member main portion; and
a protruding portion projecting from an outer peripheral portion of the rotating member main portion, outward in a radial direction;

the rotating member comprises a processing member processing the object to be processed by colliding against the object to be processed at the protruding portion;

the processing member constitutes a part of the protruding portion or an entirety of the protruding portion;

the rotating member main portion and the processing member can be separated;

the rotating member main portion comprises a projecting parts protruding in a direction in which the rotating member rotates; and

the processing member fits with the projecting parts.

Toner Processing Apparatus

For instance the above configuration can be adopted in a known mixer such as FM mixer (by Nippon Coke & Engineering Co., Ltd.) or Super mixer (by Kawata Manufacturing Co., Ltd.), as toner processing apparatuses.

FIG. 1 illustrates a schematic diagram of a toner processing apparatus 1. The toner processing apparatus 1 comprises a processing chamber (processing tank) 10 having a bottom portion and a cylindrical inner peripheral surface 10a, a drive shaft 11 rotatably provided at the bottom portion of the processing chamber, and a rotating member 30 supported on the drive shaft 11 and provided so as to be rotatably around the drive shaft 11. The toner processing apparatus 1 is provided with a flip-up means in the form of a stirring blade 20 pivotally supported on the drive shaft 11 and arranged below the rotating member 30, for causing an object to be processed to flow from the bottom portion of the processing chamber towards the top, and with a drive motor 50 and a control unit 60.

The processing chamber 10 has the bottom portion and the cylindrical inner peripheral surface 10a. The purpose of the processing chamber 10 is to accommodate an object to be processed comprising a toner particle and an external additive. The drive shaft 11 is attached at substantially the center of the bottom portion of the processing chamber 10, and the stirring blade 20 and the rotating member 30 are attached to the drive shaft 11. The stirring blade 20 is pivotally supported on the drive shaft 11 and is rotatably provided at the bottom portion of the processing chamber 10 below the rotating member 30, within the processing chamber.

The rotating member 30 is pivotally supported on the drive shaft 11, and is rotatably provided above the stirring blade 20. The driving force of the drive motor 50 is transmitted to the drive shaft 11 via a drive belt 51. The control unit 60 is provided for instance with a power switch, a drive ON switch, a drive stop switch, a rotational speed adjustment volume, a rotational speed display unit and a product temperature display unit, and controls the operation of the toner processing apparatus 1.

Processing Chamber

FIG. 2 illustrates a schematic diagram of the processing chamber 10. FIG. 2 illustrates a partial cutaway state of the inner peripheral surface (inner wall) 10a of the processing chamber 10, for convenience of explanation.

The processing chamber 10 is a cylindrical container having a substantially flat bottom portion, and has a rotatably provided drive shaft 11, for mounting of the stirring blade 20 and of the rotating member 30, at substantially the center of the bottom portion. From the viewpoint of strength, the processing chamber 10 is preferably made up of a metal such as iron or SUS. Preferably, the inner surface is made up of a conductive material, or alternatively the surface is subjected to a conductivity-imparting treatment.

Flip-Up Means

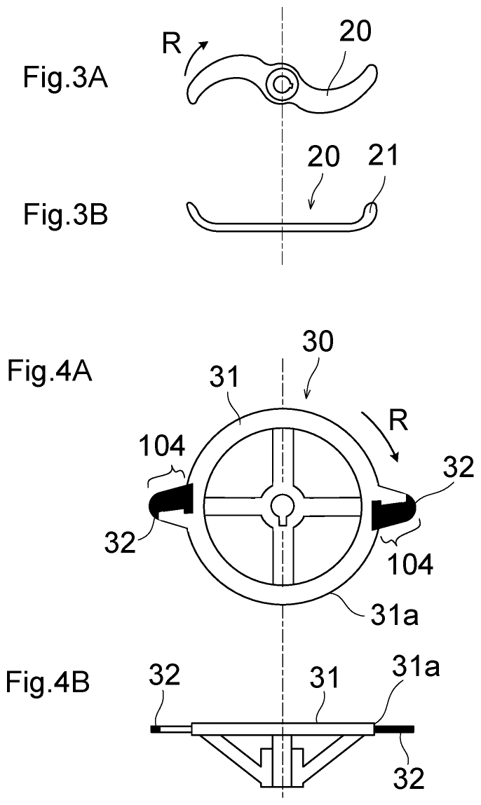

FIG. 3A and FIG. 3B are a set of schematic diagrams illustrating an example of a stirring blade 20 as a means for flipping up the object to be processed, the stirring blade 20 being pivotally supported on the drive shaft and disposed below the rotating member. FIG. 3A illustrates a top-view diagram seen from above, and FIG. 3B illustrates a front-view diagram seen from the front. The stirring blade 20 is configured to be able, by rotating, of flipping up the object to be processed comprising a toner particle and an external additive, within the processing chamber 10, by causing the object to be processed to flow upward from the bottom portion of the processing chamber.

The stirring blade 20 has blade portions 21 extending outward (outwardly in the radial direction (outward radial direction); outer diameter side) from the center of rotation, the tip of each blade portion 21 having a flipped-up shape so as to kick up the object to be processed. The shape of the blade portion 21 can be designed as appropriate on the basis of the size and operating conditions of the toner processing apparatus 1, and the filling amount and the specific gravity of the object to be processed.

The stirring blade 20 is preferably made up of a metal such as iron or SUS, in terms of strength, and may be plated or coated for wear resistance, as needed. The stirring blade 20 is fixed to the drive shaft 11 at the bottom portion of the processing chamber 10, and rotates clockwise (as illustrated in FIG. 3A) when viewed from above. The rotation direction of the drive shaft 11 is denoted by an arrow R in the figure. Through rotation of the stirring blade 20, the object to be processed rises while rotating in the same direction as the stirring blade 20, within the processing chamber 10, and then descends due to gravity. The object to be processed becomes uniformly mixed in this manner.

Rotating Member

FIG. 4A and FIG. 4B are a set of schematic diagrams illustrating an example of the rotating member 30. FIG. 4A illustrates a top-view diagram of the rotating member 30 installed in the processing chamber 10, and FIG. 4B illustrates a front-view diagram of the rotating member 30. The rotating member 30 has a rotating member main portion 31, and protruding portions 104 that protrude outward in the radial direction, from an outer peripheral portion 31a of the rotating member main portion 31. At the protruding portions 104, the rotating member 30 has respective processing members 32 that collide with the object to be processed, to thereby process the object.

The outer peripheral portion 31a and each protruding portion 104 are defined as follows. When viewing the rotating member 30 from the axial-direction top face of the drive shaft 11 (for instance as illustrated in FIG. 4A), a concentric circle is envisaged that is centered on the axis center of the drive shaft 11. A largest concentric circle is drawn such that the entirety of the circumference thereof is encompassed within in the rotating member 30. The circumference of the largest concentric circle is herein the outer peripheral portion 31a of the rotating member main portion. Portions projecting radially outward from this largest concentric circle are the protruding portions 104.

Each processing member 32 constitutes a part of the protruding portion or an entirety of the protruding portion; further, the rotating member main portion 31 and the processing members 32 are configured to be separable. The rotating member main portion 31 has projecting parts that protrude in the direction in which the rotating member 30 rotates, such that the processing members 32 fit with respective projecting parts. As the rotating member 30 rotates in the direction of the arrow R, the protruding portions collide with the object to be processed, to thereby process the object. The number of protruding portions in the rotating member 30 is not particularly limited, and is preferably from 2 to 8, more preferably from 2 to 4, and is yet more preferably 2. The protruding portions are preferably provided at equal intervals on the outer peripheral portion 31a of the rotating member main portion 31.

FIG. 8A and FIG. 8B are a set of diagrams focusing on the vicinity of a protruding portion 104 and the outer peripheral portion of a rotating member main portion 31 in the rotating member 30. The processing member 32 may make up part of the protruding portion 104, as illustrated in FIG. 8A, or may make up the entirety of the protruding portion 104, as illustrated in FIG. 8B. The protruding portion 104 is formed through fitting of the processing member 32 to the main body of the member body.

The rotating member main portion 31 has a projecting parts 103 that protrudes in the direction in which the rotating member rotates. In FIG. 8A, for instance, the rotating member main portion 31 has a projecting parts 103 at a position (protruding portion 104) that projects in the radial direction from the outer peripheral portion 31a. As illustrated in FIG. 8B, the projecting parts 103 may be provided inward of the protruding portion 104 of the rotating member 30 (on the side of the rotating member main portion 31). The processing member 32 has a shape that fits with the projecting parts 103.

In another aspect of the present disclosure, the rotating member main portion 31 may have a projecting parts that protrudes in at least one orientation in the circumferential direction of the rotating member 30. The rotating member main portion 31 may have a projecting parts that protrudes in one orientation in the circumferential direction of the rotating member 30, and a projecting parts that protrudes in the other orientation in the circumferential direction.

As illustrated in FIG. 1, the rotating member 30 lies above the stirring blade 20 within the processing chamber 10, is pivotally supported on the same drive shaft 11 as the stirring blade 20, and rotates in the same direction as the stirring blade 20 (Direction of the arrow R). Through rotation of the stirring blade 20 and the rotating member 30, the flipped up object to be processed and the processing members 32 at the protruding portions 104 collide with each other, as a result of which the external additive becomes adhered to the toner particle.

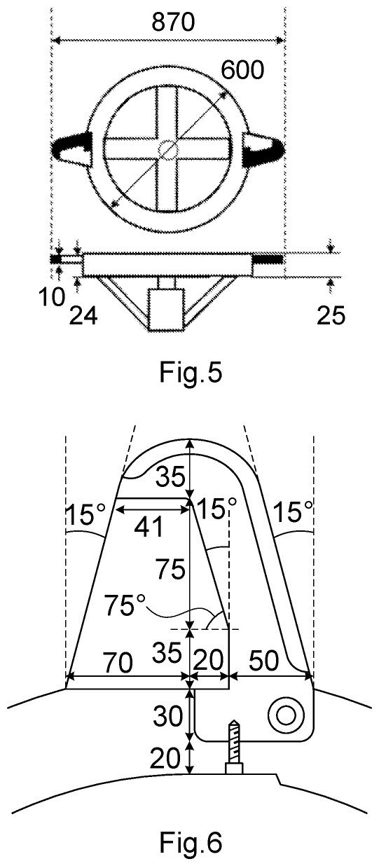

The rotating member main portion 31 and the processing member 32 are characterized by having separable configurations, and are used in a state of having been assembled and fixed through fitting of the projecting parts of the rotating member main portion 31 and the processing members 32. A fixing means such as screws and projections 109, bolts and pins 110 or the like may be also used herein. (FIG. 5, FIG. 6 and FIG. 10)

If the rotating member main portion 31 has no projecting parts or has a projecting parts that protrudes in a direction opposite to the direction in which the rotating member 30 rotates, the processing members 32 may readily come off when sustaining the impact of collisions with the object to be processed. In a case where the processing member 32 does not have a shape that fits with the projecting parts, joining of the rotating member main portion 31 and the processing member 32 fails to elicit a moment of inertia effect, and hence the processing members 32 detach readily.

Preferably, the projecting parts is a protruding portion, for instance such that the cross section thereof has a top and two bases on either side. Examples of projecting parts include portions having a crest shape, a U-shape, a right-angled U-shape, a C-shape, a W-shape or a V-shape.

Fitting Positional Relationship

Preferably, each processing member 32 is fitted to the rotating member main portion 31 so as to pinch a respective projecting parts in the radial direction (FIG. 8A, FIG. 8B, and FIG. 9). That is because when the moment of inertia 106 acts on the processing member 32 on account of the impact 107 sustained upon collision with the object to be processed, a force is exerted in the direction in which the processing member 32 pinches the projecting parts 103, so that, as a result, the processing member 32 becomes further fixed to the extent of the sustained impact, and does not come readily off. This configuration is preferable, since it functions also as a stopper that precludes the processing member 32 from coming off in the direction of the centrifugal force 108 that acts outward in the radial direction of the rotating member.

Presence of a Supporting Body

Preferably, the rotating member main portion 31 has supporting member 105 that project from the side of the rotating member main portion 31 towards respective protruding portions 104, and that support respective processing members 32, from the upstream side in the direction in which the rotating member 30 rotates (FIG. 8A). That is, the rotating member main portion 31 preferably has supporting member 105 that protrude from the rotating member main portion 31 side towards the protruding portions 104 and that support respective processing members 32 from the starting point side of the protrusion of the projecting parts 103.

As a result, each processing member 32 is supported by the force exerted in the normal direction to the collision surface of the processing member 32, from among the impact 107 exerted on the processing member 32, by virtue of the fact that the supporting member 105 projects toward the protruding portion. In consequence, the load derived from the impact 107 is also exerted on the rotating member main portion 31 side, such that the load on the processing member 32 is distributed; as a result, detachment and deformation of the processing member 32 can be further suppressed thereby.

Contribution of the Support of the Fitting Structure

More preferably, each supporting member 105 has the projecting parts 103 (FIG. 8A). The supporting member 105 distributes the load by bearing the impact that acts on the processing member 32 also on the rotating member main portion 31 side; in the above configuration, however, the supporting member 105 and the processing member 32 are fitted to each other. In consequence, deviations are unlikelier to occur and yet more sufficient contact area is obtained, at the joint surface of the supporting member 105 and the processing member 32, and accordingly the load distribution effect of the supporting member 105 is maximally brought out.

Tilt of the Supporting Member and of the Projecting Portion

Preferably, the surface of the supporting member 105 on the side towards which the rotating member 30 rotates has a surface that is parallel to the surface of the processing member 32 on the side towards which the rotating member 30 rotates. That is, the supporting member 105 on the protrusion side of the projecting parts 103 preferably has a surface that is parallel to the surface of the processing member 32 on the protrusion side of the projecting parts 103 (FIG. 6). At the protruding portion 104, in other words, at least part of the surface at which the processing member 32 and the rotating member main portion 31 fit with each other is parallel to the surface of collision of the processing member 32 against the object to be processed.

In particular, more preferably the supporting member 105 has the above-described parallel surface, in a region of the supporting member 105 further removed from the outer peripheral portion 31a of the rotating member main portion 31 (a region in the supporting member 105 that includes the tip thereof in the radial direction of the rotating member 30).

By virtue of the above configuration the supporting member 105 sustains, in the normal direction, the impact from the collision of the object to be processed with the processing member 32, whereby the effect of the supporting member 105 becomes more pronounced.

In particular, such a surface is present, increasingly preferably, in a region further removed from the outer peripheral portion 31a of the rotating member main portion 31. The impact from the collision with the object to be processed is large when the peripheral speed of the protruding portion 104 is high. Therefore, the effect of the supporting member 105 is pronounced when the inclination of the surface of the supporting member 105 in the region farther from the outer peripheral portion 31a of the rotating member main portion 31 is parallel to that of the surface of the processing member 32 on the side towards which the rotating member 30 rotates.

High Hardness and Surface Coat of the Processing Portion

The processing member 32 preferably has a substrate and a coating layer on the surface of the substrate. The HRC hardness of the substrate of the processing member 32 is preferably higher than the HRC hardness of the rotating member main portion 31. Preferably, the HRC hardness of the coating layer is higher than the HRC hardness of the substrate. That is because the wear resistance of the processing portion is enhanced by virtue of the presence of the high-hardness material on the resurfaced surface of the processing portion.

Specifically, a surface treatment is performed herein such as de-polishing, coating and plating of hard metals and ceramics, sintering of cemented carbides such as ceramics and cermets, thermal spraying/welding, overlay welding, carburizing or nitriding, ion plating, blasting and the like.

The HRC hardness (Rockwell hardness: depth of a permanent dent from the reference plane) of the rotating member main portion 31 is preferably 20 or higher, more preferably 25 or higher. The upper limit of the HRC hardness of the rotating member main portion 31 is not particularly limited, but is preferably 40 or lower, more preferably 35 or lower.

The HRC hardness (Rockwell hardness) of the processing member 32 is preferably 40 or higher, more preferably 50 or higher, and yet more preferably 55 or higher. The upper limit of the HRC hardness of the processing member 32 is not particularly restricted, but is preferably 70 or lower, more preferably 65 or lower.

The difference between the HRC hardness (Rockwell hardness) of the rotating member main portion 31 and the HRC hardness (Rockwell hardness) of the processing member 32 is preferably 40 or less, more preferably 35 or less. The lower limit of the hardness difference is not particularly restricted, but is preferably 0 or more, more preferably 10 or more, yet more preferably 20 or more, and even more preferably 25 or more.

Given that within the above ranges the rotating member main portion 31 and the processing member 32 have sufficient hardness, wear resistance is excellent and there is suppressed the occurrence of gaps and deformation, arising from wear of low-HRC hardness members on account of stress derived from friction or the like at the fitting portion of the rotating member main portion and the processing member.

The HRC hardness is measured herein in accordance with the Rockwell hardness test in JIS Z 2245.

Preferably, the processing member 32 has a portion that fits with the rotating member main portion 31 at a position not encompassed by the protruding portion 104 (i.e. further towards the center of the rotating member main portion 31 than the outer peripheral portion 31a of the rotating member).

Herein a contact point A (116) denotes a contact point between the processing member 32 and the outer peripheral portion 31a of the rotating member at an end on the side towards which the rotating member rotates (protrusion side of the projecting parts), within a portion at which the rotating member main portion 31 and the processing member 32 fit each other and at which the processing member 32 penetrates from the outer peripheral portion 31a of the rotating member towards the center of the rotating member main portion 31, at a position not encompassed by the protruding portion 104. In this case, preferably, the contact point A (116) is identical to a contact point 124 of the end of the protruding portion 104 with the outer peripheral portion 31a of the rotating member, on the side towards which the rotating member rotates, or is positioned further on the side towards which the rotating member rotates (FIG. 15).

As a result, a gap is less likely to occur at the boundary between the protruding portion 104 on the side towards which the rotating member rotates, and the outer peripheral portion 31a of the rotating member, and hence the object to be processed is unlikelier to get into such a gap. This makes it therefore easier to prevent positional deviation and detachment of the processing member 32 during use. (FIG. 15)

A penetration angle α denotes herein the penetration angle of the processing member 32, from the contact point A into the outer peripheral portion 31a of the rotating member.

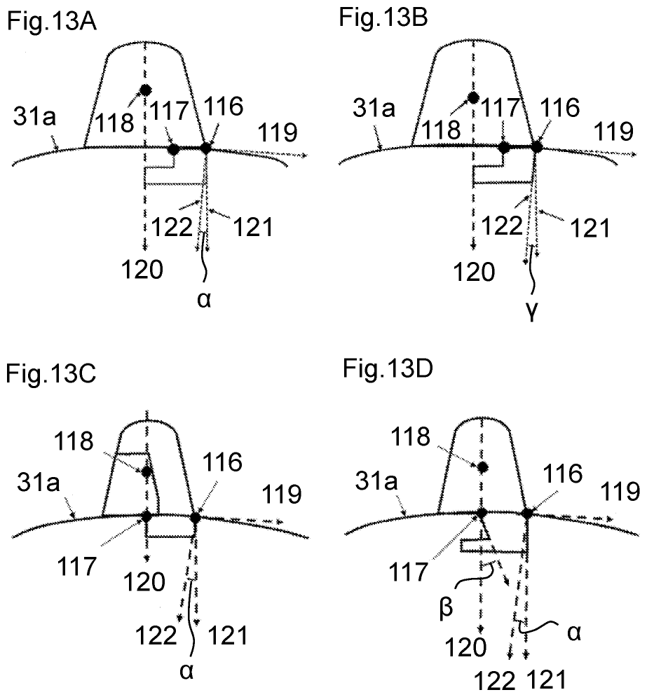

Meanwhile, a contact point B (117) denotes a contact point between the processing member 32 and the outer peripheral portion 31a of the rotating member at an end on the side opposite to the side towards which the rotating member rotates (protrusion side of the projecting parts), of the portion at which the rotating member main portion 31 and the processing member 32 fit each other and into which the processing member 32 intrudes from the outer peripheral portion 31a of the rotating member towards the center of the rotating member main portion 31, at a position not encompassed by the protruding portion 104. A penetration angle β denotes herein the penetration angle of the processing member 32 from the contact point B (117) into the outer peripheral portion 31a of the rotating member. (FIG. 13A to FIG. 13D)

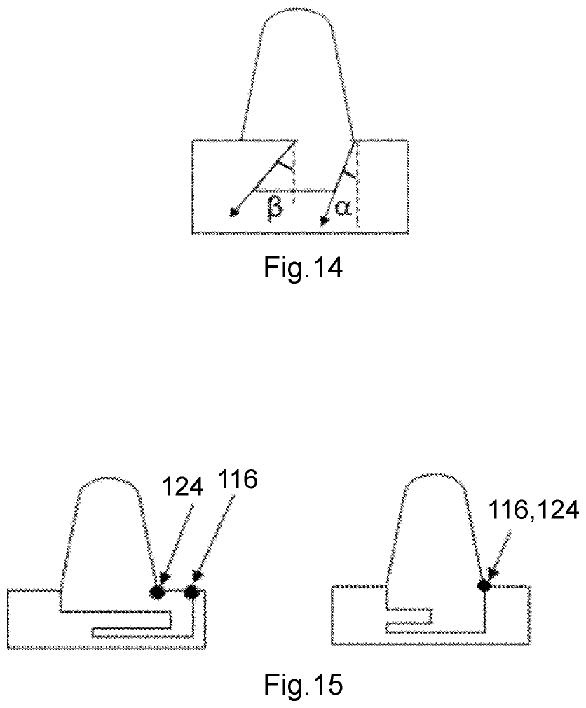

Specifically, the penetration angle α is as follows. A tangent X (119) denotes the tangent of the outer peripheral portion 31a of the rotating member at the contact point A. A normal line Y (122) to the tangent X (119) is drawn from the contact point A. The penetration angle α is defined herein as the angle formed by a line segment Z (coinciding with 121 in FIG. 13A) formed by the processing member 32 that intrudes into the outer peripheral portion 31a at the contact point A (116), and the normal line Y. With respect to the normal line Y, the penetration angle α is 0° when the normal line Y and the line segment Z match, takes on a positive value in a case where the line segment Z is closer to starting point of the projecting parts 103 than the normal line Y, and takes on a negative value in a case where the line segment Z is closer to the protrusion side of the projecting parts 103 than the normal line Y. (FIG. 13A, FIG. 13C and FIG. 14)

Specifically, the penetration angle β is as follows. A line segment (line segment P) connecting the contact points between the ends of the protruding portion 104 in the circumferential direction of the rotating member and the outer peripheral portion 31a of the rotating member is drawn. At the contact point B, a straight line Q perpendicular to the line segment P is drawn (in FIG. 13D the straight line C (120) described below and the straight line Q are identical). The penetration angle β is defined as the angle formed by a line segment R in turn formed by the processing member 32 that penetrates the outer peripheral portion 31a at the contact point B (117), and the straight line Q. With respect to the straight line Q, the penetration angle β is 0° in a case where the straight line Q and the line segment R match, takes on a positive value in a case where the line segment R is closer to starting point of the projecting parts 103 than the straight line Q, and takes on a negative value in a case where the line segment R is closer to the protrusion side of the projecting parts 103 than the straight line Q.

Further, an angle γ is defined as follows (FIG. 13B). With a straight line C (120) as the straight line that joins the center of the drive shaft 11 of the rotating member and the center of gravity 118 of the protruding portion, a straight line (straight line 121) is drawn parallelly to the straight line C, from the contact point A, inward in the radial direction. The angle γ is defined herein as the angle formed by the straight line 121 and the normal line Y (122).

In a preferred implementation of the processing member in this case, preferably any one of the three conditions below is satisfied.

(1) 0≤α<β

(2) α<0<β

(3) 0≥α≥γ, β=−60° to +60°

In a case where (1) or (2) is satisfied, a force derived from the centrifugal forces acting on the processing member 32 acts in turn so as to close the gap at the joint surface of the fitting portion with the rotating member main portion, as a result of which intrusion of the object to be processed into the gap is suppressed. Since the force acts in the direction in which the processing member 32 is fixed by the rotating member main portion 31, it becomes moreover easier to prevent positional deviation or detachment of the processing member 32 during use.

In a case where (3) is satisfied, the processing member 32 is assumed to be fitted with the rotating member main portion 31, so as to pinch the projecting parts 103 in the radial direction. Even if α≥β holds in this case, if 0≥α≥γ is satisfied then an object to be processed that may hypothetically get in the gap at the fitting portion between the processing member 32 and the rotating member main portion 31, from the contact point A, would exert a force onto the rotating member main portion 31 and the processing member 32, in the circumferential direction of the rotating member. As a result, the force that fixes the processing member 32 and the rotating member main portion would increase in that case, which is desirable. More preferably, the object to be processed comprises resin particles such as toner or a toner particle, since in that case the object acts as an adhesive at the gap of the fitting portion of the processing member 32 and the rotating member main portion 31.

Further, α is preferably from −18° to +10°, and more preferably from −16° to +5°.

Further, β is preferably from −35° to +35°, and more preferably from −20° to +20°.

Further, γ is preferably from −20° to −10°, and more preferably from −17° to −13°.

Positional Relationship between the Starting Point and End Point of the Protruded Portion in the Circumferential Direction

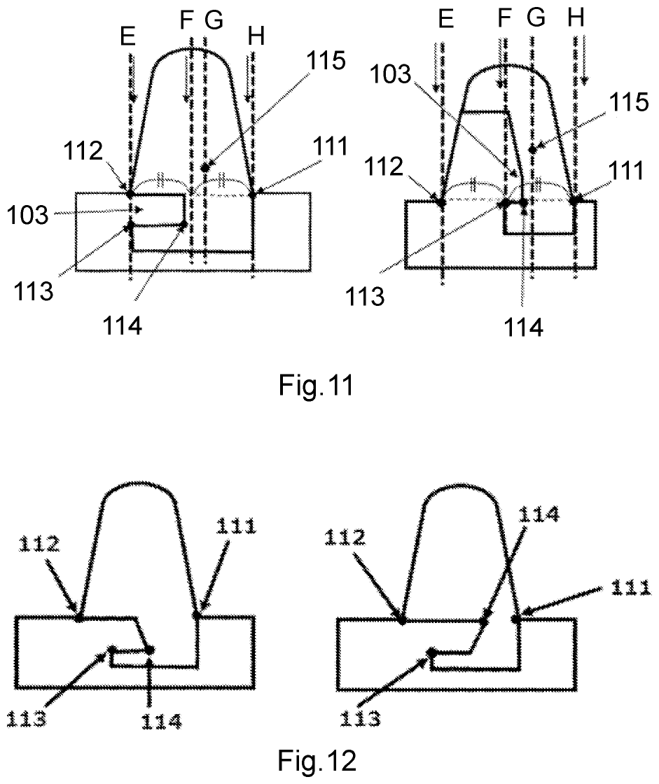

Preferably, a starting point 113 of the projecting parts 103 in the circumferential direction of the rotating member 30 (preferably, the starting point of the projecting parts on the side towards the center of the rotating member) satisfies the following relationship. Two contact points of the protruding portion 104 with the outer peripheral portion 31a of the rotating member are set. From among the two contact points, a contact point 111 in FIG. 11 denotes the contact point on the side of the direction of rotation (i.e. on the protrusion side of the projecting parts 103). From among the two contact points, a contact point 112 in FIG. 11 denotes the contact point on the side opposite to the side of the direction of rotation (i.e. starting point side of the protrusion of the projecting parts 103).

Further, a straight line F is drawn from the midpoint of the two contact points toward the center of the drive shaft 11 of the rotating member. A straight line E is drawn that passes through the contact point 112 and is parallel to the straight line F. Preferably, the starting point 113 of the projecting parts is present on the straight line E, or closer to the straight line F than straight line E.

Further, a straight line G is drawn that passes through the center of gravity 115 of the processing member 32 and is parallel to the straight line F. Such being the case, the starting point 113 of the projecting parts is more preferably present between the straight line E and the straight line G.

By satisfying the above, the projecting parts 103 is unlikelier to deform on account of the impact sustained upon collision of the processing member 32 against the object to be processed, and the life of the projecting parts 103 as a component is lengthened. (FIG. 11)

Preferably, an end point 114 of the projecting parts 103 in the circumferential direction of the rotating member 30 (preferably, the end point of the projecting parts on the side towards the center of the rotating member) satisfies the relationship below. A straight line H is drawn that passes through the contact point 111 and is parallel to the straight line F. The end point 114 is preferably present on the far side of the straight line G as viewed from the straight line H. That is because the moment of inertia derived from the impact sustained upon collision of the processing member 32 against the object to be processed acts readily in this case. (FIG. 11)

Further, X denotes the length from the starting point 113 of the projecting parts 103 in the circumferential direction of the rotating member 30 (preferably, the starting point of the projecting parts on the side towards the center of the rotating member) up to the end point 114 of the projecting parts 103 in the circumferential direction of the rotating member 30 (preferably the end point of the projecting parts on the side towards the center of the rotating member). Further, Y denotes the length between the two contact points of the protruding portion 104 with the outer peripheral portion 31a of the rotating member.

Setting herein Y to 100, then the length X (i.e. the protrusion length of the projecting parts) is preferably from about 5 to 90, more preferably from about 8 to 75, and yet more preferably from about 10 to 60.

Definition of Starting Points

The starting point 113 of the projecting parts in the circumferential direction of the rotating member 30 is the end of the projecting parts on the side opposite to the direction in which the rotating member rotates (the starting point side of the projecting parts). In a case where there are multiple starting points of the projecting parts, the starting point 113 denotes the end point furthest on the side opposite to the direction in which the rotating member rotates. In a case where there are multiple projecting parts, the starting point 113 is the end on the most opposite to the direction of rotation of the rotating member. (FIG. 11 and FIG. 12)

Definition of End Points

The end point 114 of the projecting parts in the circumferential direction of the rotating member 30 is the end on the side towards which the rotating member rotates (the protrusion direction side of the projecting parts). In a case where there are multiple of projecting parts, the end point 114 is the end of the projecting parts lying furthest on the rotating direction side of the rotating member. (FIG. 11 and FIG. 12)

In the surface of collision in the protruding portion 104 against the object to be processed, on the side towards which the rotating member 30 rotates (protrusion direction side of the projecting parts), a region farthest from the rotating member main portion may be positioned further downstream, in the rotation direction of the rotating member 30, than a region lying closer to the rotating member main portion than the former region, or may be opposite.

The shape of the surface of collision in the protruding portion 104 against the object to be processed, on the side towards which the rotating member 30 rotates (protrusion direction side of the projecting parts), is not particularly limited. For instance the shape may be rectangular or paddle-like. Preferably, the shape of the surface is a U-shape, a right-angled U-shape, a C-shape or a V-shape. For instance, the shape may be rectangular, with the ends of two parallel sides forming a taper the tip whereof is rounded, as illustrated in FIG. 18. A rectangular shape as in FIG. 19 is also preferable. The collision surface may be imparted with rounding, but is preferably a flat surface.

Preferably, the center of gravity of the processing member 32 is positioned further on the side towards the rotating member rotates (protrusion direction side of the projecting parts) than the center of gravity of the protruding portion 104. The moment of inertia derived from the impact sustained upon collision of the processing member 32 against the object to be processed acts more readily by virtue of the above configuration.

Structure of Rotating Member Body

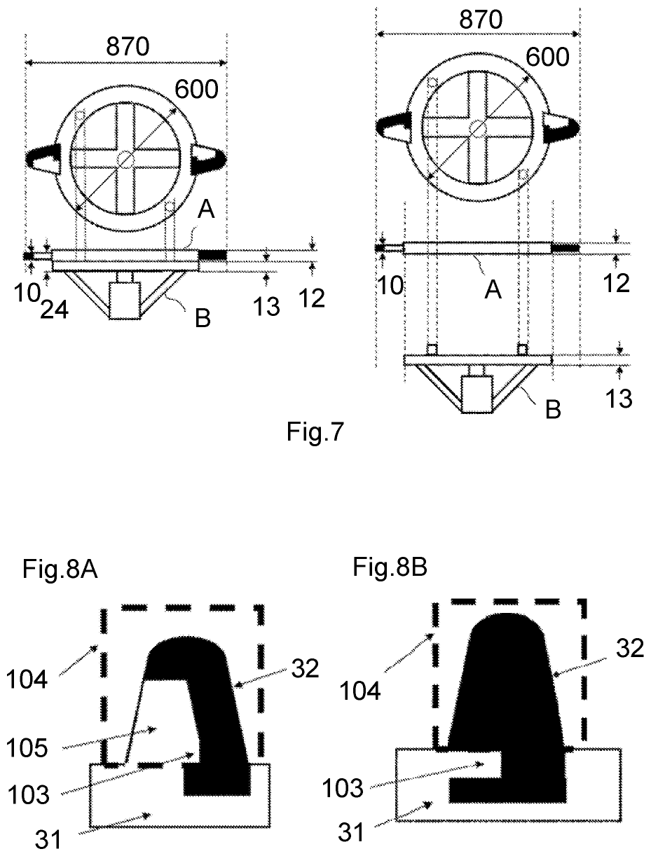

As illustrated in FIG. 7, the rotating member main portion 31 may be separable into two parts. For instance, one part may be a part A having projecting parts 103 and that forms the protruding portions 104, and the other part may be a part B having no projecting parts 103. In that case the part A having the projecting parts is preferably based on a shape resulting from cutting the rotating member main portion 31 along a plane perpendicular to the drive shaft 11. For instance as illustrated in FIG. 7, the rotating member main portion 31 may be configured to be separable into a support part B of the rotating member main portion pivotally supported on the drive shaft 11 and into a part A that can be fixed to the support part B and that forms the protruding portions 104 of the rotating member main portion (FIG. 7). The numerals in FIG. 5 to FIG. 7 denote the relative dimensions of the part indicated by arrows (the distance between the arrows).

In terms of wear resistance, herein deformation and detachment derived from wear between metal pieces readily occur in a case where the HRC hardness of the processing members that are strongly impacted by collisions with the object to be processed is set to a high hardness but the HRC hardness of the rotating member main portion is not as high. By contrast, a hardness relationship can be designed for instance as follows in a case where the rotating member main portion is made separable into two, as illustrated in FIG. 7.

HRC hardness of processing members >HRC hardness of part A >HRC hardness of support part B

The cost of the support part B having no projecting parts, and being of largest volume, can be reduced by prescribing the above relationship. Moreover, costs and the burden replacement work are reduced, since the replacement parts involved in a case where the projecting parts are worn or deformed may be small in number. Preferably, rotating member bodies that are separated have a relief shape that allows the bodies to be fitted. That is because it becomes then possible to prevent the rotating member bodies from deforming or coming off

Material and HRC Hardness

The steel material used in the rotating member main portion 31 and the processing member 32 is not particularly limited, and known materials can be used. For example there may be used stainless steel, chromium molybdenum steel, carbon tool steel, alloy tool steel, steel for plastic molds, high-speed tool steel and the like. From the viewpoint of wear resistance, a steel material having an HRC hardness of 40 or higher, more preferably carbon tool steel, alloy tool steel, steel for plastic molds or high-speed tool steel, having an HRC hardness of 40 or higher, may be the base material used in the processing member 32. The steel material is more preferably steel for plastic molds, or high-speed tool steel. Such steel types are preferable since, thanks to their hardness, not only base materials thereof are unlikely to be dented by impacts from collision with the object to be processed, but the materials are also tough and not prone to chipping.

Coating

Preferably, the coating layer of the surface of the substrate of the processing member 32 should be made of a material with higher hardness than the substrate. Examples include for instance ceramic coating, ceramic chip lining, ceramic thermal spraying, Daikuron plating, diamond-like carbon coating, fluorine composite electroless nickel plating, PEEK coating, cemented carbide overlaying and cemented carbide thermal spraying.

Other than by coating, micro-cracks on the coated surface can be eliminated, and wear resistance can be further improved by resorting, after coating, to shot peening as a mechanical surface treatment on a coated surface.

Shot peening is a method in which particles of steel or the like are sprayed onto a treated surface, for instance by compressed air or by centrifugal forces, such that micro-cracks on the surface treatment can be eliminated; in the present invention, shot peening is preferably performed through jetting of ceramic particles.

As is known, micro-cracks formed on the surface tend to decrease, through plastic deformation, when the jetting pressure is high and the duration of peening is long. For the purpose of further increasing surface hardness and wear resistance, it is preferable to perform hardening prior to shot peening, to make the plating layer harder and to increase adhesion.

Fixing of the Processing Member and Rotating Member Body

After fitting the rotating member main portion 31 and the processing member 32, a fixing means such as screws and projections 109, bolts and pins 110 may be used for further fixing or positioning (FIG. 10). In that case, the rotating member main portion 31 and the processing member 32 may be fixed by way for instance of a relief portion, a pin, a bolt or a screw, in a direction parallel to the drive shaft 11, in the region of the processing member 32 that is not included in the protruding portion 104. That is because the object to be processed moves also in the direction parallel to the drive shaft 11 in the processing chamber 10, thanks to which it becomes possible to suppress detachment of the processing member 32 derived from a collision with the object to be processed.

Further, the processing member 32 may be fixed by a fixing means in a direction perpendicular to the drive shaft 11, from the inward side of the rotating member 30 in the radial direction, and outward in the radial direction of the rotating member. That is because the object to be processed also moves in a direction parallel to the drive shaft, within the processing chamber, and accordingly it is possible to prevent the member to be processed from coming off due to collisions with the object to be processed.

By providing the fixing means from the inward side of the rotating member 30 in the radial direction, outwards in the radial direction of the rotating member, detachment and deformation of the fixing means can be suppressed on account of the centrifugal force acting on the fixing means. (FIG. 10)

Peripheral Speed of Rotating Member

The peripheral speed of the rotating member 30 at the outermost end of the protruding portion 104, in the radial direction, is preferably 20 m/s or higher, and more preferably 30 m/s or higher. The upper limit is not particularly restricted, but is preferably 60 m/s or lower, and more preferably 50 m/s or lower. Within the above ranges, the moment of inertia acting on the processing member 32 is sufficiently large, and as a result the processing member 32 is yet unlikelier to come off the rotating member main portion 31.

Toner Production Method

An external addition treatment of the toner is preferably performed using the above toner processing apparatus. Specifically, preferably, a method for producing a toner particle comprising a binder resin, and producing a toner comprising an external additive, includes the following steps.

(i) a step of producing a toner particle comprising a binder resin, and

(ii) a step of performing a treatment of externally adding an external additive to the toner particle having been produced in the step (i) by using the above toner processing apparatus.

The particle diameter of the toner particle is about 10 μm or smaller; the toner particle is mainly made up of resin particles comprising a wax and so forth, and the size of the additive that is externally added to the toner is smaller than the particle diameter of the toner, regardless of the hardness. This facilitates as a result the action of the moment of inertia derived from the impact sustained upon collision of the processing members 32 against the object to be processed.

The duration of the external addition treatment is not particularly limited, but is preferably from 3 to 30 minutes, and more preferably from 5 to 20 minutes. The temperature at the time of the external addition treatment is not particularly limited, but is preferably from 20 to 35° C., and more preferably from 25 to 33° C. The rotational speed of the rotating member of the toner processing apparatus at the time of external addition may be modified as appropriate depending on the size of the apparatus that is used, and is not particularly limited; preferably, however, the rotational speed is from about 200 to 3000 rpm, more preferably from about 300 to 2000 rpm.

A heating step of heating the toner may be performed during or after the external addition treatment. With T_{R} (° C.) as the temperature in the heating step and Tg (° C.) as the glass transition temperature of the toner particle, preferably satisfying Tg-10 (° C)≤T_{R}≤Tg+5 (° C.), and more preferably satisfying Tg-5 (° C)≤T_{R}≤Tg+5 (° C.). As a result, this facilitates control of the dispersion state and the fixing state of the external additive on to the toner particle.

The duration of the heating step is not particularly limited, but is preferably from 2 to 30 minutes, and more preferably 3 to 10 minutes. The glass transition temperature Tg of the toner particle is preferably from 40 to 70° C., and more preferably from 50 to 65° C., from the viewpoint of storability.

The device used in the heating step is not particularly limited, and the above toner processing apparatus can be used. A water-permeable jacket or the like that allows modifying the temperature of the processing chamber 10 may also be used.

Additives in the External Addition Step

When producing a toner through external addition of an external additive to a toner particle using the toner processing apparatus, various known inorganic and organic additives can be used for the purpose of imparting various characteristics. The external additive that is used has preferably a particle diameter of 3/10 or less of the weight-average particle diameter of the toner particle, from the viewpoint of durability at the time of addition to the toner. The term particle diameter of the additive denotes herein an average particle diameter worked out by observing the surface of the toner particle using a scanning electron microscope.

In particular, the external additive is preferably at least one selected from the group consisting of inorganic fine particles such as silica, titanium oxide and alumina, inorganic-organic hybrid particles, and organosilicon polymer particles. The external additive has low elasticity, which makes for unlikelier losses at the time of collision between the processing member 32 and the external additive; the moment of inertia acting on the processing member is larger as a result.

The number-average particle diameter of the primary particles of the external additive is preferably from 6 to 500 nm, and more preferably from 6 to 350 nm. Within the above ranges, the external additive is less likely to detach from the toner particle, and as a result stable quality can be maintained even when the toner is used over long periods of time.

These additives may be subjected to a hydrophobic treatment. Various coupling agents such as a silane coupling agent or a titanium coupling agent can be used, although preferably hydrophobicity is increased herein by using silicone oil, as a hydrophobic treatment method. That is because silicone oil allows suppressing adsorption of moisture by the inorganic fine powder under high humidity, and allows further suppressing contamination of a regulating member or charging member, thanks to which a high-quality image can be obtained.

The addition amount of these external additives is preferably from 0.01 to 10 parts by mass, and more preferably from 0.4 to 8 parts by mass, relative to 100 parts by mass of the toner particle. These additives may be used singly or in combinations of a plurality of types.

This is desirable since in that case the toner exhibits sufficient flowability and charging performance, and also toner performance can be maintained stably over long periods of time. Preferably, the fixing state and coverage ratio of additives such as inorganic fine particles on the surface of the toner particle are stable during long-term use in the external addition step of the toner. Preferably, a fixing index of the external additive is 4.5 or lower.

Method for Measuring the Fixing Index and Coverage Ratio of the External Additive

A method for indexing the fixing state of the external additive may involve evaluating the migration amount of external additive at the time where the toner is brought into contact with a substrate. In terms of the material of the surface layer of the substrate, a substrate that utilizes a polycarbonate resin as the surface layer material thereof is used herein as a substrate that simulates the surface layer of a photosensitive member. Specifically, firstly there is applied a coating solution resulting from dissolving a bisphenol Z-type polycarbonate resin (product name: Iupilon Z-400, by Mitsubishi Engineering Plastics Corporation, viscosity-average molecular weight (Mv): 40000) in toluene, to a concentration of 10 mass %.

This coating solution is applied onto an aluminum sheet having a thickness of 50 using a # 50 Meyer rod, to form a coating film. The coating film is dried for 10 minutes at 100° C., to thereby produce a sheet having a layer (thickness: 10 μm) of a polycarbonate resin on the aluminum sheet. The sheet is held on a substrate holder. The substrate is a square having sides of about 3 mm.

A measurement step is described below divided into a step of arranging the toner on a substrate, a step of removing the toner from the substrate, and a step of quantifying the coverage ratio of the external additive supplied to the substrate.

Step of Arranging Toner on the Substrate

The toner is incorporated into a porous soft material (hereafter notated as “toner holder”), and the toner holder is brought into contact with the substrate. As the method for impregnating the toner into the toner holder, a step is repeated, five times, of immersing the toner holder in a container that contains a sufficient amount of toner, and removing the toner holder; this step is followed by visual checking of whether the surface of the toner holder is covered with the toner. A sponge (product name: White wiper) by Marusan Industry Co., Ltd. is used as the toner holder.

The toner-impregnated toner holder is then fixed to the tip of a load meter that is in turn fixed to a stage which moves in a direction perpendicular to the contact surface of the substrate, so that the toner-impregnated toner holder and the substrate can be in contact with each other while a load is measured. Contact between the toner-impregnated toner holder and the substrate is accomplished by repeating five times a step that involves moving the stage, pressing the toner-impregnated toner holder against the substrate until the load meter indicates 10 N, and separating thereafter the toner holder from the substrate.

Step of Removing the Toner from the Substrate

An elastomer-made suction port having an inner diameter of about 5 mm and connected to the tip of a nozzle of a cleaner is brought close to the substrate after contact with the toner-impregnated toner holder, in such a manner that the suction port is perpendicular to the toner placement surface, and then the toner adhered to the substrate is removed. The toner is removed herein while visually checking the extent of residual toner. The distance between the end of the suction port and the substrate is set to 1 mm, the suction time to 3 seconds, and the suction pressure to 6 kPa.

Step of Quantifying the Coverage Ratio of External Additive Supplied to the Substrate

The amount and shape of the external additive remaining on the substrate after toner removal are quantified through observation by scanning electron microscopy and image measurement. Firstly, platinum is sputtered on the substrate after removing the toner, under the conditions of a current of 20 mA and 60 seconds, to yield an observation sample.

Observation magnifications that allow observing the external additive are arbitrarily selected, to observe the sample by scanning electron microscopy. Observations are performed on S-4800 (product name) backscattered electron images, using a Hitachi ultra-high resolution field-emission scanning electron microscope (product name: S-4800, by Hitachi High-Technologies Corporation), as a scanning electron microscope. The observation magnifications are set to 50000, the acceleration voltage to 10 kV, and the working distance to 3 mm.

In the images obtained through observation, the external additive appears with high brightness and the substrate with low brightness; hence, the amount of external additive in the field of view can be quantified by binarization. The binarization conditions are properly selected depending on the observation device and the sputtering conditions. The image analysis software Image J (available at https://imagej.nih.gov/ij/) is used for binarization.

The area ratio of the external additive within the observation field is worked out by integrating only the surface area of the external additive, using Image J, and dividing the result by the surface area of the entire observation field. The above measurement is performed on 100 binarized images, and an average value of the results is taken as the area ratio [A] (units: area %) of the external additive on the substrate.

A coverage ratio [B] (units: area %) of the external additive on the toner particle is calculated next.

The coverage ratio of the external additive is measured relying on observation by scanning electron microscopy, and by image measurement. The same magnifications under which the external additive is observed are adopted herein as the observation magnifications under which the external additive is observed in the observation by scanning electron microscopy. The above Hitachi ultra-high resolution field-emission scanning electron microscope S-4800 (product name) is used as the scanning electron microscope.

To measure an area ratio A and coverage ratio B in a case where the toner contains fine particles other than the external additive, EDS analysis is performed for each particle of the external additive, in the toner observation, and the presence or absence of element peaks is used as the criterion for determining whether the analyzed particle is an external additive or not. Specifically, the same operation as that of the number-average particle diameter of the primary particles of the external additive is performed herein.

Imaging conditions are as follows.

(1) Sample Production

A conductive paste is thinly coated on a sample stand (15 mm×6 mm aluminum sample stand), and toner is blown onto the paste. Air is then blown to remove excess toner from the sample stand, and thoroughly dry the toner. The sample stand is set in a sample holder, and the height of the sample stand is adjusted to 36 mm using a sample height gauge.

(2) Setting of S-4800 Observation Conditions

Calculation of the coverage ratio [B] of the external additive is carried out using the image obtained by backscattered electron image observation with the S-4800. The backscattered electron image provides less charge up of the external additive than with the secondary electron image, which enables measurement of the coverage ratio [B] of the external additive with good accuracy.

Liquid nitrogen is introduced to the brim of the anti-contamination trap attached to the S-4800 housing and standing for 30 minutes is carried out. The “PC-SEM” of the S-4800 is started and flashing is performed (the FE tip, which is the electron source, is cleaned). The acceleration voltage display area in the control panel on the screen is clicked and the [flashing] button is pressed to open the flashing execution dialog. A flashing intensity of 2 is confirmed and execution is carried out. The emission current due to flashing is confirmed to be 20 μA to 40 μA. The specimen holder is inserted in the specimen chamber of the S-4800 housing. [home] is pressed on the control panel to transfer the specimen holder to the observation position.

The acceleration voltage display area is clicked to open the HV setting dialog and the acceleration voltage is set to [0.8 kV] and the emission current is set to [20 μA]. In the [base] tab of the operation panel, signal selection is set to [SE], [upper (U)] and [+BSE] are selected for the SE detector, and the instrument is placed in backscattered electron image observation mode by selecting [L. A. 100] in the selection box to the right of [+BSE].

Similarly, in the [base] tab of the operation panel, the probe current of the electron optical system condition block is set to [Normal]; the focus mode is set to [UHR]; and WD is set to [3.0 mm]. The [ON] button in the acceleration voltage display area of the control panel is pressed to apply the acceleration voltage.

(3) Focus Adjustment

The magnification is set to 5,000 (5 k) by dragging within the magnification indicator area of the control panel. Turning the [COARSE] focus knob on the operation panel, adjustment of the aperture alignment is carried out where some degree of focus has been obtained. [Align] in the control panel is clicked and the alignment dialog is displayed and [beam] is selected. The displayed beam is migrated to the center of the concentric circles by turning the STIGMA/ALIGNMENT knobs (X, Y) on the operation panel. [aperture] is then selected and the STIGMA/ALIGNMENT knobs (X, Y) are turned one at a time and adjustment is performed so as to stop the motion of the image or minimize the motion. The aperture dialog is closed and focus is performed with the autofocus. This operation is repeated an additional two times to achieve focus.

In a state where a midpoint of maximum diameter is aligned with the center of the measurement screen, the magnifications indicator in the control panel is dragged to set magnifications to 10000 (10k) magnifications. Turning the [COARSE] focus knob on the operation panel, adjustment of the aperture alignment is carried out where some degree of focus has been obtained. [Align] in the control panel is clicked and the alignment dialog is displayed and [beam] is selected. The displayed beam is migrated to the center of the concentric circles by turning the STIGMA/ALIGNMENT knobs (X, Y) on the operation panel.

[aperture] is then selected and the STIGMA/ALIGNMENT knobs (X, Y) are turned one at a time and adjustment is performed so as to stop the motion of the image or minimize the motion. The aperture dialog is closed and focus is performed with the autofocus. Thereafter, magnifications are set to 50000 (50 k) magnifications, focus is adjusted using the focus knob and STIGMA/ALIGNMENT knobs, and focusing is performed once more using autofocus. This operation is repeated again to adjust focus. The measurement precision of coverage ratio is prone to decrease when the inclination angle of the observation surface is large; to perform the analysis, therefore, an observation surface exhibiting as little inclination as possible is selected by choosing the observation surface so that the entirety thereof is focused simultaneously, at the time of focus adjustment.

(4) Image Storage

Brightness is adjusted in an ABC mode, and 640x480 pixel micrographs are captured and stored. The below-described analysis is performed using the resulting image files. One micrograph is captured for each toner particle, to obtain images of 100 or more toner particles.

Each observed image is binarized using Image J (available from https://imagej.nih.gov/ij/), which is image analysis software.

After binarization, only the external additive is extracted on the basis of the particle diameter, circularity and EDS analysis, by [Analyze]-[Analyze Particles], to work out the coverage ratio (units: area %) of the external additive on the toner particle.

The above measurement is performed on 100 binarized images; the average value of the coverage ratio (units: area %) of the external additive is taken as the coverage ratio [B] of the additive. The fixing index of the external additive is calculated on the basis of the area ratio [A] of the external additive on the substrate, and the coverage ratio [B] of the external additive, according to Expression (I) below.

Fixing index=area ratio [A] of external additive having migrated to the polycarbonate film/coverage ratio [B] of external additive on the surface of the toner particle×100 (I)

Method for Measuring the Coverage Ratio of External Additive

As the coverage ratio of the surface of the toner particle by the external additive, the value of the coverage ratio [B] (units: area %) of the external additive on the toner particle in the above method for measuring the fixing index of the external additive is used.

Binder Resin

The binder resin is not particularly limited, and for instance the following polymers and resins can be used.

Monopolymers of styrene and substituted styrene, such as polystyrene, poly-p-chlorostyrene and polyvinyltoluene; styrene copolymers such as styrene-p-chlorostyrene copolymers, styrene-vinyltoluene copolymers, styrene-vinylnaphthalene copolymers, styrene-acrylate ester copolymers, styrene-methacrylate ester copolymers, styrene-α-chloromethyl methacrylate copolymers, styrene-acrylonitrile copolymers, styrene-vinyl methyl ether copolymers, styrene-vinyl ethyl ether copolymers, styrene-vinyl methyl ketone copolymers and styrene-acrylonitrile-indene copolymers; and polyvinyl chloride, phenol resins, natural resin-modified phenol resins, natural resin-modified maleic acid resins, acrylic resins, methacrylic resins, polyvinyl acetate, silicone resins, polyester resins, polyurethane resins, polyamide resins, furan resins, epoxy resins, xylene resins, polyvinyl butyral, terpene resins, coumarone-indene resins and petroleum-based resins.

Particularly preferred among the foregoing are styrenic copolymers such as styrene-acrylate ester copolymers and styrene-methacrylate ester copolymers, and polyester resins.

Polymerizable Monomer

A vinyl-based polymerizable monomer amenable to radical polymerization can be used as a polymerizable monomer utilized as a styrenic copolymer. A monofunctional polymerizable monomer or a multifunctional polymerizable monomer can be used as the vinyl-based polymerizable monomer.

Examples of monofunctional polymerizable monomers include styrene; styrene derivatives such as a-methyl styrene, β-methyl styrene, o-methyl styrene, m-methyl styrene, p-methyl styrene, 2,4-dimethyl styrene, p-n-butyl styrene, p-tert-butyl styrene, p-n-hexyl styrene, p-n-octyl styrene, p-n-nonyl styrene, p-n-decyl styrene, p-n-dodecyl styrene, p-methoxystyrene and p-phenyl styrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethylphosphate ethyl acrylate, diethylphosphate ethyl acrylate, dibutylphosphate ethyl acrylate and 2-benzoyloxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethylphosphate ethyl methacrylate and dibutylphosphate ethyl methacrylate; methylene aliphatic monocarboxylic acid esters; vinyl esters such as vinyl acetate, vinyl propionate, vinyl butyrate, vinyl benzoate and vinyl formate; vinyl ethers such as vinyl methyl ether, vinyl ethyl ether and vinyl isobutyl ether; and vinyl ketones such as vinyl methyl ketone, vinyl hexyl ketone and vinyl isopropyl ketone.

Examples of multifunctional polymerizable monomers include diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′ -bis(4-(acryloxy diethoxy)phenyl)propane, trimethylolpropane triacrylate, tetramethylol methane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy diethoxy)phenyl)propane, 2,2′ -bis(4-(methacryloxy polyethoxy)phenyl)propane, trimethylolpropane trimethacrylate, tetramethylolmethanetetramethacrylate, divinylbenzene, divinylnaphthalene and divinyl ether.

The above monofunctional polymerizable monomers are used singly or in combinations of two or more types; alternatively, the above monofunctional polymerizable monomers and multifunctional monomers are used in combination.

Preferred polymerizable monomers that are used, other than styrene, include styrene derivatives, acrylic polymerizable monomers such as n-butyl acrylate or 2-ethylhexyl acrylate, and methacrylic polymerizable monomers such as n-butyl methacrylate or 2-ethylhexyl methacrylate. That is because the binder resin obtained by polymerizing these polymerizable monomers is superior in terms of strength and flexibility.

The polyester resin is preferably an amorphous polyester resin. The weight-average molecular weight (Mw) of the polyester resin is preferably from 6,000 to 100,000, more preferably from 6,500 to 85,000, and yet more preferably from 6,500 to 45,000.

When the weight-average molecular weight is 6,000 or higher, the external additive on the toner surface is less likely to become embedded on account of durable use in continuous image output, and drops in transferability are suppressed. If the weight-average molecular weight is 100,000 or lower, a toner can be readily obtained that has a small particle diameter and a uniform particle size distribution.

As a production method thereof, for instance the amorphous polyester resin may be produced through a dehydration condensation reaction of a carboxylic acid component and an alcohol component, or as a result of a transesterification reaction. The catalyst involved may be a general acidic or alkaline catalyst used in esterification reactions, for instance zinc acetate, a titanium compound or the like. Thereafter, the amorphous polyester resin may be purified to higher purity by recrystallization, distillation or the like.

A preferred production method involves a dehydration condensation reaction from a carboxylic acid component and an alcohol component, in terms of the diversity of starting materials and ease of reaction of such components.

Preferably, the polyester resin comprises 43 to 57 mol % of an alcohol component and 43 to 57 mol % of an acid component, relative to the total of the components.

A known alcohol component can be used to produce the polyester resin. The alcohol component may be for instance a diol such as ethylene glycol, neopentyl glycol, 2-ethyl-1,3-hexanediol, hydrogenated bisphenol A, a bisphenol derivative represented by formula (A) below, or a diol represented by formula (B) below.

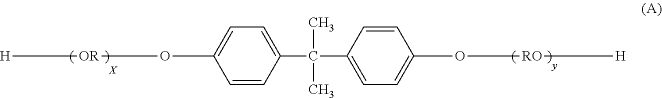

(In the formula, R represents an ethylene or propylene group, x and y each represents an integer equal to or greater than 1, such that the average value of x+y is from 0 to 10.)

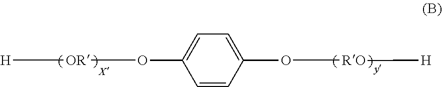

In the formula, R′ is

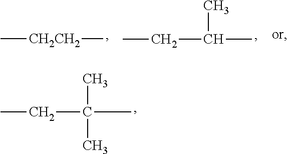

and x′ and y′ are each an integer equal to or greater than 0, such that the average value of x′+y′ is from 0 to 10.

Examples of divalent carboxylic acids include benzene dicarboxylic acids and anhydrides thereof, such as phthalic acid, terephthalic acid, isophthalic acid, phthalic anhydride, diphenyl-P,P′-dicarboxylic acid, naphthalene-2,7-dicarboxylic acid, naphthalene-2,6-dicarboxylic acid, diphenylmethane-P,P′-dicarboxylic acid, benzophenone-4,4′-dicarboxylic acid and 1,2-diphenoxy ethane-P,P′-dicarboxylic acid; alkyldicarboxylic acids and anhydrides thereof, such as succinic acid, adipic acid, sebacic acid, azelaic acid, glyceric acid, cyclohexanedicarboxylic acid, triethylenedicarboxylic acid and malonic acid; succinic acid substituted with a C6 to C18 alkyl group or alkenyl group, and anhydrides thereof; as well as unsaturated dicarboxylic acids and anhydrides thereof, such as fumaric acid, maleic acid, citraconic acid or itaconic acid.

Particularly preferable alcohol components are ethylene glycol and a bisphenol derivative represented by formula (A) above. Preferred acid components include dicarboxylic acids such as terephthalic acid and an anhydride thereof, succinic acid, n-dodecenyl succinic acid and an anhydride thereof, fumaric acid, maleic acid and maleic anhydride. Terephthalic acid and fumaric acid are particularly preferable.

A trivalent or higher polycarboxylic acid or a trihydric or higher polyol may be used in the polyester resin.

Examples of trivalent or higher polycarboxylic acids include trimellitic acid, pyromellitic acid, cyclohexanetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methylene carboxylpropane, 1,3-dicarboxyl-2-methyl-methylene carboxylpropane, tetra(methylene carboxyl)methane, as well as 1,2,7,8-octane tetracarboxylic acid, and anhydrides of the foregoing.

Examples of trihydric or higher polyols include sorbitol, 1,2,3,6-hexanetetrol, 1,4-sorbitan, pentaerythritol, dipentaerythritol, tripentaerythritol, sucrose, 1,2,4-methanetriol, glycerin, 2-methylpropanetriol, 2-methyl-1,2,4-butanetriol, trimethylolethane, trimethylolpropane and 1,3,5-trihydroxymethylbenzene.

The content of the trivalent or higher polycarboxylic acid is preferably 10.00 mol % or lower relative to the totality of acid monomer units. Similarly, the content of the trihydric or higher polyol is preferably 10.00 mol % or lower relative to the totality of alcohol monomer units. Contents within these ranges are preferable, in terms of pigment dispersibility, since in that case the crosslinking-derived insoluble fraction is small. In terms of durability, preferably the proportion of branched polyester resin is low, since in that case strength is excellent.

The polyester resin is preferably an aromatic saturated polyester. That is because the toner exhibits excellent charging performance, durability and fixing performance, and it is easier to control the physical properties of the toner and polyester. In particular, an aromatic saturated polyester brings out excellent charging performance derived from aromatic 7C electron interactions. Moreover, the fixing performance improves, since crosslinking is unlikelier.

The crystalline polyester resin can be preferably obtained as a result of a reaction between a divalent or higher polyvalent carboxylic acid with a dihydric or higher alcohol. Preferred among these is a polyester containing an aliphatic diol and an aliphatic dicarboxylic acid as main components, given the high degree of crystallinity of such a polyester. As the crystalline polyester resin there may be used a single type alone, or a plurality of types concomitantly. A crystalline polyester resin and an amorphous polyester resin may be used in combination.

The term crystalline polyester resin denotes a polyester resin exhibiting an endothermic peak during a rise in temperature and exhibiting a heat generation peak during a drop in temperature in a differential scanning calorimetric measurement (DSC), carried out in accordance with “ASTM D 3417-99”.

Examples of alcohol monomers for obtaining such a crystalline polyester resin include ethylene glycol, diethylene glycol, triethylene glycol, 1,2-propylene glycol, 1,3-propylene glycol, dipropylene glycol, trimethylene glycol, tetramethylene glycol, pentamethylene glycol, hexamethylene glycol, octamethylene glycol, nonamethylene glycol, decamethylene glycol, neopentyl glycol and 1,4-butadiene glycol.

In addition to the above components there may be used dihydric alcohols such as polyoxyethylated bisphenol A, polyoxypropylated bisphenol A or 1,4-cyclohexanedimethanol; aromatic alcohols such as 1,3,5-trihydroxymethylbenzene; and trihydric alcohols such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane or trimethylolpropane.

Examples of carboxylic acid monomers for obtaining a crystalline polyester include oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, itaconic acid, isophthalic acid, terephthalic acid, n-dodecylsuccinic acid, n-dodecenylsuccinic acid and cyclohexanedicarboxylic acid, as well as anhydrides and lower alkyl esters of these acids.

A trivalent or higher polyvalent carboxylic acid may be used besides the above components.

Examples of trivalent or higher polyvalent carboxylic acid components include trimellitic acid, 2,5,7-naphthalenetricarboxylic acid, 1,2,4-naphthalenetricarboxylic acid, pyromellitic acid, 1,2,4-butanetricarboxylic acid, 1,2,5-hexanetricarboxylic acid and 1,3-dicarboxyl-2-methyl-2-methylene carboxypropane, as well as derivatives of the foregoing such as acid anhydrides and lower alkyl esters.

The foregoing may be used as a single type alone, or in combinations of two or more types.

Particularly preferred crystalline polyester resins are herein a polyester obtained as a result of a reaction between 1,4-cyclohexanedimethanol and adipic acid; a polyester obtained as a result of a reaction between tetramethylene glycol, ethylene glycol, and adipic acid; a polyester obtained as a result of a reaction between hexamethylene glycol and sebacic acid; a polyester obtained as a result of a reaction between ethylene glycol and succinic acid; a polyester obtained as a result of a reaction between ethylene glycol and sebacic acid; a polyester obtained as a result of a reaction between tetramethylene glycol and succinic acid; and a polyester obtained as a result of a reaction between diethylene glycol and decanedicarboxylic acid. Yet more preferably, the crystalline polyester resin is a saturated polyester resin. That is because the cross-linking reaction does not occur in a reaction with peroxide-based polymerization initiator, as compared with a case where the crystalline polyester resin has an unsaturated moiety; this is advantageous in terms of the solubility of the crystalline polyester resin.

The crystalline polyester resin can be produced in accordance with an ordinary polyester synthesis method. For instance, the crystalline polyester resin can be obtained as a result of an esterification reaction or a transesterification reaction between a dicarboxylic acid component and a dialcohol component, followed by a polycondensation reaction in accordance with an ordinary method, under reduced pressure or under introduction of nitrogen gas.

The melting point (DSC endothermic peak) of the crystalline polyester resin ranges preferably from 50.0° C. to 90.0° C. Within the above range toner particle aggregation is unlikelier, the storability and fixing performance of the toner particle can be maintained, and solubility in polymerizable monomers is increased, in a case where the toner particle is produced in accordance with a polymerization method.

The melting point (DSC endothermic peak) of the crystalline polyester resin can be measured by differential scanning calorimetry (DSC). The melting point of the crystalline polyester resin can be adjusted for instance on the basis of the types of alcohol monomer and carboxylic acid monomer that are used, and the degree of polymerization.

The weight-average molecular weight (Mw) of the crystalline polyester resin is preferably from 5,000 to 35,000, more preferably from 10,000 to 35,000. A crystalline polyester having the above weight-average molecular weight (Mw) allows improving the dispersibility of the crystalline polyester resin and improving durability stability, in the toner particle that is obtained.

The density of the crystalline polyester becomes higher, and durability stability improves, in a case where the weight-average molecular weight (Mw) of the crystalline polyester resin is 5,000 or higher. On the other hand, when the weight-average molecular weight (Mw) of the crystalline polyester resin is 35,000 or lower, the crystalline polyester resin melts rapidly and the resulting dispersion state is uniform, which results in better development stability.

The weight-average molecular weight (Mw) of the crystalline polyester can be adjusted for instance on the basis of the types of alcohol monomer and carboxylic acid monomer that are used, the polymerization time, and the polymerization temperature.

The acid value (AV) of the crystalline polyester resin is preferably from 0.0 to 20.0 mgKOH/g, more preferably from 0.0 to 10.0 mgKOH/g, and yet more preferably from 0.0 to 5.0 mgKOH/g.

Adhesiveness between the toner and paper at the time of image formation is improved by lowering the acid value. In the production of a toner particle in accordance with a polymerization method, toner particle aggregation tends to be unlikelier to occur when the acid value (AV) of the crystalline polyester resin is 20.0 mgKOH/g or lower. Also, the distribution state of the crystalline polyester resin in the toner is less likely to be biased, and both charging stability and durability stability improve as a result.

Molecular Weight and Molecular Weight Distribution of a Crystalline Polyester Resin, an Amorphous Polyester Resin and a Styrene-Acrylic Resin

The molecular weight and molecular weight distribution of a sample are calculated, on a polystyrene basis, by gel permeation chromatography (GPC). To measure the molecular weight of a resin with acid group, prepare a sample with acid groups capped beforehand, since the column elution rate is also dependent on the amount of acid groups. Methyl esterification is preferable for accomplishing capping; a commercially available methyl esterifying agent can be used to that end. Specific examples include a method that involves a treatment with trimethylsilyldiazomethane.

A molecular weight measurement by GPC is carried out as follows.

Firstly, a measurement sample is dissolved in tetrahydrofuran (THF) at room temperature over 24 hours. The obtained solution is then filtered through a solvent-resistant membrane filter “MYSYORI DISC” (by Tosoh Corporation) having a pore diameter of 0.2 μm, to obtain a sample solution. The sample solution is adjusted so that the concentration of the THF-soluble component is 0.8 mass %. This sample solution is then used for measurements under the following conditions.

Device: HLC8120 GPC (detector: RI) (by Tosoh Corporation)

Column: 7 columns Shodex KF-801, 802, 803, 804, 805, 806, 807 (by Showa Denko KK)

Eluent: tetrahydrofuran (THF)

Flow rate: 1.0 mL/min

Oven temperature: 40.0° C.

Sample injection amount: 0.10 mL

To calculate the molecular weight of the measurement sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000 or A-500”, by Tosoh Corporation).

Glass Transition Temperature of Resins, Toner Particle, etc.

The glass transition temperature of a sample such as a resin is measured using a differential scanning calorimeter (DSC measuring device).

The differential scanning calorimetric measurement is performed in accordance with ASTM D3418-82, as follows, using a differential scanning calorimetry device “Q1000” (by TA Instruments Inc.). Specifically, 3 mg of measurement sample are weighed exactly, and are placed on a pan made of aluminum, and an aluminum-made pan is used as a reference. Equilibrium is maintained at 20° C. for 5 minutes, and thereafter a measurement is performed at a temperature increase rate of 10° C./min, within a measurement range from 20 to 180° C. The glass transition temperature can then be worked out in accordance with a midpoint method.

Structural Analysis of a Binder Resin and Other Resins

The structure of resins such as the binder resin can be elucidated using a nuclear magnetic resonance apparatus (¹H-NMR and/or ¹³C-NMR), and on the basis of FT-IR spectra. A description follows on the equipment that is used.

Each resin sample may be analyzed after being sampled through separation from the toner.

(i)¹H-NMR and ¹³C-NMR

FT-NMR JNM-EX400 by JEOL Ltd. (solvent used: deuterated chloroform)

(ii) FT-IR spectrum

AVATAR 360 FT-IR by Thermo Fisher Scientific Inc.

Measurement of the Acid Value of Resins such as Polyester Resins and Styrene-Acrylic Resins

The acid value is the number of milligrams of potassium hydroxide required to neutralize the acid contained in 1 g of the sample. The acid value in the present disclosure is measured according to JIS K 0070-1992, but specifically, it is measured according to the following procedure.

Titration is performed using a 0.1 mol/L potassium hydroxide ethyl alcohol solution (manufactured by Kishida Chemical Co., Ltd.). The factor of the potassium hydroxide ethyl alcohol solution can be determined by using a potentiometric titration device (potentiometric titration measuring device AT-510 manufactured by Kyoto Electronics Manufacturing Co., Ltd.). A total of 100 mL of 0.100 mol/L hydrochloric acid is taken in a 250 mL tall beaker, titration is performed with the potassium hydroxide ethyl alcohol solution, and the factor is determined from the amount of the potassium hydroxide ethyl alcohol solution required for neutralization. The 0.100 mol/L hydrochloric acid prepared according to JIS K 8001-1998 is used.

The measurement conditions for acid value measurement are shown below.
Titration device: potentiometric titration device AT-510 (manufactured by Kyoto Electronics Manufacturing Co., Ltd.)
Electrode: composite glass electrode, double junction type (manufactured by Kyoto Electronics Manufacturing Co., Ltd.)
Control software for titrator: AT-WIN
Titration analysis software: Tview

The titration parameters and control parameters at the time of titration are as follows.
(Titration Parameters)
Titration mode: blank titration
Titration style: total titration
Maximum titration amount: 20 mL
Waiting time before titration: 30 sec
Titration direction: automatic
(Control Parameters)
End point determination potential: 30 dE
End point determination potential value: 50 dE/dmL
End point detection and determination: not set
Control speed mode: standard
Gain: 1
Data collection potential: 4 mV
Data collection titration amount: 0.1 mL

Main test: 0.100 g of the measurement sample is precisely weighed in a 250 mL tall beaker, 150 mL of a mixed solution of toluene/ethanol (3:1) is added, and the dissolution is performed over 1 h. Titration is performed with the potentiometric titrator by using the potassium hydroxide ethyl alcohol solution.

Blank test: titration similar to the above procedure is performed, except that no sample is used (that is, only a mixed solution of toluene/ethanol (3:1) is used). The acid value is calculated by substituting the obtained result into the following formula.

A=[(C−B)×f×5.61]/S

In the formula, A: acid value (mg KOH/g), B: addition amount of potassium hydroxide ethyl alcohol solution in the blank test (mL), C: addition amount of potassium hydroxide ethyl alcohol solution in the main test (mL), f: potassium hydroxide solution factor, S: sample mass (g).

Measurement of the Hydroxyl Value of Resins such as Polyester Resins and Styrene-Acrylic Resins

The hydroxyl value is the number of mg of potassium hydroxide necessary for neutralizing acetic acid bonded to hydroxyl groups, upon acetylation of 1 g of sample. The hydroxyl value is measured according to JIS K 0070-1992; the procedure involved is as follows.

Specifically, 25.0 g of special grade acetic anhydride are placed in a 100 mL volumetric flask, and pyridine is added to bring the total volume to 100 mL, with thorough shaking, to yield an acetylation reagent. The obtained acetylation reagent is stored in a brown bottle so as to preclude contact with moisture, carbon dioxide or the like.

Titration is then performed using a 1.0 mol/L ethyl alcohol solution of potassium hydroxide (by Kishida Chemical Co., Ltd.). The factor of the ethyl alcohol solution of potassium hydroxide is determined using a potentiometric titration apparatus (potentiometric titration measuring device AT-510, produced by Kyoto Electronics Manufacturing Co., Ltd.). Specifically, 100 mL of 1.00 mol/L hydrochloric acid are placed in a 250 mL tall beaker, and titration with the ethyl alcohol solution of potassium hydroxide is performed, whereupon the factor of the ethyl alcohol solution of potassium hydroxide is worked out from the amount thereof required for neutralization. The 1.00 mol/L hydrochloric acid that is used is prepared according to JIS K 8001-1998.

The measurement conditions for hydroxyl value measurement are shown below.
Titration device: potentiometric titration device AT-510 (manufactured by Kyoto Electronics Manufacturing Co., Ltd.)
Electrode: composite glass electrode, double junction type (manufactured by Kyoto Electronics Manufacturing Co., Ltd.)
Control software for titrator: AT-WIN
Titration analysis software: Tview

The titration parameters and control parameters at the time of titration are as follows.
(Titration Parameters)
Titration mode: blank titration
Titration style: total titration
Maximum titration amount: 80 mL
Waiting time before titration: 30 sec
Titration direction: automatic
(Control Parameters)
End point determination potential: 30 dE
End point determination potential value: 50 dE/dmL
End point detection and determination: not set
Control speed mode: standard
Gain: 1
Data collection potential: 4 mV
Data collection titration amount: 0.5 mL

Main Test

Then 2.00 g of the measurement sample are precisely weighed in a 200 mL round bottom flask, and 5.00 mL of the above acetylation reagent are accurately added thereto, using a whole pipette. If the sample proves difficult to dissolve in the acetylation reagent, a small amount of special-grade toluene is added to dissolve the sample.

A small funnel is placed on the mouth of the flask, and about 1 cm of the bottom of the flask is heated by being immersed in a glycerin bath at about 97° C. Preferably, the base of the neck of the flask is covered with heavy paper having a round hole opened therein, in order to prevent the temperature of the neck of the flask from rising by absorbing heat from the bath.

After 1 hour the flask is removed from the glycerin bath and is allowed to cool down. After cool-down, 1.00 mL of water is added through the funnel, with shaking to elicit hydrolysis of acetic anhydride. The flask is heated again in the glycerin bath for 10 minutes, for the purpose of completing hydrolysis. After cool-down, the walls of the funnel and flask are washed with 5.00 mL of ethyl alcohol.

The obtained sample is transferred to a 250 mL tall beaker, 100 mL of a mixed solution of toluene and ethanol (3:1) is added, and the whole is dissolved over 1 hour. Titration is performed using the ethyl alcohol solution of potassium hydroxide, in a potentiometric titration apparatus.

Blank Test

The same titration operation as above is performed, but using herein no sample (i.e. using only a mixed solution of toluene and ethanol (3:1)).

The obtained result is substituted into the following expression, to calculate the hydroxyl value.

A=[{(B−C)×28.05×f}/S]+D

In the expression, A: hydroxyl value (mgKOH/g), B: addition amount (mL) of ethyl alcohol solution of potassium hydroxide in the blank test, C: addition amount (mL) of ethyl alcohol solution of potassium hydroxide in the main test, f: factor of the ethyl alcohol solution of potassium hydroxide, S: sample mass (g), and D: acid value of the sample (mgKOH/g).

Wax

A wax may be used in the toner. The wax is not particularly limited, and a known wax can be used.

Examples of waxes that can be used include hydrocarbon waxes such as paraffin wax, polyolefin wax, microcrystalline wax and Fischer-Tropsch wax; polymethylene wax; amide wax; petroleum waxes and derivatives thereof such as petrolatum; montan wax and derivatives thereof; natural waxes and derivatives thereof such as carnauba wax and candelilla wax; hardened castor oil and derivatives thereof; as well as vegetable waxes, animal waxes, higher fatty acids, long-chain alcohols, ester waxes, ketone waxes, and derivatives thereof such as graft compounds and block compounds.

The foregoing can be used singly or in combination. Hydrocarbon waxes are preferable, from the viewpoint of the blocking resistance, multisheet durability, low-temperature fixing performance and offset resistance of the toner.

At least one of the waxes preferably has a melting point from 65 to 120° C., more preferably from 65 to 90° C. Preferably, the wax is solid at room temperature; in particular, a solid wax having a melting point from 65 to 90° C. is preferable from the viewpoint of blocking resistance, multisheet durability, low-temperature fixing performance and offset resistance of the toner.

The content of wax in the toner is preferably from 3 to 30 parts by mass, relative to 100 parts by mass of binder resin. The deviation prevention effect is not impaired when the wax content is equal to or higher than the above lower limit. When the content is at or below the above upper limit value, the offset resistance effect can be readily elicited without detracting from the blocking resistance effect, and fusion of the toner to a drum and melt adhesion of the toner to a developing sleeve can be suppressed.

In a case where it is necessary to extract the wax from the toner in order to determine the above physical characteristics, the extraction method that is resorted to is not particularly limited, and any method can be used. For instance, a predetermined amount of toner is Soxhlet-extracted with toluene, and then the solvent is removed from the obtained toluene-soluble fraction, to obtain thereafter a chloroform-insoluble fraction. Identification analysis is performed thereafter in accordance with an IR method or the like.

Quantitative analysis is performed using a differential scanning calorimeter (DSC) or the like. Specifically, the measurement is performed using DSC-2920, by TA Instruments Japan Inc. The intersection between a differential heat curve and a midpoint line of the baseline before and after a change in specific heat at the time of measurement is taken herein as the glass transition point. The maximum temperature of an endothermic peak of the wax component is obtained from the obtained DSC curve at the time of temperature rise.

Charge Control Agent

A known charge control agent can be used as the toner. The content of the charge control agent is preferably from 0.01 to 20 parts by mass, more preferably from 0.5 to 10 parts by mass, relative to 100 parts by mass of binder resin.

Colorant

The toner particle may include a colorant. Pigments and dyes can be used as the colorant.

Examples of pigments used in cyan-based colorants include copper phthalocyanine compounds and derivatives thereof, anthraquinone compounds, basic dye lake compounds, and the like. Specifical examples include C. I. Pigment Blue 15, 15:1, 15:2, 15:3, 15:4.

Examples of pigments used in magenta colorants include condensed azo compounds, diketopyrrolopyrrole compounds, anthraquinone compounds, quinacridone compounds, basic dye lake compounds, naphthol compounds, benzimidazolone compounds, thioindigo compounds, perylene compounds, and the like. Specifical examples include C. I. Pigment Violet 19, C. I. Pigment Red 31, 32, 122, 150, 254, 264 and 269.

Examples of pigments used in yellow colorants include condensed azo compounds, isoindolinone compounds, anthraquinone compounds, azo metal complexes, methine compounds, and allylamide compounds. Specific examples include C. I. Pigment Yellow 74, 93, 120, 139, 151, 155, 180, and 185.

Examples of black colorants include carbon black, magnetic body, and those colored black using the above-mentioned yellow colorant, magenta colorant and cyan colorant.

The pigments are preferably carbon black, C. I. Pigment Blue 15:3, C. I. Pigment Red 122, 150, 32 or 269, and C. I. Pigment Yellow 155, 93, 74, 180 or 185. Particularly preferable are carbon black, C. I. Pigment Blue 15:3, and C. I. Pigment Red 122. In the case of carbon black, preferably, the oil absorption amount (DBP) thereof is from 30 (ml/100 g) to 120 (ml/100 g), at a pH of 6 or higher.

The content of these colorants is preferably from 1 to 20 parts by mass relative to 100 parts by mass of binder resin.

Other Additives

Various known inorganic and organic additives may be added to the toner, for the purpose of imparting various characteristics, so long as the above effects are not impaired. Preferably, the additives that are used have a particle diameter of 3/10 or less of the weight-average diameter of the toner particle, from the viewpoint of durability upon addition to the toner. The particle diameter of the additive denotes herein the average particle diameter obtained by observing the surface of a toner particle with a scanning electron microscope.

The content of these additives is preferably from 0.01 to 10 parts by mass, more preferably from 0.02 to 3 parts by mass, relative to 100 parts by mass of the toner particle. These additives may be used singly or in combinations of two or more types.

Moreover, these additives may be subjected to a hydrophobic treatment. As a hydrophobic treatment method, various coupling agents such as a silane coupling agent or a titanium coupling agent can be used, but preferably hydrophobicity is increased herein by using a silicone oil. That is because a silicone oil allows suppressing adsorption of moisture by the inorganic fine powder under high humidity, and allows further suppressing contamination of regulating member and charging member, thanks to which a high-quality image can be obtained

An explanation follows next on a method for producing a toner particle.

The method for producing the toner particle is not particularly limited. Examples include methods (hereafter also referred to as polymerization methods) in which a toner particle is produced directly in a hydrophilic medium, such as suspension polymerization, interfacial polymerization, dispersion polymerization, emulsification aggregation, dissolution suspension and the like. A pulverization method may also be resorted to, and the toner particle obtained by pulverization may be subjected to thermal spheroidizing.

Among the foregoing, a toner particle is preferred that is produced by suspension polymerization, emulsification aggregation or dissolution suspension, and that exhibits high transferability, since in that case individual particles are substantially equally spherical, and also the charge quantity distribution is comparatively uniform.

The following are examples of a method for producing toner particles by a pulverization method.

In a raw material mixing step, a binder resin, and if necessary, a colorant, and other additives are weighed in predetermined amounts, compounded, and mixed as materials constituting the toner particles. Examples of the mixing device include a double-cone mixer, a V-type mixer, a drum-type mixer, a Super mixer, an FM mixer, a Nauta mixer, MechanoHybrid (manufactured by Nippon Coke & Engineering, Ltd.), and the like.

Next, the mixed materials are melt-kneaded to disperse the colorant and the like to binder resin, and obtain a kneaded product. In the melt-kneading step, a batch-type kneader such as a pressure kneader or a Banbury mixer, or a continuous kneader can be used. Single-screw or twin-screw extruders are preferable because of their superiority in continuous production. Examples thereof include a KTK type twin-screw extruder (manufactured by Kobe Steel, Ltd.), a TEM type twin-screw extruder (manufactured by Toshiba Machine Co., Ltd.), a PCM kneader (manufactured by Ikegai Corp.), a twin-screw extruder (manufactured by KCK Engineering Co.), a co-kneader (manufactured by Buss AG), Kneadex (manufactured by Nippon Coke & Engineering Co., Ltd.), and the like. Further, the resin composition obtained by melt-kneading may be rolled using two rolls or the like, and may be cooled for instance with water, in a cooling step.

The cooled product of the resin composition may be then pulverized to a desired particle diameter, in a pulverization step. In the pulverization step, coarse pulverization using crushing equipment can be followed by further pulverization using a pulverizer. Examples of the crushing equipment include a crusher, a hammer mill and a feather mill. Examples of the pulverizer include CRIPTRON SYSTEM (by Kawasaki Heavy Industries, Ltd.), SUPER ROTOR (by Nisshin Engineering Inc.), TURBO MILL (by Turbo Kogyo Co., Ltd.), and a pulverizer of an air jet system.

This is followed as needed by classification using a classifier or sieve machine such as the following ones. For classification there can be used an ELBOW JET (by Nittetsu Mining Co., Ltd.), which is an inertial classification system, TURBOPLEX (by Hosokawa Micron Corporation), TSP SEPARATOR (by Hosokawa Micron Corporation), or FACULTY (by Hosokawa Micron Corporation), which are centrifugal classification systems.

Further, the toner particle may be spheroidized. Examples of the system and the like that can be used for spheroidizing after pulverization include the following. Hybridization System (manufactured by Nara Machinery Co., Ltd.), Mechanofusion System (manufactured by Hosokawa Micron Corporation), Faculty (manufactured by Hosokawa Micron Corporation), and Meteo Rainbow MR Type (manufactured by Nippon Pneumatic Mfg. Co., Ltd.).

Emulsification aggregation will be explained next as a production method.

Emulsification aggregation is a production method for producing core particles by preparing beforehand resin fine particles sufficiently small for a target particle diameter, and by aggregating these resin fine particles in an aqueous medium. In an emulsification aggregation method, the toner particle is produced as a result of an emulsification step, an aggregation step, a fusion step, a cooling step, and a washing step of resin fine particles. A shell formation step can be added after the cooling step, to obtain a core-shell toner.

Emulsification Step of Resin Fine Particles

Resin fine particles having a resin such as polyester resin as a main component can be prepared in accordance with a known method. For instance the above resin is dissolved in an organic solvent, the resulting solution is added to an aqueous medium, and particles are dispersed in the aqueous medium together with a surfactant and a polymer electrolyte using a disperser such as a homogenizer, after which the solvent is removed through heating or pressure reduction, so that a resin particle dispersion can be produced as a result. As the organic solvent used for dissolution there can be used any organic solvent that dissolves the resin; however, for instance tetrahydrofuran, ethyl acetate and chloroform are preferred herein from the viewpoint of having high solubility.

In terms of environmental load, preferably the above resin, a surfactant, a base and so forth are added into an aqueous medium, and emulsification dispersion is performed in the aqueous medium containing substantially no organic solvent, using a disperser that imparts high-speed shear forces, such as CLEARMIX, a homomixer or a homogenizer.

Particularly preferably, the content of organic solvent having a boiling point of 100° C. or lower is 100 μg/g or less. Within the above ranges, production of the toner does not require a new step of removing and recovering the organic solvent, and thus the wastewater treatment burden is lessened. The organic solvent content in the aqueous medium can be measured by gas chromatography (GC).

The surfactant used at the time of emulsification is not particularly limited, and examples thereof include the following. Anionic surfactants of sulfate ester salt type, sulfonate salt type, carboxylate type, phosphate ester type, soap type and the like; cationic surfactants of amine salt type, quaternary ammonium salt type and the like; and nonionic surfactants of polyethylene glycol type, alkylphenol ethylene oxide adduct type, polyhydric alcohol type and the like. The surfactant may be used singly as one type alone, or in combinations of two or more types.

The median diameter of the resin fine particles on a volume distribution basis is preferably from 0.05 to 1.0 μm, more preferably from 0.05 to 0.4 μm. If the median diameter of the resin fine particles is 1.0 μm or smaller, it is easy to obtain a toner particle exhibiting a median diameter from 4.0 to 7.0 μm, which is an appropriate toner particle median diameter on a volume distribution basis. The median diameter on a volume distribution basis can be measured by using a particle size distribution analyzer of dynamic light scattering type (Nanotrac UPA-EX150: by Nikkiso Co., Ltd.).

Aggregation Step

In the aggregation step, the above resin fine particles, plus, as needed, colorant fine particles, wax fine particles and so forth, are mixed to prepare a mixed solution, whereupon an aggregate is subsequently formed through aggregation of the particles contained in the prepared mixed solution. The method for forming the aggregates may suitably be for instance a method in which a flocculant is added to and mixed with the above mixed solution, under appropriate application of temperature and mechanical power.

Examples of the flocculant include metal salts of monovalent metals such as sodium and potassium; metal salts of divalent metals such as calcium and magnesium; and metal salts of trivalent metals such as iron and aluminum.

Addition and mixing of the flocculant are preferably accomplished at a temperature equal to or lower than the glass transition temperature (Tg) of the resin particles contained in the mixed solution. Aggregation proceeds in a stable state when the above mixing is carried out under these temperature conditions. The above mixing can be accomplished using a known mixing device, homogenizer, mixer or the like.

The weight-average particle diameter of the aggregates formed herein is not particularly limited, but may ordinarily be controlled to range from 4.0 to 7.0 μm, so as to be comparable to the weight-average particle diameter of the toner particle to be obtained. Control of the weight-average particle diameter of the aggregates can be easily accomplished for instance by setting/modifying as appropriate the temperature at the time of addition/mixing of the flocculant and so forth, and the stirring/mixing conditions. The particle size distribution of the toner particle can be measured using a particle size distribution analyzer (Coulter Multisizer III: by Beckman Coulter Inc.) in accordance with the Coulter method.

Fusion Step

The fusion step is a step of producing particles resulting from smoothing the surface of the aggregates, through heating and fusion of the aggregates at or above the glass transition temperature (Tg). Before entering a primary fusion step, a chelating agent, a pH adjuster, a surfactant or the like can be added as appropriate in order to prevent melt adhesion between toner particles.

Examples of chelating agents include the following. Alkali metal salts such as ethylenediaminetetraacetic acid (EDTA) and a Na salt thereof; sodium gluconate, sodium tartrate, potassium citrate and sodium citrate; a nitrotriacetate (NTA) salt; and numerous water-soluble polymers having both COOH and OH functionalities (polymer electrolytes).

The heating temperature may lie between the glass transition temperature (Tg) of the resin contained in the aggregates and the thermal decomposition temperature of the resin. A short lapse of time is sufficient as the heating/fusion time so long as the heating temperature is high, whereas a long time is required if the heating temperature is low. Specifically, the heating/fusion time depends on the heating temperature, and cannot be prescribed categorically, but ordinarily ranges from 10 minutes to 10 hours.

Cooling Step

The cooling step is a step of lowering the temperature of the aqueous medium that comprises the above particles down to a temperature lower than the glass transition temperature (Tg) of the resin that is used. Formation of coarse particles may occur if cooling is not performed down to a temperature lower than Tg. The concrete cooling rate is herein from 0.1 to 50° C./min.

Shell Formation Step

A shell formation step can further be added, as needed, that precedes the washing and drying step described below. The shell formation step is a step of newly adding resin fine particles to the particles produced in the previous steps, and causing the newly added particles to adhere onto the former, to form a shell.

The resin fine particles that are added herein may have the same structure as that of the resin fine particles used for the core, or may have a different structure.

The resin that makes up such a shell layer is not particularly limited, and examples thereof include known resins used in toners.

For instance, a vinyl polymer such as a polyester resin or a styrene-acrylic copolymer, or an epoxy resin, a polycarbonate resin, a polyurethane resin or the like can be used herein. Preferred among the foregoing are polyester resins and styrene-acrylic copolymers, and in terms of fixing performance and high durability, a polyester resin more preferably.

A polyester resin having a rigid aromatic ring in the main chain can impart comparable mechanical strength as in the case of a vinyl polymer, but with a lower molecular weight than a vinyl polymer, since a polyester resin having a rigid aromatic ring in the main chain is more flexible than a vinyl polymer such a styrene-acrylic copolymer. Therefore, a polyester resin is preferable also as a resin suitable for low-temperature fixing performance.

The resin that makes up the shell layer may be used singly, or in combinations of two or more types.

Washing and Drying Step

The particles produced as a result of the above steps are washed with ion-exchanged water having had the pH thereof adjusted with sodium hydroxide or potassium hydroxide, are filtered, and are subsequently washed with ion-exchanged water and filtered a plurality of times. An emulsified aggregated toner particle can be obtained thereafter through drying.

In the case of suspension polymerization, toner can be produced directly in accordance with the production method below.

Suspension polymerization is a method for producing a toner particle through a granulation step and a polymerization step. In the granulation step, a polymerizable monomer composition having a polymerizable monomer that generates a binder resin and, as needed, additives such as a colorant and a wax, is dispersed in an aqueous medium; droplets of the polymerizable monomer composition can be produced as a result. The polymerizable monomer in the droplets can be polymerized in the polymerization step.

Preferred examples of the polymerizable monomer that can be used in order to produce the binder resin include the vinyl-based polymerizable monomers described above.

The polymerizable monomer composition is obtained by adding as needed, to the polymerizable monomer, a polar resin such as a polyester resin, a wax, a colorant, a crosslinking agent and other additives, with uniform dissolution or dispersion using a homogenizer, an ultrasonic disperser or the like.

The obtained polymerizable monomer composition is dispersed in an aqueous medium having a dispersion stabilizer, using an ordinary stirrer, homomixer, homogenizer or the like. At that time, the stirring speed/duration are adjusted so that the droplets of the polymerizable monomer composition yield a desired toner size, and particles of the polymerizable monomer composition are produced through granulation.

Thereafter, stirring may be performed so that the particulate state is maintained and settling of particles is prevented, thanks to the action of the dispersion stabilizer. A polymerization initiator is added, as needed, to conduct the polymerization reaction. The polymerization temperature is ordinarily set to 40° C. or higher, and preferably to a temperature from 50 to 120° C. In a case where the polymerization temperature is 95° C. or higher, the vessel in which the polymerization reaction is carried out may be pressurized, to suppress evaporation of the aqueous medium.

The temperature may be raised in the latter half of the polymerization reaction, and the pH may be modified as needed. Further, the reaction temperature may be raised in the latter half of the reaction, or part of the aqueous medium may be distilled off in the latter half of the reaction, or once the reaction is over, in order to remove unreacted polymerizable monomers, by-products and the like that give rise to odor at the time of fixing. A produced toner particle precursor dispersion is obtained once the reaction is over. The toner particle precursor dispersion is concentrated, cooled, washed and collected by filtration, and is dried.

The pH in the aqueous medium during granulation is not particularly limited, but pH is preferably from 3.0 to 13.0, more preferably from 3.0 to 7.0, and yet more preferably from 3.0 to 6.0. In a case where granulation is performed in an acidic region, it is possible to curtail excessive content of metals in the toner, derived from the dispersion stabilizer.

Preferably, the toner particle is washed with an acid having a pH of 2.5 or lower, more preferably a pH of 1.5 or lower. The amount of dispersion stabilizer present on the surface of the toner particle can be reduced by washing thus the toner particle with an acid. The acid used for washing is not particularly limited, and an inorganic acid such as hydrochloric acid or sulfuric acid can be used herein. This allows adjusting the charging performance of the toner particle so as to lie within a desired range.

Besides poorly water-soluble inorganic fine particles as the dispersion stabilizer, organic compounds such as polyvinyl alcohol, gelatin, methyl cellulose, methylhydroxypropyl cellulose, ethyl cellulose, a sodium salt of carboxymethyl cellulose, or starch may be used concomitantly. Preferably, the dispersion stabilizer is used in an amount of from 0.01 to 2.0 parts by mass relative to 100 parts by mass of the polymerizable monomer.

Further, 0.001 to 0.1 mass % of a surfactant may be used concomitantly for the purpose of making these dispersion stabilizers finer. Specifically, commercially available nonionic, anionic and cationic surfactants can be used herein.

For instance sodium dodecyl sulfate, sodium tetradecyl sulfate, sodium pentadecyl sulfate, sodium octyl sulfate, sodium oleate, sodium laurate, potassium stearate or calcium oleate is preferably used.

Other production equipment will be explained next. Although known equipment can be used, examples of stirring means in the granulation step include paddle blades, pitched paddle blades, three-wing backswept blades, anchor blades, as well as by FULLZONE (Shinko Pantec Co., Ltd.), Maxblend (Sumitomo Heavy Industries, Ltd.), Super-Mix (Satake Chemical Equipment Mfg., Ltd.), and Hi-F Mixer (Soken Chemical & Engineering Co., Ltd.).

In addition, a stirrer capable of imparting high shear forces is more preferable herein. As a high-shear stirrer there is preferably used a stirrer provided with a stirring chamber formed by a stirring rotor that rotates at high speed and a screen provided so as to surround the stirring rotor.

Concrete examples include Ultra-Turrax (by IKA Werke GmbH & Co. KG), Polytron (Kinematica AG), T. K. Homomixer (by Tokushu Kika Kogyo Co., Ltd.), Clearmix (by M Technique Co., Ltd.), W-Motion (by M Technique Co., Ltd.), Cavitron (by Eurotec, Ltd,) and Sharp Flow Mill (by Primix Corporation Co., Ltd,).

The weight-average particle diameter (D4) of the toner is preferably from 4.0 to 12.0 μm, more preferably from 4.0 to 9.0 μm. When the weight-average particle diameter is 4.0 μm or larger, durability and heat resistance in long-term use are good, and when the weight-average particle diameter is 12.0 μm or smaller, the tinting strength of the toner and image resolution are likewise good.

Method for Measuring Weight-Average Particle Diameter (D4) and Number-Average Particle Diameter (D1) of Toner

The weight-average particle diameter (D4) and the number-average particle diameter (D1) of the toner is calculated in the manner described below. A precision particle size distribution measuring apparatus based on a pore electric resistance method with a 100 μm aperture tube (a Coulter Counter Multisizer 3 (registered trademark) produced by Beckman Coulter, Inc.) and dedicated software for the measurement apparatus (Beckman Coulter Multisizer 3 Version 3.51 produced by Beckman Coulter, Inc.) for setting measurement conditions and analysis of measured data are used for measurement. The measurements are carried out using 25,000 effective measurement channels.

A solution obtained by dissolving special grade sodium chloride in ion exchanged water at a concentration of approximately 1 mass %, such as “ISOTON II” (produced by Beckman Coulter), can be used as an aqueous electrolyte solution used in the measurements.

The dedicated software was set up in the following way before carrying out measurements and analysis. On the “Standard Operating Method (SOM) alteration” screen in the dedicated software, the total count number in control mode is set to 50,000 particles, the number of measurements is set to 1, and the Kd value is set to the value obtained by using “standard particle 10.0 μm” (Beckman Coulter). By pressing the “Threshold value/noise level measurement button”, threshold values and noise levels are automatically set. In addition, the current is set to 1600 μA, the gain is set to 2, the electrolyte solution is set to ISOTON II, and the “Flush aperture tube after measurement” option is checked.

On the “Conversion settings from pulse to particle diameter” screen in the dedicated software, the bin interval is set to logarithmic particle diameter, the particle diameter bin is set to 256 particle diameter bin, and the particle diameter range is set to from 2 μm to 60 μm.

The specific measurement method is as follows.
1. 200 mL of the aqueous electrolyte solution is placed in a dedicated Multisizer 3 250 mL glass round bottomed beaker, the beaker is set on a sample stand, and a stirring rod is rotated anticlockwise at a rate of 24 rotations/second. By carrying out the “Aperture tube flush” function of the dedicated software, dirt and bubbles in the aperture tube are removed.
2. Approximately 30 mL of the aqueous electrolyte solution is placed in a 100 mL glass flat bottomed beaker. Approximately 0.3 mL of a diluted liquid, which is obtained by diluting “Contaminon N” (a 10 mass % aqueous solution of a neutral detergent for cleaning precision measurement equipment, which has a pH of 7 and comprises a non-ionic surfactant, an anionic surfactant and an organic builder, available from Wako Pure Chemical Industries, Ltd.) approximately 3-fold in terms of mass with ion exchanged water, is added to the beaker as a dispersant.
3. An ultrasonic wave disperser (Ultrasonic Dispersion System Tetra 150 produced by Nikkaki Bios Co., Ltd.) having an electrical output of 120 W, in which two oscillators having an oscillation frequency of 50 kHz are housed so that their phases are staggered by 180° is prepared. A predetermined amount of ion exchanged water is placed in a water bath in the ultrasonic dispersion system, and approximately 2 mL of Contaminon N is added to this water bath.
4. The beaker mentioned in step (2) above is placed in a beaker-fixing hole in the ultrasonic wave disperser, and the ultrasonic wave disperser is activated. The height of the beaker is adjusted so that the resonant state of the liquid surface of the aqueous electrolyte solution in the beaker is at a maximum.
5. While the aqueous electrolyte solution in the beaker mentioned in section (4) above is being irradiated with ultrasonic waves, approximately 10 mg of toner is added a little at a time to the aqueous electrolyte solution and dispersed therein. The ultrasonic wave dispersion treatment is continued for a further 60 seconds. When carrying out the ultrasonic wave dispersion, the temperature of the water bath is adjusted as appropriate to a temperature of from 10 to 40° C.
6. The aqueous electrolyte solution mentioned in section (5) above, in which the toner is dispersed, is added dropwise by means of a pipette to the round bottomed beaker mentioned in section (1) above, which is disposed on the sample stand, and the measurement concentration is adjusted to approximately 5%. Measurements are carried out until the number of particles measured reaches 50,000.
7. The weight-average particle diameter (D4) and the number-average particle diameter (D1) are calculated by analyzing measurement data using the accompanying dedicated software. The “AVERAGE DIAMETER” on the “ANALYSIS/VOLUME STATISTICAL VALUE (ARITHMETIC MEAN)” screen when the special software is set to graph/volume% is the weight average particle diameter (D4). The “AVERAGE DIAMETER” on the “ANALYSIS/NUMBER STATISTICAL VALUE (ARITHMETIC MEAN)” screen when the special software is set to graph/number% is the number average particle diameter (D1).

The glass transition temperature of the toner particle is preferably from to 75° C., from the viewpoint of storability and fixing performance.

The average circularity of the toner particle is preferably 0.950 or higher, more preferably 0.960 or higher. That is because such values entail a higher probability of uniform triboelectric charging between toner particles, with a toner carrying member, and with a toner layer thickness control member, which is preferable in terms of charging performance and melt adhesion on the toner layer thickness control member.

Method for Measuring Average Circularity of Toner

The average circularity of the toner is measured with an “FPIA-3000” flow particle image analyzer (Sysmex Corporation) under the measurement and analysis conditions for calibration operations.

The specific measurement methods are as follows. 20 mL of ion-exchange water from which solid impurities and the like have been removed is first placed in a glass container. 0.2 mL of a dilute solution of “Contaminon N” (a 10 mass % aqueous solution of a pH 7 neutral detergent for washing precision instruments, comprising a nonionic surfactant, an anionic surfactant and an organic builder, manufactured by Wako Pure Chemical Industries, Ltd.) diluted three times by mass with ion-exchange water is then added as a dispersant. 0.02 g of the measurement sample is then added and dispersed for 2 minutes with an ultrasonic disperser to obtain a dispersion for measurement. Cooling is performed as appropriate during this process so that the temperature of the dispersion is 10 to 40° C. Using a tabletop ultrasonic cleaner and disperser having an oscillating frequency of 50 kHz and an electrical output of 150 W (for example, “VS-150” manufactured by Velvo-Clear) as an ultrasonic disperser, a predetermined amount of ion-exchange water is placed on the water tank, and 2 mL of the Contaminon N is added to the tank.

For the measurement, a flow type particle image analyzer equipped with “LUCPLFLN” (magnification 20 times, numerical aperture 0.40) as an objective lens is used, and a particle sheath “PSE-900A” (manufactured by Sysmex Corporation) is used as a sheath liquid. The liquid dispersion obtained by the procedures above is introduced into the flow particle image analyzer, and 2,000 toner particles are measured in HPF measurement mode, total count mode. The average circularity of the toner is then determined with a binarization threshold of 85% during particle analysis, and with the analyzed particle diameters limited to equivalent circle diameters of from 1.977 to less than 39.54 μm.

Prior to the start of measurement, autofocus adjustment is performed using standard latex particles (for example, Duke Scientific Corporation “RESEARCH AND TEST PARTICLES Latex Microsphere Suspensions 5100A” diluted with ion-exchange water). Autofocus adjustment is then performed again every two hours after the start of measurement.

In the examples in the present application, the flow particle image analyzer used had been calibrated by the Sysmex Corporation and had been issued a calibration certificate by the Sysmex Corporation. The measurements were carried out under the same measurement and analysis conditions as when the calibration certification was received, with the exception that the analyzed particle diameter was limited to a circle-equivalent diameter of from 1.977 to 39.54 μm.

### EXAMPLES

The present invention will be described in more detail hereinbelow with reference to Examples and Comparative Examples, but the present invention is not limited thereto. Unless otherwise specified, the parts used in the examples are based on mass.

Production of Amorphous Polyester Resin 1

Terephthalic acid: 75 parts

Propylene oxide 2-mole adduct of bisphenol A: 100 parts

Tetrabutoxytitanate: 0.125 parts

The above polyester monomers were charged in an autoclave equipped with a pressure-reducing device, a water separating device, a nitrogen gas introducing device, a temperature measuring device and a stirring device, and the reaction was conducted at 200° C. for 5 hours in a nitrogen atmosphere at normal pressure. Thereafter, 2.1 parts of trimellitic acid and 0.120 parts of tetrabutoxytitanate were added, and were caused to react at 220° C. for 3 hours, with further reaction under reduced pressure from 10 to 20 mmHg for 2 hours, to yield Amorphous polyester resin 1.

The physical properties of the obtained Amorphous polyester resin 1 were acid value=8.3 mgKOH/g, hydroxyl value=33.3 mgKOH/g, weight-average molecular weight (Mw)=10000 and DSC endothermic peak=72.5° C.

Production of Amorphous polyester resin 2

Terephthalic acid: 60 parts

Fumaric acid: 15 parts

Propylene oxide 2-mole adduct of bisphenol A: 100 parts

Tetrabutoxytitanate: 0.125 parts

The above polyester monomers were charged in an autoclave equipped with a pressure-reducing device, a water separating device, a nitrogen gas introducing device, a temperature measuring device and a stirring device, and the reaction was conducted at 200° C. for 5 hours in a nitrogen atmosphere at normal pressure. Thereafter, 2.1 parts of trimellitic acid and 0.120 parts of tetrabutoxytitanate were added, and were caused to react at 220° C. for 3 hours, with further reaction under reduced pressure from 10 to 20 mmHg for 2 hours, to yield Amorphous polyester resin 2.

The physical properties of the obtained Amorphous polyester resin 2 were acid value=12.3 mgKOH/g, hydroxyl value=27.6 mgKOH/g, weight-average molecular weight (Mw)=12600, and DSC endothermic peak=72.1° C.

Production Example 1 of a Crystalline Polyester Resin

Sebacic acid: 175 parts

1,6-Hexanediol: 170 parts

Ethylene glycol: 50 parts

Potassium titanium oxide oxalate: 0.40 parts

The above polyester monomers were charged into an autoclave provided with a pressure-reducing device, a water separating device, a nitrogen gas introducing device, a temperature measuring device and a stirring device, and were caused to react at 200° C. for 6 hours in a nitrogen atmosphere, followed by further 1.5 hours of reaction at 220° C., under reduced pressure of 10 to 20 mmHg, to yield Crystalline polyester resin 1.

The physical properties of the obtained Crystalline polyester resin 1 were acid value=1.3 mgKOH/g, weight-average molecular weight (Mw)=21000 and DSC endothermic peak=79.8° C.

Production Example of Hydrophobic Silica 1

Herein 100 parts of silica (AEROSIL 200CF, by Nippon Aerosil Co., Ltd.) were treated with 10 parts of hexamethyldisilazane and were further treated with 20 parts of dimethyl silicone oil, to yield Hydrophobic silica 1. The number-average diameter of the primary particles of Hydrophobic silica 1 was 12 nm, and hydrophobicity was 97 vol %.

Production Example of Hydrophobic Silica 2

Herein 100 parts of silica (AEROSIL OX50, by Nippon Aerosil Co., Ltd.) were treated with 10 parts of hexamethyldisilazane and were further treated with 10 parts of dimethyl silicone oil, to yield Hydrophobic silica 2. The number-average diameter of the primary particles of Hydrophobic silica 2 was 40 nm, and hydrophobicity was 97 vol %.

Production Example of Hydrophobic Silica 3

Herein 100 parts of silica (AEROSIL 300CF, by Nippon Aerosil Co., Ltd.) were treated with 15 parts of hexamethyldisilazane and were further treated with 20 parts of dimethyl silicone oil, to yield Hydrophobic silica 3. The number-average diameter of the primary particles of Hydrophobic silica 3 was 7 nm, and hydrophobicity was 97 vol %.

Production Example of Hydrophobic Silica 4

Herein 100 parts of silica (AEROSIL 130, by Nippon Aerosil Co., Ltd.) were treated with 10 parts of hexamethyldisilazane and were further treated with 20 parts of dimethyl silicone oil, to yield Hydrophobic silica 4. The number-average diameter of the primary particles of Hydrophobic silica 4 was 16 nm, and hydrophobicity was 97 vol %.

Titania 1

Rutile-type titanium oxide (by TAYCA Corporation, product name: JR-301, primary particle size: 0.30 μl-treated) was used as Titania 1.

Titania 2

Anatase-type titanium oxide (by TAYCA Corporation, product name: JA-1, primary particle size: 0.18 μm) was used as Titania 2.

Method for Calculating Hydrophobicity

Hydrophobicity is worked out on the basis of a methanol-drip transmittance curve obtained as follows.

Firstly, 70 ml of water are placed in a cylindrical glass container having a diameter of 5 cm and a thickness of 1.75 mm, and dispersion is performed using an ultrasonic disperser for 5 minutes, in order to remove bubbles and so forth.

Next, 0.1 g of inorganic fine particles is weighed exactly, and is added to the above water-containing container, to prepare a sample solution for measurement. The sample solution for measurement is set in a powder wettability tester “WET-101P” (by Rhesca Co., Ltd.). This sample solution for measurement is stirred at a speed of 6.7 s⁻¹ (400 rpm) using a magnetic stirrer. A spindle-shaped rotor coated with a fluororesin and having a length of 25 mm and a maximum body diameter of 8 mm is used as the rotor of the magnetic stirrer.

Next, transmittance is measured with light having a wavelength of 780 nm while under continuous addition of methanol into the sample solution for measurement at a dripping rate of 1.3 ml/min, using the above device, and a methanol-drip transmittance curve is created.

Hydrophobicity is defined herein as the methanol concentration (vol %) at a time where transmittance reaches 50% at the start of dripping.

Production Example of Magnetic Body 1

Into an aqueous solution of ferrous sulfate there was mixed caustic soda solution (containing 1 mass % of sodium hexametaphosphate on a P basis referred to Fe) in an amount of 1.0 equivalents of iron ions, to prepare an aqueous solution containing ferrous hydroxide. Air was blown into the aqueous solution while the pH thereof was maintained at 9, and an oxidation reaction was conducted at 80° C., to prepare a slurry for producing seed crystals.

Next, an aqueous solution of ferrous sulfate was added to the slurry, in an amount of 1.0 equivalents with respect to the initial alkali amount (sodium component of caustic soda). The slurry was maintained at pH 8, and the oxidation reaction was caused to proceed while under blowing of air; at the later stage of the oxidation reaction the pH was adjusted to 6, and the slurry was washed with water and was dried, to yield spherical magnetite particles, as Magnetic iron oxide 1 having a number-average particle diameter of primary particles of 200 nm.

Then 10.0 kg of Magnetic iron oxide 1 were placed in Simpson Mix Muller (model MSG-0 L by Shin-Nitto Kogyo KK) and were deagglomerated for 30 minutes. Thereafter, 95 g of n-decyltrimethoxysilane as a silane coupling agent were added into the apparatus, and the operation was carried out for 1 hour, to hydrophobize the particle surface of Magnetic iron oxide 1 with the silane coupling agent; Magnetic body 1 was obtained as a result. The obtained Magnetic body 1 had a spherical particle shape, and had a number-average particle diameter of primary particles of 200 nm.

Production Example of Toner Particle 1
Dispersion Medium (Aqueous Medium 1)

Herein 19.2 parts of sodium phosphate and 6.2 parts of 10% hydrochloric acid were added to 1000 parts of ion-exchanged water in the reaction vessel, and the whole was kept warm at 65° C. for 60 minutes while under purging with N₂. A calcium chloride aqueous solution resulting from dissolving 10.7 parts of calcium chloride in 13.8 parts of ion-exchanged water was added all at once, while under stirring at 12000 rpm, using a T. K. Homomixer (by Primix Corporation), to prepare Aqueous medium 1 containing a dispersion stabilizer.

Polymerizable Monomer Composition

Styrene: 60 parts

Carbon black (by Orion Engineered Carbons Inc., product name “Printex 35”): 7 parts

Charge control agent (by Orient Chemical Industries Co.: Bontron E-89): 0.25 parts

The above materials were placed in an attritor disperser (by Mitsui Miike Chemical Engineering Machinery, Co., Ltd.) and were further dispersed using zirconia particles having a diameter of 1.7 mm, at 220 rpm for 5 hours, to yield a polymerizable monomer composition.

To the above polymerizable monomer composition there were added

Styrene: 20 parts

n-butyl acrylate: 20 parts

Amorphous polyester resin 1: 4 parts

Fischer-Tropsch wax (by Schumann Sasol Ltd., product name “C80”: DSC endothermic peak 83.0° C.): 9.00 parts

The above materials were kept warm at 65° C. in a separate vessel, and were uniformly dissolved and dispersed at 500 rpm using T. K. Homomixer (by Primix Corporation). Into the resulting product there were dissolved 10.0 parts of the polymerization initiator t-hexyl peroxypivalate (by NOF Corporation, product name “Perhexyl PV”, molecular weight: 202, 10-hour half-life temperature: 53.2° C.), to prepare a polymerizable monomer composition.

The polymerizable monomer composition was added to Aqueous medium 1 in a granulation tank, and the whole was stirred at 10000 rpm for 5 minutes in T. K. Homomixer under N₂ purging at 65° C., at a pH of 5.2, to elicit granulation. The resulting product was transferred to a polymerization tank, was heated at 70° C. for 6 hours (90% conversion rate) while under stirring at 30 revolutions/minute using a paddle stirring blade, with further heating to 95° C., and reacting for 2 hours.

A cooling step was carried out once the polymerization reaction was over. Water at 5° C. was mixed with the toner particle precursor dispersion at 95° C., and the whole was cooled down to 30° C. at a cooling rate of 4.000° C./sec.

Thereafter, the temperature was raised to 55° C. at a temperature increase rate of 1.00° C./min, the temperature was held at 55° C. for 180 minutes, and then water at 5° C. was mixed in, with cooling down to 30° C. at a cooling rate of 5° C./sec.

Hydrochloric acid was added to the obtained Toner particle dispersion 1, to adjust the pH to 1.5 or below, and the dispersion was stirred for 1 hour and allowed to stand, followed by solid-liquid separation using a pressure filter, to yield a toner cake. The toner cake was reslurried with ion-exchanged water to form a dispersion again, and then solid-liquid separation was carried out using the above filter. Reslurrying and solid-liquid separation were repeated until the electric conductivity of the filtrate was 5.0 μS/cm or lower, followed by final solid-liquid separation, to yield a toner cake.

The obtained toner cake was dried using an airflow dryer Flash Jet Dryer (by Seishin Enterprise Co., Ltd.). The drying conditions involved a blow-in temperature of 90° C. and a dryer outlet temperature of 40° C.; further, the feed rate of toner cake was adjusted in accordance with the moisture content of the toner cake, to a rate such that the outlet temperature did not deviate from 40° C. The product was further cut into a fine and a coarse powder using a multi-grade classifier relying on the Coanda effect, to yield Toner particle 1. The weight-average particle diameter (D4) of Toner particle 1 was 6.5 μm.

Production Example of Toner Particle 2
Dispersion Medium (Aqueous Medium 2)

Herein 23.2 parts of sodium phosphate and 7.2 parts of 10% hydrochloric acid were added to 1000 parts of ion-exchanged water in a reaction vessel, and the whole was kept warm at 65° C. for 60 minutes while under purging with N₂. A calcium chloride aqueous solution resulting from dissolving 12.7 parts of calcium chloride in 16.8 parts of ion-exchanged water was added all at once, while under stirring at 12000 rpm, using T. K. Homomixer (by Primix Corporation), to prepare Aqueous medium 2 containing a dispersion stabilizer. Toner particle 2 was obtained in the same way as in Production example 1 of a toner particle, but using herein Aqueous medium 2. The weight-average particle diameter (D4) of Toner particle 2 was 5.0 μm.

Production Example of Toner Particle 3
Dispersion Medium (Aqueous Medium 3)

Herein 15.2 parts of sodium phosphate and 5.2 parts of 10% hydrochloric acid were added to 1000 parts of ion-exchanged water in the reaction vessel, and the whole was kept warm at 65° C. for 60 minutes while under purging with N₂. A calcium chloride aqueous solution resulting from dissolving 8.7 parts of calcium chloride in 11.8 parts of ion-exchanged water was added, all at once, while under stirring at 12000 rpm, using a T. K. Homomixer (by Primix Corporation), to prepare Aqueous medium 3 containing a dispersion stabilizer. Toner particle 3 was obtained in the same way as in Production example 1 of a toner particle, but using herein Aqueous medium 3. The weight-average particle diameter (D4) of Toner particle 3 was 7.5 μm.

Production Example of Toner Particle 4
Dispersion Medium (Aqueous Medium 4)

Herein 11.2 parts of sodium phosphate and 4.2 parts of 10% hydrochloric acid were added to 1000 parts of ion-exchanged water in the reaction vessel, and the whole was kept warm at 65° C. for 60 minutes while under purging with N₂. A calcium chloride aqueous solution resulting from dissolving 6.7 parts of calcium chloride in 9.8 parts of ion-exchanged water was added, all at once, while under stirring at 12000 rpm, using a T. K. Homomixer (by Primix Corporation), to prepare Aqueous medium 4 containing a dispersion stabilizer. Toner particle 4 was obtained in the same way as in Production example 1 of a toner particle, but using herein Aqueous medium 4. The weight-average particle diameter (D4) of Toner particle 4 was 10.0 μm.

Production Example of Toner Particle 5

Toner particle 5 was obtained in the same way as in Production example 1 of a toner particle, but modifying herein carbon black (7 parts) to Magnetic body 1 (65 parts). The weight-average particle diameter (D4) of Toner particle 5 was 6.5 μm.

Production Example of Toner Particle 6

Toner particle 6 was obtained in the same way as in Production example 1 of a toner particle, but modifying herein carbon black (7 parts) to P.Y.155 (7 parts). The weight-average particle diameter (D4) of Toner particle 6 was 6.5 μm.

Production Example of Toner Particle 7

Toner particle 7 was obtained in the same way as in Production example 1 of a toner particle, but modifying herein carbon black (7 parts) to P. R. 122 (7 parts). The weight-average particle diameter (D4) of Toner particle 7 was 6.5 μm.

Production Example of Toner Particle 8

Toner particle 8 was obtained in the same way as in Production example 1 of a toner particle, but modifying herein carbon black (7 parts) to P.B.15:3 (7 parts). The weight-average particle diameter (D4) of Toner particle 8 was 6.5 μm.

Preparation of Resin Particle Dispersion 1

Into the emulsification tank of a high-temperature/high-pressure emulsification device (Cavitron CD1010, slit: 0.4 mm) there were charged 3,000 parts of Amorphous polyester resin 1, plus 10,000 parts of ion-exchanged water, and 150 parts of a sodium dodecylbenzene sulfonate surfactant. Thereafter, the whole was heated and melted at 130° C., and was dispersed at 110° C. at a flow rate of 3 L/m, at 10,000 rpm for 30 minutes, and was caused to pass through a cooling tank, to recover an amorphous polyester resin dispersion in the high-temperature/high-pressure emulsification device (Cavitron CD1010, slit: 0.4 mm, by Eurotec, Ltd.).

The obtained dispersion was cooled down to room temperature and ion-exchanged water was added, to thereby obtain Resin particle dispersion 1 which was a dispersion of Amorphous polyester resin 1 having a solids concentration of 12.5 mass % and a volume-basis median diameter of 0.15 μm.

Preparation of Resin Particle Dispersion 2

Into the emulsification tank of a high-temperature/high-pressure emulsification device (Cavitron CD1010, slit: 0.4 mm) there were charged 3,000 parts of Crystalline polyester resin 1, plus 10,000 parts of ion-exchanged water and 150 parts of a sodium dodecylbenzene sulfonate surfactant. Thereafter, the whole was heated and melted at 130° C., and was dispersed at 110° C. at a flow rate of 3 L/m, at 10,000 rpm for 30 minutes, and was caused to pass through a cooling tank, to recover a Crystalline polyester resin dispersion in the high-temperature/high-pressure emulsification device (Cavitron CD1010, slit: 0.4 mm, by Eurotec, Ltd.).

The obtained dispersion was cooled down to room temperature and ion-exchanged water was added, to thereby obtain Resin particle dispersion 1 which was a dispersion of Crystalline polyester resin 2 having a solids concentration of 12.5 mass % and a volume-basis median diameter of 0.15 μm.

Volume-Basis Median Diameter (D50) of Resin Particles

The volume-basis median diameter (D50) of resin particles such as resin particle dispersions is measured using a particle size distribution measuring device of laser diffraction/scattering type. Specifically, the volume-basis median diameter (D50) is measured according to JIS Z8825-1 (2001). A particle size distribution measuring device of laser diffraction/scattering type “LA-920” (by HORIBA, Ltd.) is used as the measuring device. The measurement conditions are set, and measurement data analyzed, using dedicated software “HORIBA LA-920 for Windows (registered trademark) WET (LA-920) Ver. 2.02” ancillary to LA-920. Ion-exchanged water from which impurity solids and so forth have been removed beforehand is used as the measurement solvent. The measurement procedure is as follows.

(1) A batch cell holder is attached to LA-920.

(2) A predetermined amount of ion-exchanged water is placed in the batch cell, and the batch cell is set in a batch cell holder.

(3) The interior of the batch cell is stirred using a dedicated stirrer chip.

(4) The “Refractive index” button on the “Display condition setting” screen is pressed, and the relative refractive index is set to a value corresponding to the resin particles.

(5) Particle diameter basis is set to volume basis on the “Display condition setting” screen.

(6) After warming up for 1 hour or longer, the optical axis is adjusted and then fine-tuned, and a blank is measured.

(7) Then 3 ml of a dispersion of resin particles are placed in a 100.0 ml flat-bottom beaker made of glass, with further addition of 57 ml ion-exchanged water, to dilute the resin particle dispersion. Among dispersants there are added 0.3 ml of a diluted solution resulting from dissolving, 3 times by mass in ion-exchanged water, “Contaminon N” (10 mass % aqueous solution of a pH-7 neutral detergent for cleaning precision measuring instruments, made up of a nonionic surfactant, an anionic surfactant and an organic builder, by Wako Pure Chemical Industries, Ltd.).

(8) An ultrasonic disperser is prepared that has an electrical output of 120 W “Ultrasonic Dispension System Tetora 150” (by Nikkaki Bios Co., Ltd.), and that has two built-in oscillators which oscillate at a frequency of 50 kHz and are disposed at a phase offset by 180 degrees. Then 3.3 L of ion-exchanged water are charged into the water tank of the ultrasonic disperser, and 2 mL of Contaminon N are added to the water tank.

(9) The beaker in (7) is set in a beaker-securing hole of the ultrasonic disperser, which is then operated. The height position of the beaker is adjusted so as to maximize a resonance state at the liquid level of the aqueous solution in the beaker.

(10) The ultrasonic dispersion treatment is further continued for 60 seconds. The water temperature of the water tank during ultrasonic dispersion is adjusted as appropriate to be from 10 to 40° C.

(11) The resin particle dispersion prepared in (10) above is added immediately, in small amounts, into the batch cell, while taking precautions so as not to allow any bubbles to be entrapped, and the transmittance of a tungsten lamp is adjusted to a range from 90 to 95%. The particle size distribution of the resin particles is then measured. The value of D50 is calculated on the basis of the obtained volume-basis particle size distribution data.

Preparation of Colorant Dispersion 1

Herein 100 parts of carbon black “Nipex 35 (by Orion Engineered Carbons GmbH)” and 15 parts of Neogen RK were mixed with 885 parts of ion-exchanged water, with dispersion for about 1 hour using a wet-type jet mill JN100, to yield Colorant-dispersed solution 1.

Preparation of Wax Dispersion 1

Herein 100 parts of a Fischer-Tropsch wax (by Schumann Sasol Ltd., product name “C80”: DSC endothermic peak 83.0° C.) and 15 parts of Neogen RK were mixed into 385 parts of ion-exchanged water, with dispersion for about 1 hour using a wet-type jet mill JN100 (by Jokoh KK), to yield Wax dispersion 1. The concentration of the wax dispersion was 20 mass %.

The volume-basis median diameter of the wax fine particles was measured using a particle size distribution analyzer of dynamic light scattering type Nanotrac (by Nikkiso Co., Ltd.); the measurement result was 0.20 μ.

Production Example of Toner Particle 9

Resin particle dispersion 1: 195 parts, Resin particle dispersion 2: 265 parts, Wax dispersion 1: 20 parts and Colorant-dispersed solution 1: 20 parts were dispersed using a homogenizer (Ultra-Turrax T50, by IKA Werke GmbH & Co. KG). The temperature inside the container was adjusted to 30° C. while under stirring, and a 1 mol/L aqueous solution of sodium hydroxide was added to adjust the pH to 8.0. A flocculant in the form of an aqueous solution obtained by dissolving 0.250 parts of magnesium sulfate in 10 parts of ion-exchanged water was added over 10 minutes, with stirring at 30° C. After 3 minutes of standing, the temperature started being raised up to 50° C., to generate aggregated particles.

After holding at 50° C. for 30 minutes, 70.0 parts of Resin particle dispersion 1 were further added. In that state, the particle diameter of the aggregated particles is measured using “Coulter Counter Multisizer 3” (registered trademark, by Beckman Coulter Inc.). Once the weight-average particle diameter reached 4.5 μm, particle growth was discontinued through addition of 3.0 parts of sodium chloride and 8.0 parts of Neogen RK.

The temperature was raised thereafter to 95° C., to elicit melt adhesion and spheroidizing of the aggregated particles. A cooling step was carried out once the average circularity reached 0.980. Water at 5° C. was mixed with the toner particle precursor dispersion at 95° C., and the whole was and cooled down to 30° C. at a cooling rate of 4.000° C./sec.

Thereafter, the temperature was raised to 55° C. at a temperature increase rate of 1.00° C./min, the temperature was held at 55° C. for 180 minutes, and then water at 5° C. was mixed in, with cooling down to 30° C. at a cooling rate of 5° C./sec.

Hydrochloric acid was added to the obtained Toner particle dispersion 1, to adjust the pH to 1.5 or below, and the dispersion was stirred for 1 hour and allowed to stand, followed by solid-liquid separation using a pressure filter, to yield a toner cake. The toner cake was reslurried with ion-exchanged water to form a dispersion again, and then solid-liquid separation was carried out using the above filter. Reslurrying and solid-liquid separation were repeated until the electric conductivity of the filtrate was 5.0 μS/cm or lower, followed by final solid-liquid separation, to yield a toner cake.

The obtained toner cake was dried using an airflow dryer Flash Jet Dryer (by Seishin Enterprise Co., Ltd.). The drying conditions involved a blow-in temperature of 90° C. and a dryer outlet temperature of 40° C.; further, the feed rate of toner cake was adjusted in accordance with the moisture content of the toner cake, to a rate such that the outlet temperature did not deviate from 40° C. The product was further cut into a fine and a coarse powder using a multi-grade classifier relying on the Coanda effect, to yield Toner particle 9. The weight-average particle diameter (D4) of Toner particle 9 was 6.5 μm.

Production Example of Toner Particle 10

### Synthesis of a Toner Binder Solution

Herein 1000 parts of Amorphous polyester resin 1 were dissolved in and mixed with 2000 parts of an ethyl acetate solvent, to yield an ethyl acetate solution of a toner binder (1).

Production of a Toner Particle

In a beaker there were placed 240 parts of the ethyl acetate solution of the toner binder (1), 6.0 parts of carbon black (by Orion Engineered Carbons GmbH, product name “Printex 35”), 1.0 part of an aluminum compound of 3,5-di-tert-butylsalicylic acid “Bontron E88 (by Orient Chemical Industries Co., Ltd.)”, and 13 parts of a Fischer-Tropsch wax (by Schumann Sasol Ltd., product name “C80”: DSC endothermic peak 83.0° C.) and the whole was uniformly dissolved and dispersed through stirring at 12,000 rpm in a TK-type homomixer at 55° C., to yield a toner material solution. Then Aqueous medium 1 (1036.3 parts) and 0.27 parts of sodium dodecylbenzene sulfonate were placed in a beaker and dissolved uniformly.

Next, the above toner material solution was added over 3 hours while under stirring at 60° C. in a TK-type homomixer at 12,000 rpm. The resulting mixed solution was then transferred to a flask equipped with a stirring rod and a thermometer, and the temperature was raised to 98° C., to remove the solvent.

A cooling step was performed once solvent removal was over. Water at 5° C. was mixed with the toner particle precursor dispersion at 95° C., and the whole was cooled down to 30° C. at a cooling rate of 4.000° C./sec.

Thereafter, the temperature was raised to 55° C. at a temperature increase rate of 1.00° C./min, the temperature was held at 55° C. for 180 minutes, and then water at 5° C. was mixed in, with cooling down to 30° C. at a cooling rate of 5° C./sec.

Hydrochloric acid was added to the obtained toner particle dispersion, to adjust the pH to 1.5 or below, and the dispersion was stirred for 1 hour and allowed to stand, followed by solid-liquid separation using a pressure filter, to yield a toner cake. The toner cake was reslurried with ion-exchanged water to form a dispersion again, and then solid-liquid separation was carried out using the above filter. Reslurrying and solid-liquid separation were repeated until the electric conductivity of the filtrate was 5.0 μS/cm or lower, followed by final solid-liquid separation, to yield a toner cake.

The obtained toner cake was dried using an airflow dryer Flash Jet Dryer (by Seishin Enterprise Co., Ltd.). The drying conditions involved a blow-in temperature of 90° C. and a dryer outlet temperature of 40° C.; further, the feed rate of toner cake was adjusted in accordance with the moisture content of the toner cake, to a rate such that the outlet temperature did not deviate from 40° C. The product was further cut into a fine and a coarse powder using a multi-grade classifier relying on the Coanda effect, to yield Toner particle 10. The weight-average particle diameter (D4) of Toner particle 10 was 6.5

Production Example of Toner Particle 11

Amorphous polyester resin 2: 100.0 parts

Carbon black “Nipex 35” (by Orion Engineered Carbons GmbH): 7.00 parts

Fischer-Tropsch wax (by Schumann Sasol Ltd., product name “C80”: DSC endothermic peak 83.0° C.): 5.00 parts

After mixing of the above materials in a Henschel mixer, the resulting mixture was melt-kneaded at 125° C. using a twin-screw kneading extruder, and then the kneaded product was cooled gradually down to room temperature, was thereafter coarsely pulverized using a cutter mill, was pulverized using a pulverizer that utilized a jet stream, and was then wind-classified, to produce Toner particle 11.

The weight-average particle diameter (D4) of Toner particle 11 was 6.5 μm.

Production of Rotating Member 7

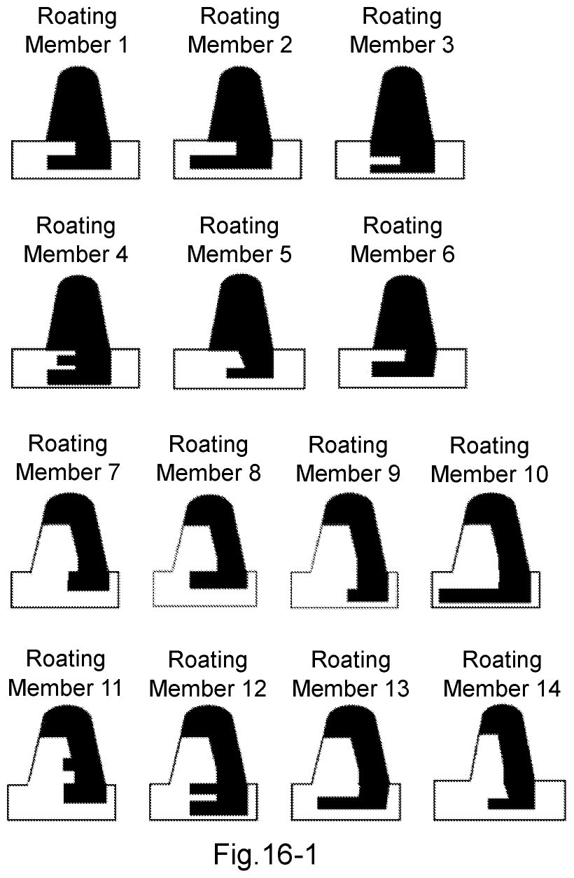

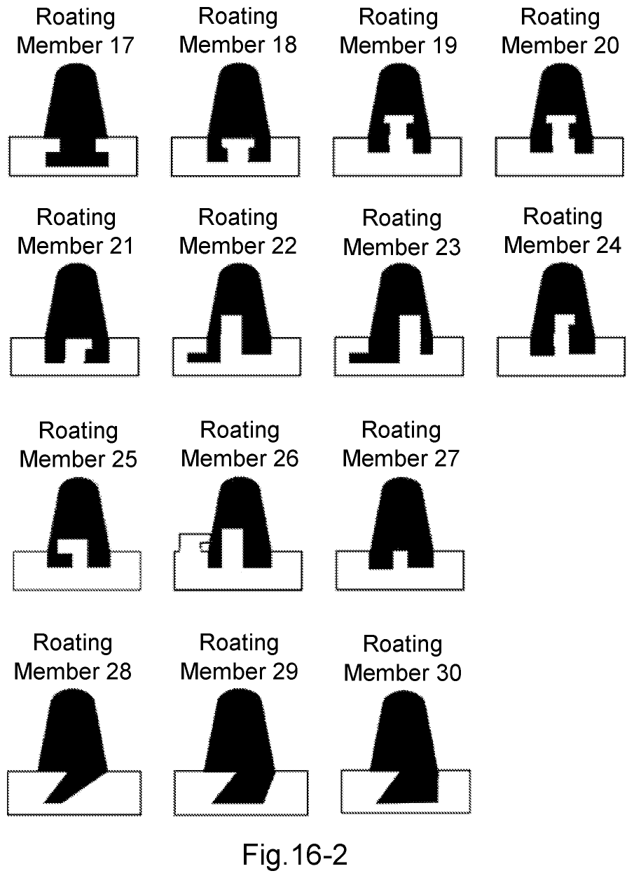

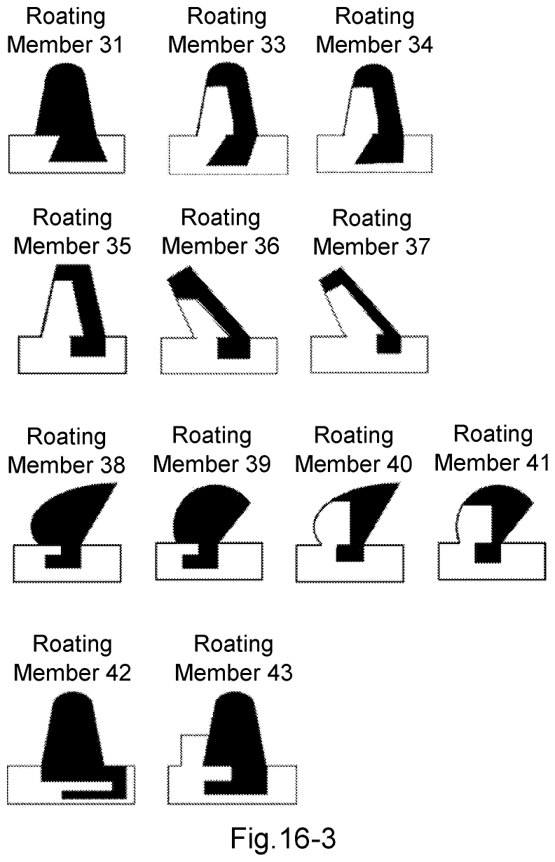

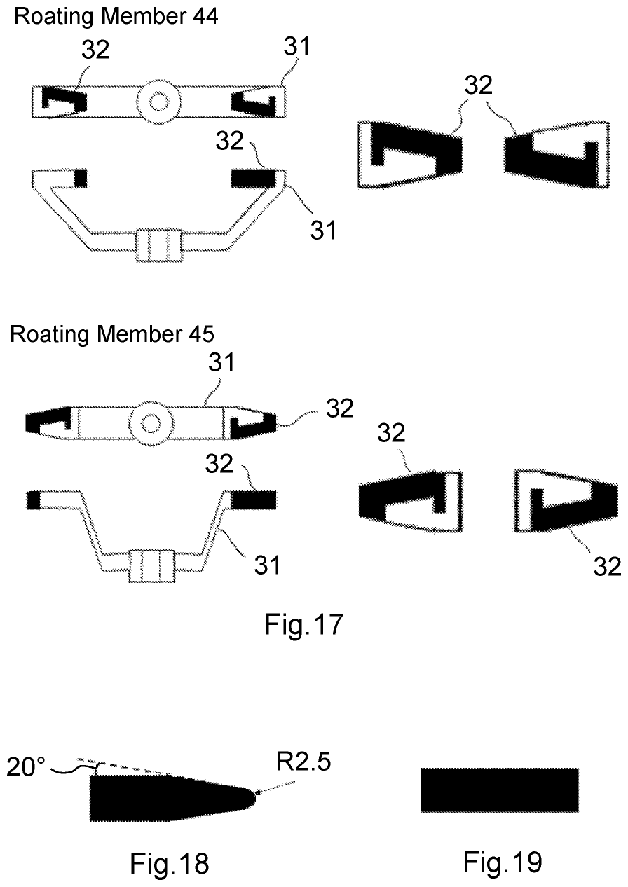

Projecting portions and peripheral portions thereof, of a Y1 blade for FM mixer, model: FM500 L, by Nippon Coke & Engineering Co., Ltd., are worked as illustrated in FIG. 6 and FIG. 7, to yield Rotating member 7 that can be separated into processing members and a rotating member main portion {the numerals in FIG. 6 and FIG. 7 denote the relative dimensions of the part indicated by arrows (the distance between the arrows)}. The rotating member main portion can be separated into a part A that forms protruding portions and a support part B. The shape of each processing member was set to the shape of Rotating member 7 illustrated in FIG. 16-1. The materials of the processing members and the rotating member main portion (part A forming the protruding portions, and support part B) were as given in Tables 1-1 and 1-2.

Projecting portions and peripheral portions thereof of a Y1 blade for FM mixer, model: FM500 L, by Nippon Coke & Engineering Co., Ltd., were worked as illustrated in FIG. 5 and FIG. 6, to yield Rotating member 7-2, used in Example 87, that can be separated into the processing members 32 and rotating member main portion 31. (Blade shape: Rotating member 7 illustrated in FIG. 16-1)

Production of Rotating Members 1 to 6 and 8 to 43

Rotating members 1 to 6 and 8 to 43 were obtained in the same way as Rotating member 7, but being worked herein to the shapes, angles and dimensions illustrated in FIG. 6 and FIG. 7 and given in Tables 1-1, 1-2, 1-3 and 1-4. The shapes of the protruding portions comprising the processing members of the respective rotating members are illustrated in FIG. 16-1, FIG. 16-2 and FIG. 16-3. Herein the ratio of the inner diameter of the processing chamber and the outermost diameter of the rotating member in the radial direction was set to be identical to that of Rotating member 7.

Production of Rotating Members 44 and 45

Rotating members 44 and 45 were obtained in the same way as Rotating member 7, but being worked herein to the shapes, angles and dimensions illustrated in FIG. 15 and given in Tables 1-3 and 1-4. Herein the ratio of the inner diameter of the processing chamber and the outermost diameter of the rotating member in the radial direction was set to be identical to that of Rotating member 7.

### Example 1

### Toner Processing Apparatus 1

Herein FM mixer (FM500 L; by Nippon Coke & Engineering Co., Ltd.) was used. As rotating members, an S0 blade (by Nippon Coke & Engineering Co., Ltd.) having the shape illustrated in FIG. 3A and FIG. 3B was used a lower blade and Rotating member 7 was used, as given in Tables 1-1 and 1-2, as an upper blade.

External Addition Step

Herein Toner particle 1: 100 parts, Hydrophobic silica 1: 2.50 parts, Titania 1: 0.30 parts and Titania 2: 0.20 parts were mixed for 15 minutes at a rotational speed of 1450 rpm, using the toner processing apparatus 1. Mixing was initiated once the temperature stabilized at 30° C., and the temperature was adjusted so that 30° C.±1° C. was maintained during mixing.

Heating Step

Subsequently, hot water was caused to pass through a jacket so that the temperature of the toner processing apparatus 1 having the above configuration was 43° C. Mixing was initiated once the temperature stabilized at 43° C., and the temperature was adjusted so that 43° C.±1° C. was maintained during mixing.

The toner having undergone the above external addition step was placed in the toner processing apparatus 1, and thereafter was thermally treated for 7 minutes at 1450 rpm. After the heating treatment was over, Toner 1 was obtained through sifting using a sieve having a 75 μm mesh opening. Tables 2-1 and 2-2 set out the production conditions of Toner 1, and Tables 4-1 and 4-2 set out various physical properties of Toner 1.

Defining this operation as one set, the same operation was repeated after discharge of a toner obtained by external addition, and the states of the rotating members and of the toner were evaluated at the 1000-th set, the 5000-th set and the 10000-th set. The evaluation method is described further on. Evaluation results are given in Tables 3-1 and 3-2.

### Examples 2 to 87

Toners 2 to 87 were obtained in the same way as in Example 1, but setting herein a toner processing apparatus, a rotating member main portion (shape and material), processing members (modified as appropriate so that α, β and γ took on the values given in the tables), the type and amount of toner particle and hydrophobic silica, as well as external addition conditions, as given in Tables 1-1, 1-2, 1-3 and 1-4, and Tables 2-1 and 2-2. The states of the obtained rotating members and obtained toners were evaluated. The evaluation methods are described further on. Evaluation results are given in Tables 3-1 and 3-2 and Tables 4-1 and 4-2.

The “20 L—Spherical” in Example 79 was used based on a Mechano Hybrid (MH20, by Nippon Coke & Engineering Co., Ltd.).

The HRC hardness of the coating layer on the surface of the processing members of Examples 12 to 14 were 68 in Example 12; 80 in Example 13; and 78 in Example 14.

### Comparative Examples 1 to 5

Toners 88 to 92 were obtained in the same way as in Example 1, but setting herein a toner processing apparatus, a rotating member main portion (shape and material), processing members, type and amount of toner particle and hydrophobic silica, given in Tables 1-3 and 1-4, and Table 2-2. The evaluation methods will be described further on. The evaluation results are set out in Tables 3-1 and 3-2, and Table 4-2. Herein a Y1 blade (integral type) by Nippon Coke & Engineering Co., Ltd. was used as the rotating member used in Comparative example 4.

The materials in the tables are based on the following standards.

SCM440: Chromium molybdenum steel

SUS821 L1: Lean duplex stainless steel

SUS304: Austenitic stainless steel

S45C: Carbon steel for mechanical structures

SKT4: Alloy tool steel

HPM38: Steel for plastic molds

HPM31: Steel for plastic molds

SKH51: Molybdenum-based high-speed tool steel

SKH55: Molybdenum-based high-speed tool steel

SKH40: Molybdenum-based high-speed tool steel

Evaluation of Rotating Member and the Toner

Rotating members corresponding to the respective toner processing apparatuses were installed, as set out in Tables 1-1, 1-2, 1-3, and 1-4 and external addition was repeated under the conditions given in Tables 2-1 and 2-2; the physical characteristics of each rotating member and produced toner upon execution of 1000 sets, 5000 sets and 10000 sets of the external addition operation were ascertained.

Detachment of the Processing Member

After the external addition treatment step was repeated a predetermined number of times, the state of each processing member was checked visually.

A: No change at all from the initial state. No detachment or deviation

B: No detachment, but slight deviation

C: No detachment, but deviation occurred. Deviation occurs in the vertical direction.

D: Detachment occurred.

Deformation of the Fitting Portion of the Processing Member and Rotating Member Body Including the Protruded Portion

The state of the projecting parts was checked visually after the external addition treatment step was repeated a predetermined number of times.

A: No change at all from the initial state, no deformation.

B: Very slight deformation, but not problematic in practice.

C: Some deformation, but the rotating member main portion and the processing member can be fitted or separated to/from each other.

D: Significant deformation; the rotating member main portion and the processing member cannot be fitted or separated to/from each other.

Deformation and Tuck-Up of Rotating Member Main Portion

After the external addition treatment step was repeated a predetermined number of times, the state of the rotating member main portion was checked visually. In particular, the state of the portion in the rotating member main portion that fits with the processing member and the periphery of that portion were visually checked.

A: No change at all from the initial state; no deformation.

B: Slight deformation of the rotating member main portion, but not problematic in practice.

C: Deformation of the rotating member main portion, and slight tuck-up of the portion fitting with the processing member, on the side towards which the rotating member rotates, or on the opposite side.

D: Significant deformation, and tuck-up of the portion fitting with the processing member, on the side towards which the rotating member rotates, or on the opposite side.

Wear of the Processing Member

After the external addition treatment step was repeated a predetermined number of times, the change in weight of each processing member was checked.

A: Weight change smaller than 0.10%

B: Weight change from 0.10% to less than 0.50%

C: Weight change from 0.50% to less than 1.00%

D: Weight change of 1.00% or larger

Load at the Time of replacement of the Processing Member

After the external addition treatment step was repeated a predetermined number of times, the ease of replacement of the rotating member main portion and of the processing member was checked visually.

A: Weight of the replacement parts is small, with very few replacements.

B: Weight of the replacement parts is small, but the number of replacement sites, or the replacement frequency, is somewhat high.

C: The weight of the replacement parts is small, but there are numerous replacement sites, or replacement frequency is high.

D: The entirety of the rotating member is replaced.

Toner Clogging in Gap between Rotating Member Body and the Processing Member

After the external addition treatment step was repeated a predetermined number of times, the occurrence or absence of toner clogging at the gap where the rotating member main portion and the processing member fit was checked visually.

A: No toner clogging at all in the gap, or slight toner clogging in the gap, but not problematic in practice.

B: Toner clogging in the gap, giving rise to deformation and positional deviation of for instance the processing member.

Changes in the Fixing Index of Additive on Toner

After the external addition treatment step was repeated a predetermined number of times, the amount of change relative to the fixing index of the external additive on the toner of the first set was evaluated (difference between the fixing index of the first set, and the fixing index of the respective set to be evaluated).

A: Difference in fixing index smaller than 0.3

B: Difference in fixing index from 0.3 to less than 0.5

C: Difference in fixing index from 0.5 to less than 0.8

D: Difference in fixing index of 0.8 or larger

Change in the Coverage Ratio of Additive on Toner

After the external addition treatment step was repeated a predetermined number of times, the proportion of change relative to the coverage ratio of the additive of toner of the first set was evaluated.

A: Change in coverage ratio smaller than 1.0%

B: Change in coverage ratio from 1.0% to less than 2.0%

C: Change in coverage ratio from 2.0% to less than 3.0%

D: Change in coverage ratio of 3.0% or larger

TABLE 1-1

| | | | Processing | Separation | | | | Protruded | | | | | | |
|---|---|---|---|---|---|---|---|---|---|---|---|---|---|---|
| | | | surface | mechanism | | | | portion | | | | E | | |
| | | Process- | shape | in | | | | A | B | C | D | Projecting | | G |
| | Process- | ing | of | rotating | Penetration | | | Start | End | Pinch- | Support- | parts of | F | Center |
| Example | ing | member | processing | member | angle | | | point | point | ing | ing | supporting | Parallel | of |
| No. | apparatus | shape | member | body | α | β | γ | position | position | shape | member | member | surface | gravity |
| 1 | 500L | 7 | 1 (FIG. 18) | 1 (FIG. 7) | −15° | 0° | −15° | ◯ | ◯ | ◯ | ◯ | ◯ | ◯ | ◯ |
| 2 | 500L | 7 | 1 (FIG. 18) | 1 (FIG. 7) | −15° | 0° | −15° | ◯ | ◯ | ◯ | ◯ | ◯ | ◯ | ◯ |
| 3 | 500L | 7 | 1 (FIG. 18) | 1 (FIG. 7) | −15° | 0° | −15° | ◯ | ◯ | ◯ | ◯ | ◯ | ◯ | ◯ |
| 4 | 500L | 7 | 1 (FIG. 18) | 1 (FIG. 7) | −15° | 0° | −15° | ◯ | ◯ | ◯ | ◯ | ◯ | ◯ | ◯ |
| 5 | 500L | 7 | 1 (FIG. 18) | 1 (FIG. 7) | −15° | 0° | −15° | ◯ | ◯ | ◯ | ◯ | ◯ | ◯ | ◯ |
| 6 | 500L | 7 | 1 (FIG. 18) | 1 (FIG. 7) | −15° | 0° | −15° | ◯ | ◯ | ◯ | ◯ | ◯ | ◯ | ◯ |
| 7 | 500L | 7 | 1 (FIG. 18) | 1 (FIG. 7) | −15° | 0° | −15° | ◯ | ◯ | ◯ | ◯ | ◯ | ◯ | ◯ |
| 8 | 500L | 7 | 1 (FIG. 18) | 1 (FIG. 7) | −15° | 0° | −15° | ◯ | ◯ | ◯ | ◯ | ◯ | ◯ | ◯ |
| 9 | 500L | 7 | 1 (FIG. 18) | 1 (FIG. 7) | −15° | 0° | −15° | ◯ | ◯ | ◯ | ◯ | ◯ | ◯ | ◯ |
| 10 | 500L | 7 | 1 (FIG. 18) | 1 (FIG. 7) | −15° | 0° | −15° | ◯ | ◯ | ◯ | ◯ | ◯ | ◯ | ◯ |
| 11 | 500L | 7 | 1 (FIG. 18) | 1 (FIG. 7) | −15° | 0° | −15° | ◯ | ◯ | ◯ | ◯ | ◯ | ◯ | ◯ |
| 12 | 500L | 7 | 1 (FIG. 18) | 1 (FIG. 7) | −15° | 0° | −15° | ◯ | ◯ | ◯ | ◯ | ◯ | ◯ | ◯ |
| 13 | 500L | 7 | 1 (FIG. 18) | 1 (FIG. 7) | −15° | 0° | −15° | ◯ | ◯ | ◯ | ◯ | ◯ | ◯ | ◯ |
| 14 | 500L | 7 | 1 (FIG. 18) | 1 (FIG. 7) | −15° | 0° | −15° | ◯ | ◯ | ◯ | ◯ | ◯ | ◯ | ◯ |
| 15 | 500L | 7 | 1 (FIG. 18) | 1 (FIG. 7) | −15° | 0° | −15° | ◯ | ◯ | ◯ | ◯ | ◯ | ◯ | ◯ |
| 16 | 500L | 7 | 1 (FIG. 18) | 1 (FIG. 7) | −15° | 0° | −15° | ◯ | ◯ | ◯ | ◯ | ◯ | ◯ | ◯ |
| 17 | 500L | 7 | 1 (FIG. 18) | 1 (FIG. 7) | −15° | 0° | −15° | ◯ | ◯ | ◯ | ◯ | ◯ | ◯ | ◯ |
| 18 | 500L | 7 | 1 (FIG. 18) | 1 (FIG. 7) | −15° | 0° | −15° | ◯ | ◯ | ◯ | ◯ | ◯ | ◯ | ◯ |
| 19 | 500L | 7 | 1 (FIG. 18) | 1 (FIG. 7) | −15° | 0° | −15° | ◯ | ◯ | ◯ | ◯ | ◯ | ◯ | ◯ |
| 20 | 500L | 7 | 1 (FIG. 18) | 1 (FIG. 7) | −15° | 0° | −15° | ◯ | ◯ | ◯ | ◯ | ◯ | ◯ | ◯ |
| 21 | 500L | 7 | 1 (FIG. 18) | 1 (FIG. 7) | −15° | 0° | −15° | ◯ | ◯ | ◯ | ◯ | ◯ | ◯ | ◯ |
| 22 | 500L | 7 | 1 (FIG. 18) | 1 (FIG. 7) | −15° | 0° | −15° | ◯ | ◯ | ◯ | ◯ | ◯ | ◯ | ◯ |
| 23 | 500L | 7 | 1 (FIG. 18) | 1 (FIG. 7) | −15° | 0° | −15° | ◯ | ◯ | ◯ | ◯ | ◯ | ◯ | ◯ |
| 24 | 500L | 7 | 1 (FIG. 18) | 1 (FIG. 7) | −15° | 0° | −15° | ◯ | ◯ | ◯ | ◯ | ◯ | ◯ | ◯ |
| 25 | 500L | 7 | 1 (FIG. 18) | 1 (FIG. 7) | 0° | 0° | −15° | ◯ | ◯ | ◯ | ◯ | ◯ | ◯ | ◯ |
| 26 | 500L | 7 | 1 (FIG. 18) | 1 (FIG. 7) | −7° | 0° | −15° | ◯ | ◯ | ◯ | ◯ | ◯ | ◯ | ◯ |
| 27 | 500L | 7 | 1 (FIG. 18) | 1 (FIG. 7) | −20° | 0° | −15° | ◯ | ◯ | ◯ | ◯ | ◯ | ◯ | ◯ |
| 28 | 500L | 7 | 1 (FIG. 18) | 1 (FIG. 7) | +7° | 0° | −15° | ◯ | ◯ | ◯ | ◯ | ◯ | ◯ | ◯ |
| 29 | 500L | 7 | 1 (FIG. 18) | 1 (FIG. 7) | −15° | 0° | −15° | ◯ | ◯ | ◯ | ◯ | ◯ | ◯ | ◯ |
| 30 | 500L | 7 | 1 (FIG. 18) | 1 (FIG. 7) | −15° | 0° | −15° | ◯ | ◯ | ◯ | ◯ | ◯ | ◯ | ◯ |
| 31 | 500L | 7 | 1 (FIG. 18) | 1 (FIG. 7) | −15° | 0° | −15° | ◯ | ◯ | ◯ | ◯ | ◯ | ◯ | ◯ |
| 32 | 500L | 7 | 1 (FIG. 18) | 1 (FIG. 7) | −15° | 0° | −15° | ◯ | ◯ | ◯ | ◯ | ◯ | ◯ | ◯ |
| 33 | 500L | 7 | 1 (FIG. 18) | 1 (FIG. 7) | −15° | 0° | −15° | ◯ | ◯ | ◯ | ◯ | ◯ | ◯ | ◯ |
| 34 | 500L | 7 | 1 (FIG. 18) | 1 (FIG. 7) | −15° | 0° | −15° | ◯ | ◯ | ◯ | ◯ | ◯ | ◯ | ◯ |
| 35 | 500L | 7 | 1 (FIG. 18) | 1 (FIG. 7) | −15° | 0° | −15° | ◯ | ◯ | ◯ | ◯ | ◯ | ◯ | ◯ |
| 36 | 500L | 7 | 1 (FIG. 18) | 1 (FIG. 7) | −15° | 0° | −15° | ◯ | ◯ | ◯ | ◯ | ◯ | ◯ | ◯ |
| 37 | 500L | 7 | 1 (FIG. 18) | 1 (FIG. 7) | −15° | 0° | −15° | ◯ | ◯ | ◯ | ◯ | ◯ | ◯ | ◯ |
| 38 | 500L | 7 | 1 (FIG. 18) | 1 (FIG. 7) | −15° | 0° | −15° | ◯ | ◯ | ◯ | ◯ | ◯ | ◯ | ◯ |
| 39 | 500L | 7 | 1 (FIG. 18) | 1 (FIG. 7) | −15° | 0° | −15° | ◯ | ◯ | ◯ | ◯ | ◯ | ◯ | ◯ |
| 40 | 500L | 7 | 1 (FIG. 18) | 1 (FIG. 7) | −15° | 0° | −15° | ◯ | ◯ | ◯ | ◯ | ◯ | ◯ | ◯ |
| 41 | 500L | 7 | 1 (FIG. 18) | 1 (FIG. 7) | −15° | 0° | −15° | ◯ | ◯ | ◯ | ◯ | ◯ | ◯ | ◯ |
| 42 | 500L | 7 | 1 (FIG. 18) | 1 (FIG. 7) | −15° | 0° | −15° | ◯ | ◯ | ◯ | ◯ | ◯ | ◯ | ◯ |
| 43 | 500L | 7 | 1 (FIG. 18) | 1 (FIG. 7) | −15° | 0° | −15° | ◯ | ◯ | ◯ | ◯ | ◯ | ◯ | ◯ |
| 44 | 500L | 7 | 1 (FIG. 18) | 1 (FIG. 7) | −15° | 0° | −15° | ◯ | ◯ | ◯ | ◯ | ◯ | ◯ | ◯ |
| 45 | 500L | 7 | 1 (FIG. 18) | 1 (FIG. 7) | −15° | 0° | −15° | ◯ | ◯ | ◯ | ◯ | ◯ | ◯ | ◯ |
| 46 | 500L | 7 | 1 (FIG. 18) | 1 (FIG. 7) | −15° | 0° | −15° | ◯ | ◯ | ◯ | ◯ | ◯ | ◯ | ◯ |
| 47 | 500L | 7 | 1 (FIG. 18) | 1 (FIG. 7) | −15° | 0° | −15° | ◯ | ◯ | ◯ | ◯ | ◯ | ◯ | ◯ |
| 48 | 500L | 7 | 1 (FIG. 18) | 1 (FIG. 7) | −15° | 0° | −15° | ◯ | ◯ | ◯ | ◯ | ◯ | ◯ | ◯ |
| 49 | 500L | 7 | 1 (FIG. 18) | 1 (FIG. 7) | −15° | 0° | −15° | ◯ | ◯ | ◯ | ◯ | ◯ | ◯ | ◯ |
| 50 | 500L | 8 | 1 (FIG. 18) | 1 (FIG. 7) | −15° | 0° | −15° | ◯ | ◯ | ◯ | ◯ | ◯ | ◯ | ◯ |

TABLE 1-2

| | | | | Material | | | | | | |
|---|---|---|---|---|---|---|---|---|---|---|
| | | | | Support part B of | | Part A of | | | | |
| | | | | rotating member | | rotating member | | Processing | | |
| | | | | main portion | | main portion | | member | | |
| | | | | | HRC | | HRC | | HRC | |
| Example | Surface treatment of | Fastener | | | hard- | | hard- | | hard- | Hardness |
| No. | processing member | (1) | (2) | Type | ness | Type | ness | Type | ness | difference |
| 1 | None | ◯ | ◯ | SCM440 | 30 | SUS821L1 | 32 | SKH51 | 63 | 31 |
| 2 | None | ◯ | ◯ | SCM440 | 30 | SUS821L1 | 32 | SKH51 | 63 | 31 |
| 3 | None | ◯ | ◯ | SCM440 | 30 | SUS821L1 | 32 | SKH51 | 63 | 31 |
| 4 | None | ◯ | ◯ | SCM440 | 30 | SUS821L1 | 32 | SKH51 | 63 | 31 |
| 5 | None | ◯ | ◯ | SCM440 | 30 | SUS821L1 | 32 | SKH51 | 63 | 31 |
| 6 | None | ◯ | ◯ | SCM440 | 30 | SUS821L1 | 32 | SKH51 | 63 | 31 |
| 7 | None | ◯ | ◯ | SCM440 | 30 | SUS821L1 | 32 | SKH51 | 63 | 31 |
| 8 | None | ◯ | ◯ | SCM440 | 30 | SUS821L1 | 32 | SKH51 | 63 | 31 |
| 9 | None | ◯ | ◯ | SCM440 | 30 | SUS821L1 | 32 | SKH51 | 63 | 31 |
| 10 | None | ◯ | ◯ | SCM440 | 30 | SUS821L1 | 32 | SKH51 | 63 | 31 |
| 11 | None | ◯ | ◯ | SCM440 | 30 | SUS821L1 | 32 | SKH51 | 63 | 31 |
| 12 | Daikuron plating | ◯ | ◯ | SCM440 | 30 | SUS821L1 | 32 | SKH51 | 63 | 31 |
| 13 | DLC coat | ◯ | ◯ | SCM440 | 30 | SUS821L1 | 32 | SKH51 | 63 | 31 |
| 14 | Ceramic chip lining | ◯ | ◯ | SCM440 | 30 | SUS821L1 | 32 | SKH51 | 63 | 31 |
| 15 | None | ◯ | ◯ | SCM440 | 30 | SUS821L1 | 32 | SKH51 | 63 | 31 |
| 16 | None | ◯ | ◯ | SCM440 | 30 | SUS821L1 | 32 | SKH51 | 63 | 31 |
| 17 | None | ◯ | ◯ | SCM440 | 30 | SUS821L1 | 32 | SKH51 | 63 | 31 |
| 18 | None | ◯ | ◯ | SCM440 | 30 | SUS821L1 | 32 | SKH51 | 63 | 31 |
| 19 | None | ◯ | ◯ | SCM440 | 30 | SUS821L1 | 32 | SKH51 | 63 | 31 |
| 20 | None | ◯ | ◯ | SCM440 | 30 | SUS821L1 | 32 | SKH51 | 63 | 31 |
| 21 | None | ◯ | ◯ | SCM440 | 30 | SUS821L1 | 32 | SKH51 | 63 | 31 |
| 22 | None | ◯ | ◯ | SCM440 | 30 | SUS821L1 | 32 | SKH51 | 63 | 31 |
| 23 | None | ◯ | ◯ | SCM440 | 30 | SUS821L1 | 32 | SKH51 | 63 | 31 |
| 24 | None | ◯ | ◯ | SCM440 | 30 | SUS821L1 | 32 | SKH51 | 63 | 31 |
| 25 | None | ◯ | ◯ | SCM440 | 30 | SUS821L1 | 32 | SKH51 | 63 | 31 |
| 26 | None | ◯ | ◯ | SCM440 | 30 | SUS821L1 | 32 | SKH51 | 63 | 31 |
| 27 | None | ◯ | ◯ | SCM440 | 30 | SUS821L1 | 32 | SKH51 | 63 | 31 |
| 28 | None | ◯ | ◯ | SCM440 | 30 | SUS821L1 | 32 | SKH51 | 63 | 31 |
| 29 | None | ◯ | ◯ | SCM440 | 30 | SUS821L1 | 32 | SKT4 | 42 | 10 |
| 30 | None | ◯ | ◯ | SCM440 | 30 | SUS821L1 | 32 | HPM38 | 50 | 18 |
| 31 | None | ◯ | ◯ | SCM440 | 30 | SUS821L1 | 32 | HPM31 | 55 | 23 |
| 32 | None | ◯ | ◯ | SCM440 | 30 | SUS821L1 | 32 | SKH55 | 65 | 33 |
| 33 | None | ◯ | ◯ | SCM440 | 30 | SUS821L1 | 32 | SKH40 | 67 | 35 |
| 34 | None | ◯ | ◯ | SCM440 | 30 | SUS821L1 | 32 | SCM440 | 30 | -2 |
| 35 | None | ◯ | ◯ | SCM440 | 30 | SUS304 | 14 | SCM440 | 30 | 16 |
| 36 | None | ◯ | ◯ | SCM440 | 30 | SUS304 | 14 | SKH51 | 63 | 49 |
| 37 | None | ◯ | ◯ | SCM440 | 30 | S45C | 25 | SKH51 | 63 | 38 |
| 38 | None | ◯ | ◯ | SCM440 | 30 | SCM440 | 30 | SKT4 | 42 | 12 |
| 39 | None | ◯ | ◯ | SCM440 | 30 | SCM440 | 30 | SKH51 | 63 | 33 |
| 40 | None | ◯ | ◯ | SCM440 | 30 | SCM440 | 30 | HPM38 | 50 | 20 |
| 41 | None | ◯ | ◯ | SCM440 | 30 | SCM440 | 30 | HPM31 | 55 | 25 |
| 42 | None | ◯ | ◯ | SCM440 | 30 | SCM440 | 30 | SKH55 | 65 | 35 |
| 43 | None | ◯ | ◯ | SCM440 | 30 | SCM440 | 30 | SKH40 | 67 | 37 |
| 44 | None | ◯ | ◯ | SCM440 | 30 | SKT4 | 42 | SKH51 | 63 | 21 |
| 45 | None | ◯ | ◯ | SCM440 | 30 | HPM38 | 50 | HPM38 | 50 | 0 |
| 46 | None | ◯ | ◯ | SCM440 | 30 | HPM31 | 55 | HPM31 | 55 | 0 |
| 47 | None | ◯ | ◯ | SCM440 | 30 | HPM38 | 50 | SKH55 | 65 | 15 |
| 48 | None | ◯ | ◯ | SCM440 | 30 | HPM38 | 50 | SKH40 | 67 | 17 |
| 49 | None | ◯ | ◯ | SCM440 | 30 | HPM38 | 50 | SKH51 | 63 | 13 |
| 50 | None | ◯ | ◯ | SCM440 | 30 | SUS821L1 | 32 | SKH51 | 63 | 31 |

TABLE 1-3

| | | | | | | | | | | | | E | | |
|---|---|---|---|---|---|---|---|---|---|---|---|---|---|---|
| | | | Processing | Separation | | | | Protruded | | | | Project- | | |
| | | | surface | mechanism | | | | portion | | | | ing | | |
| | | Process- | shape of | in | | | | A | B | C | D | parts of | | G |
| | Process- | ing | process- | rotating | Penetration | | | Start | End | Pinch- | Support- | support- | F | Center |
| Example | ing | member | ing | member | angle | | | point | point | ing | ing | ing | Parallel | of |
| No. | apparatus | shape | member | body | α | β | γ | position | position | shape | member | member | surface | gravity |
| 51 | 500L | 9 | 1 (FIG. 18) | 1 (FIG. 7) | −15° | 0° | −15° | ◯ | ◯ | ◯ | ◯ | ◯ | ◯ | ◯ |
| 52 | 500L | 10 | 1 (FIG. 18) | 1 (FIG. 7) | −15° | 0° | −15° | X | ◯ | ◯ | ◯ | ◯ | ◯ | ◯ |
| 53 | 500L | 11 | 1 (FIG. 18) | 1 (FIG. 7) | −15° | 0° | −15° | ◯ | ◯ | ◯ | ◯ | ◯ | ◯ | ◯ |
| 54 | 500L | 12 | 1 (FIG. 18) | 1 (FIG. 7) | −15° | 0° | −15° | ◯ | ◯ | ◯ | ◯ | ◯ | ◯ | ◯ |
| 55 | 500L | 13 | 1 (FIG. 18) | 1 (FIG. 7) | 0° | +15° | −15° | ◯ | ◯ | ◯ | ◯ | ◯ | ◯ | ◯ |
| 56 | 500L | 14 | 1 (FIG. 18) | 1 (FIG. 7) | −15° | −15° | −15° | ◯ | ◯ | ◯ | ◯ | ◯ | ◯ | ◯ |
| 57 | 500L | 17 | 1 (FIG. 18) | 1 (FIG. 7) | −7.5° | 0° | −15° | ◯ | ◯ | ◯ | X | X | X | ◯ |
| 58 | 500L | 18 | 1 (FIG. 18) | 1 (FIG. 7) | −15° | 0° | −15° | X | ◯ | ◯ | X | X | X | X |
| 59 | 500L | 19 | 1 (FIG. 18) | 1 (FIG. 7) | −15° | 0° | −15° | X | ◯ | ◯ | X | X | X | X |
| 60 | 500L | 20 | 1 (FIG. 18) | 1 (FIG. 7) | −15° | 0° | −15° | X | ◯ | ◯ | X | X | X | X |
| 61 | 500L | 21 | 1 (FIG. 18) | 1 (FIG. 7) | −15° | 0° | −15° | X | ◯ | ◯ | X | X | X | X |
| 62 | 500L | 24 | 1 (FIG. 18) | 1 (FIG. 7) | −15° | 0° | −15° | X | ◯ | ◯ | X | X | X | X |
| 63 | 500L | 22 | 1 (FIG. 18) | 1 (FIG. 7) | −15° | 0° | −15° | X | ◯ | X | X | X | X | ◯ |
| 64 | 500L | 23 | 1 (FIG. 18) | 1 (FIG. 7) | −15° | 0° | −15° | X | ◯ | X | X | X | X | X |
| 65 | 500L | 1 | 1 (FIG. 18) | 1 (FIG. 7) | −15° | 0° | −15° | ◯ | ◯ | ◯ | X | X | X | ◯ |
| 66 | 500L | 2 | 1 (FIG. 18) | 1 (FIG. 7) | −15° | 0° | −15° | X | ◯ | ◯ | X | X | X | ◯ |
| 67 | 500L | 3 | 1 (FIG. 18) | 1 (FIG. 7) | −15° | 0° | −15° | ◯ | ◯ | ◯ | X | X | X | ◯ |
| 68 | 500L | 4 | 1 (FIG. 18) | 1 (FIG. 7) | −15° | 0° | −15° | ◯ | ◯ | ◯ | X | X | X | ◯ |
| 69 | 500L | 5 | 1 (FIG. 18) | 1 (FIG. 7) | −15° | −15° | −15° | ◯ | ◯ | ◯ | X | X | X | ◯ |
| 70 | 500L | 6 | 1 (FIG. 18) | 1 (FIG. 7) | 0° | +15° | −15° | ◯ | ◯ | ◯ | X | X | X | ◯ |
| 71 | 500L | 43 | 1 (FIG. 18) | 1 (FIG. 7) | −15° | 0° | −15° | ◯ | ◯ | ◯ | ◯ | X | X | ◯ |
| 72 | 500L | 42 | 1 (FIG. 18) | 1 (FIG. 7) | −20° | 0° | −25° | ◯ | X | ◯ | X | X | X | ◯ |
| 73 | 500L | 28 | 1 (FIG. 18) | 1 (FIG. 7) | +20° | +15° | −15° | ◯ | ◯ | ◯ | X | X | X | ◯ |
| 74 | 500L | 29 | 1 (FIG. 18) | 1 (FIG. 7) | +3° | +15° | −15° | ◯ | ◯ | ◯ | X | X | X | ◯ |
| 75 | 500L | 30 | 1 (FIG. 18) | 1 (FIG. 7) | −15° | +15° | −15° | ◯ | ◯ | ◯ | X | X | X | ◯ |
| 76 | 500L | 31 | 1 (FIG. 18) | 1 (FIG. 7) | −20° | +7° | −15° | ◯ | ◯ | ◯ | X | X | X | ◯ |
| 77 | 500L | 33 | 1 (FIG. 18) | 1 (FIG. 7) | +3° | +30° | −15° | ◯ | ◯ | ◯ | ◯ | ◯ | ◯ | ◯ |
| 78 | 500L | 34 | 1 (FIG. 18) | 1 (FIG. 7) | −15° | +30° | −15° | ◯ | ◯ | ◯ | ◯ | ◯ | ◯ | ◯ |
| 79 | 20L | 35 | 1 (FIG. 18) | 1 (FIG. 7) | −15° | 0° | −15° | ◯ | ◯ | ◯ | ◯ | ◯ | ◯ | ◯ |
| | Spherical | | | | | | | | | | | | | |
| 80 | 500L | 36 | 1 (FIG. 18) | 1 (FIG. 7) | −15° | 0° | −15° | ◯ | ◯ | ◯ | ◯ | ◯ | ◯ | ◯ |
| 81 | 500L | 37 | 1 (FIG. 18) | 1 (FIG. 7) | −15° | 0° | −15° | ◯ | ◯ | ◯ | ◯ | ◯ | ◯ | ◯ |
| 82 | 500L | 38 | 2 (FIG. 19) | 1 (FIG. 7) | −15° | 0° | −15° | ◯ | ◯ | ◯ | X | X | X | ◯ |
| 83 | 500L | 39 | 2 (FIG. 19) | 1 (FIG. 7) | −15° | 0° | −15° | ◯ | ◯ | ◯ | X | X | X | ◯ |
| 84 | 500L | 40 | 2 (FIG. 19) | 1 (FIG. 7) | −15° | 0° | −15° | ◯ | ◯ | ◯ | ◯ | ◯ | X | ◯ |
| 85 | 500L | 41 | 2 (FIG. 19) | 1 (FIG. 7) | −15° | 0° | −15° | ◯ | ◯ | ◯ | ◯ | ◯ | X | ◯ |
| 86 | 500L | 45 | 1 (FIG. 18) | 1 (FIG. 7) | −15° | 0° | −15° | ◯ | ◯ | ◯ | ◯ | ◯ | ◯ | ◯ |
| 87 | 500L | 7-2 | 1 (FIG. 18) | 2 (FIG. 5) | −15° | 0° | −15° | ◯ | ◯ | ◯ | ◯ | ◯ | ◯ | ◯ |
| C.E. 1 | 500L | 25 | 1 (FIG. 18) | 1 (FIG. 7) | −15° | 0° | −15° | — | ◯ | ◯ | X | X | X | ◯ |
| C.E. 2 | 500L | 26 | 1 (FIG. 18) | 1 (FIG. 7) | −15° | 0° | −15° | — | ◯ | X | X | X | X | ◯ |
| C.E. 3 | 500L | 27 | 1 (FIG. 18) | 1 (FIG. 7) | −15° | 0° | −15° | — | ◯ | X | X | X | X | ◯ |
| C.E. 4 | 500L | Y1 | 1 (FIG. 18) | 1 (FIG. 7) | — | — | — | — | — | — | — | — | — | — |
| C.E. 5 | 500L | 44 | 1 (FIG. 18) | 1 (FIG. 7) | −15° | 0° | −15° | — | ◯ | ◯ | ◯ | ◯ | X | ◯ |

TABLE 1-4

| | | | | Material | | | | | | |
|---|---|---|---|---|---|---|---|---|---|---|
| | Surface | | | Support part B of | | Part A of | | | | |
| | treatment | | | rotating member | | rotating member | | Processing | | |
| | of | | | main portion | | main portion | | member | | |
| Example | processing | Fastener | | | HRC | | HRC | | HRC | Hardness |
| No. | member | (1) | (2) | Type | hardness | Type | hardness | Type | hardness | difference |
| 51 | None | ◯ | ◯ | SCM440 | 30 | SUS821L1 | 32 | SKH51 | 63 | 31 |
| 52 | None | ◯ | ◯ | SCM440 | 30 | SUS821L1 | 32 | SKH51 | 63 | 31 |
| 53 | None | ◯ | ◯ | SCM440 | 30 | SUS821L1 | 32 | SKH51 | 63 | 31 |
| 54 | None | ◯ | ◯ | SCM440 | 30 | SUS821L1 | 32 | SKH51 | 63 | 31 |
| 55 | None | ◯ | ◯ | SCM440 | 30 | SUS821L1 | 32 | SKH51 | 63 | 31 |
| 56 | None | ◯ | ◯ | SCM440 | 30 | SUS821L1 | 32 | SKH51 | 63 | 31 |
| 57 | None | ◯ | ◯ | SCM440 | 30 | SUS821L1 | 32 | SKH51 | 63 | 31 |
| 58 | None | ◯ | ◯ | SCM440 | 30 | SUS821L1 | 32 | SKH51 | 63 | 31 |
| 59 | None | ◯ | ◯ | SCM440 | 30 | SUS821L1 | 32 | SKH51 | 63 | 31 |
| 60 | None | ◯ | ◯ | SCM440 | 30 | SUS821L1 | 32 | SKH51 | 63 | 31 |
| 61 | None | ◯ | ◯ | SCM440 | 30 | SUS821L1 | 32 | SKH51 | 63 | 31 |
| 62 | None | ◯ | ◯ | SCM440 | 30 | SUS821L1 | 32 | SKH51 | 63 | 31 |
| 63 | None | ◯ | ◯ | SCM440 | 30 | SUS821L1 | 32 | SKH51 | 63 | 31 |
| 64 | None | ◯ | ◯ | SCM440 | 30 | SUS821L1 | 32 | SKH51 | 63 | 31 |
| 65 | None | ◯ | ◯ | SCM440 | 30 | SUS821L1 | 32 | SKH51 | 63 | 31 |
| 66 | None | ◯ | ◯ | SCM440 | 30 | SUS821L1 | 32 | SKH51 | 63 | 31 |
| 67 | None | ◯ | ◯ | SCM440 | 30 | SUS821L1 | 32 | SKH51 | 63 | 31 |
| 68 | None | ◯ | ◯ | SCM440 | 30 | SUS821L1 | 32 | SKH51 | 63 | 31 |
| 69 | None | ◯ | ◯ | SCM440 | 30 | SUS821L1 | 32 | SKH51 | 63 | 31 |
| 70 | None | ◯ | ◯ | SCM440 | 30 | SUS821L1 | 32 | SKH51 | 63 | 31 |
| 71 | None | ◯ | ◯ | SCM440 | 30 | SUS821L1 | 32 | SKH51 | 63 | 31 |
| 72 | None | ◯ | ◯ | SCM440 | 30 | SUS821L1 | 32 | SKH51 | 63 | 31 |
| 73 | None | ◯ | ◯ | SCM440 | 30 | SUS821L1 | 32 | SKH51 | 63 | 31 |
| 74 | None | ◯ | ◯ | SCM440 | 30 | SUS821L1 | 32 | SKH51 | 63 | 31 |
| 75 | None | ◯ | ◯ | SCM440 | 30 | SUS821L1 | 32 | SKH51 | 63 | 31 |
| 76 | None | ◯ | ◯ | SCM440 | 30 | SUS821L1 | 32 | SKH51 | 63 | 31 |
| 77 | None | ◯ | ◯ | SCM440 | 30 | SUS821L1 | 32 | SKH51 | 63 | 31 |
| 78 | None | ◯ | ◯ | SCM440 | 30 | SUS821L1 | 32 | SKH51 | 63 | 31 |
| 79 | None | ◯ | ◯ | SCM440 | 30 | SUS821L1 | 32 | SKH51 | 63 | 31 |
| 80 | None | ◯ | ◯ | SCM440 | 30 | SUS821L1 | 32 | SKH51 | 63 | 31 |
| 81 | None | ◯ | ◯ | SCM440 | 30 | SUS821L1 | 32 | SKH51 | 63 | 31 |
| 82 | None | ◯ | ◯ | SCM440 | 30 | SUS821L1 | 32 | SKH51 | 63 | 31 |
| 83 | None | ◯ | ◯ | SCM440 | 30 | SUS821L1 | 32 | SKH51 | 63 | 31 |
| 84 | None | ◯ | ◯ | SCM440 | 30 | SUS821L1 | 32 | SKH51 | 63 | 31 |
| 85 | None | ◯ | ◯ | SCM440 | 30 | SUS821L1 | 32 | SKH51 | 63 | 31 |
| 86 | None | ◯ | ◯ | SCM440 | 30 | SUS821L1 | 32 | SKH51 | 63 | 31 |
| 87 | None | ◯ | ◯ | — | — | SUS821L1 | 32 | SKH51 | 63 | 31 |
| C.E. 1 | None | ◯ | ◯ | SCM440 | 30 | SUS821L1 | 32 | SKH51 | 63 | 31 |
| C.E. 2 | None | ◯ | ◯ | SCM440 | 30 | SUS821L1 | 32 | SKH51 | 63 | 31 |
| C.E. 3 | None | ◯ | ◯ | SCM440 | 30 | SUS821L1 | 32 | SKH51 | 63 | 31 |
| C.E. 4 | None | ◯ | ◯ | SUS821L1 | 32 | — | — | — | — | — |
| C.E. 5 | None | ◯ | ◯ | SCM440 | 30 | SUS821L1 | 32 | SKH51 | 63 | 31 |

The various items in the tables denote the following.

The number of the processing member shape represents the number of the respective rotating member in FIG. 16-1, FIG. 16-2 and FIG. 16-3.

“A—Start point position” denotes whether or not the starting point 113 of the projecting parts is present between the straight line E and the straight line G (FIG. 11) (∘ (Yes) if present, × (No) if not present).

“B—End point position” denotes whether or not the end point 114 of the projecting parts is present on the far side of the straight line G as viewed from the straight line H (FIG. 11) (∘(Yes) if present, × (No) if not present).

“C—Pinching shape” denotes whether or not the processing member is fitted with the rotating member main portion in a manner so as to pinch the projecting parts in the radial direction (∘ (Yes) if so, × (No) if not so).

“D—Supporting member” denotes whether or not the rotating member main portion has a supporting member (∘ (Yes) if so, × (No) if not so).

“E—Projecting parts of supporting member” denotes whether or not the supporting member has a projecting parts (∘ (Yes) if so, × (No) if not so).

“F—Parallel surface” denotes whether or not the surface of the support on the protrusion side of the projecting parts (downstream in the rotation direction) has a surface that is parallel to the surface of the processing member on the protrusion side of the projecting parts (i.e. positioned downstream in the rotation direction) (∘ (Yes) if so, × (No) if not so).

“G—Center of gravity” denotes whether or not the center of gravity of the processing member is positioned closer to the protrusion side of the projecting parts than the center of gravity of the protruding portion (i.e. positioned downstream in the rotation direction) (∘ (Yes) if so, × (No) if not so).

Further, 500 L denotes that the base device is FM mixer by Nippon Coke & Engineering Co., Ltd., model: FM500 L.

Fastener (1) indicates whether or not fixing is accomplished by way of a fixing member such as a bolt pin, in a direction parallel to the drive shaft. (∘ if so fixed)

Fastener (2) indicates whether or not fixing is accomplished by way of a fixing means such as a screw, from the inward side of the rotating member outwards, in the radial direction (∘ if so fixed).

The hardness difference denotes a value of: (hardness of processing member)-(hardness of part A).

C. E. denotes Comparative Example.

TABLE 2-1

| | Peripheral | Toner | | Hydrophobic | |
|---|---|---|---|---|---|
| | speed | particle | | silica | |
| | (m/s) | No. | Amount | No. | Amount |
| Example 1 | 45 | 1 | 100 kg | 1 | 2.5 |
| Example 2 | 32 | 1 | 100 kg | 1 | 2.5 |
| Example 3 | 22 | 1 | 100 kg | 1 | 2.5 |
| Example 4 | 15 | 1 | 100 kg | 1 | 2.5 |
| Example 5 | 45 | 1 | 100 kg | 2 | 2.5 |
| Example 6 | 45 | 1 | 100 kg | 3 | 2.5 |
| Example 7 | 45 | 1 | 100 kg | 4 | 2.5 |
| Example 8 | 45 | 1 | 100 kg | 1 | 0.5 |
| Example 9 | 45 | 1 | 100 kg | 1 | 1.5 |
| Example 10 | 45 | 1 | 100 kg | 1 | 5 |
| Example 11 | 45 | 1 | 100 kg | 1 | 7 |
| Example 12 | 45 | 1 | 100 kg | 1 | 2.5 |
| Example 13 | 45 | 1 | 100 kg | 1 | 2.5 |
| Example 14 | 45 | 1 | 100 kg | 1 | 2.5 |
| Example 15 | 45 | 2 | 100 kg | 1 | 2.5 |
| Example 16 | 45 | 3 | 100 kg | 1 | 2.5 |
| Example 17 | 45 | 4 | 100 kg | 1 | 2.5 |
| Example 18 | 45 | 5 | 140 kg | 1 | 2.5 |
| Example 19 | 45 | 9 | 100 kg | 1 | 2.5 |
| Example 20 | 45 | 10 | 100 kg | 1 | 2.5 |
| Example 21 | 45 | 11 | 100 kg | 1 | 2.5 |
| Example 22 | 45 | 6 | 100 kg | 1 | 2.5 |
| Example 23 | 45 | 7 | 100 kg | 1 | 2.5 |
| Example 24 | 45 | 8 | 100 kg | 1 | 2.5 |
| Example 25 | 45 | 1 | 100 kg | 1 | 2.5 |
| Example 26 | 45 | 1 | 100 kg | 1 | 2.5 |
| Example 27 | 45 | 1 | 100 kg | 1 | 2.5 |
| Example 28 | 45 | 1 | 100 kg | 1 | 2.5 |
| Example 29 | 45 | 1 | 100 kg | 1 | 2.5 |
| Example 30 | 45 | 1 | 100 kg | 1 | 2.5 |
| Example 31 | 45 | 1 | 100 kg | 1 | 2.5 |
| Example 32 | 45 | 1 | 100 kg | 1 | 2.5 |
| Example 33 | 45 | 1 | 100 kg | 1 | 2.5 |
| Example 34 | 45 | 1 | 100 kg | 1 | 2.5 |
| Example 35 | 45 | 1 | 100 kg | 1 | 2.5 |
| Example 36 | 45 | 1 | 100 kg | 1 | 2.5 |
| Example 37 | 45 | 1 | 100 kg | 1 | 2.5 |
| Example 38 | 45 | 1 | 100 kg | 1 | 2.5 |
| Example 39 | 45 | 1 | 100 kg | 1 | 2.5 |
| Example 40 | 45 | 1 | 100 kg | 1 | 2.5 |
| Example 41 | 45 | 1 | 100 kg | 1 | 2.5 |
| Example 42 | 45 | 1 | 100 kg | 1 | 2.5 |
| Example 43 | 45 | 1 | 100 kg | 1 | 2.5 |
| Example 44 | 45 | 1 | 100 kg | 1 | 2.5 |
| Example 45 | 45 | 1 | 100 kg | 1 | 2.5 |
| Example 46 | 45 | 1 | 100 kg | 1 | 2.5 |
| Example 47 | 45 | 1 | 100 kg | 1 | 2.5 |
| Example 48 | 45 | 1 | 100 kg | 1 | 2.5 |
| Example 49 | 45 | 1 | 100 kg | 1 | 2.5 |
| Example 50 | 45 | 1 | 100 kg | 1 | 2.5 |

TABLE 2-2

| | Peripheral | Toner | | Hydrophobic | |
|---|---|---|---|---|---|
| | speed | particle | | silica | |
| | (m/s) | No. | Amount | No. | Amount |
| Example 51 | 45 | 1 | 100 kg | 1 | 2.5 |
| Example 52 | 45 | 1 | 100 kg | 1 | 2.5 |
| Example 53 | 45 | 1 | 100 kg | 1 | 2.5 |
| Example 54 | 45 | 1 | 100 kg | 1 | 2.5 |
| Example 55 | 45 | 1 | 100 kg | 1 | 2.5 |
| Example 56 | 45 | 1 | 100 kg | 1 | 2.5 |
| Example 57 | 45 | 1 | 100 kg | 1 | 2.5 |
| Example 58 | 45 | 1 | 100 kg | 1 | 2.5 |
| Example 59 | 45 | 1 | 100 kg | 1 | 2.5 |
| Example 60 | 45 | 1 | 100 kg | 1 | 2.5 |
| Example 61 | 45 | 1 | 100 kg | 1 | 2.5 |
| Example 62 | 45 | 1 | 100 kg | 1 | 2.5 |
| Example 63 | 45 | 1 | 100 kg | 1 | 2.5 |
| Example 64 | 45 | 1 | 100 kg | 1 | 2.5 |
| Example 65 | 45 | 1 | 100 kg | 1 | 2.5 |
| Example 66 | 45 | 1 | 100 kg | 1 | 2.5 |
| Example 67 | 45 | 1 | 100 kg | 1 | 2.5 |
| Example 68 | 45 | 1 | 100 kg | 1 | 2.5 |
| Example 69 | 45 | 1 | 100 kg | 1 | 2.5 |
| Example 70 | 45 | 1 | 100 kg | 1 | 2.5 |
| Example 71 | 45 | 1 | 100 kg | 1 | 2.5 |
| Example 72 | 45 | 1 | 100 kg | 1 | 2.5 |
| Example 73 | 45 | 1 | 100 kg | 1 | 2.5 |
| Example 74 | 45 | 1 | 100 kg | 1 | 2.5 |
| Example 75 | 45 | 1 | 100 kg | 1 | 2.5 |
| Example 76 | 45 | 1 | 100 kg | 1 | 2.5 |
| Example 77 | 45 | 1 | 100 kg | 1 | 2.5 |
| Example 78 | 45 | 1 | 100 kg | 1 | 2.5 |
| Example 79 | 45 | 1 | 4 kg | 1 | 2.5 |
| Example 80 | 45 | 1 | 100 kg | 1 | 2.5 |
| Example 81 | 45 | 1 | 100 kg | 1 | 2.5 |
| Example 82 | 45 | 1 | 100 kg | 1 | 2.5 |
| Example 83 | 45 | 1 | 100 kg | 1 | 2.5 |
| Example 84 | 45 | 1 | 100 kg | 1 | 2.5 |
| Example 85 | 45 | 1 | 100 kg | 1 | 2.5 |
| Example 86 | 45 | 1 | 100 kg | 1 | 2.5 |
| Example 87 | 45 | 1 | 100 kg | 1 | 2.5 |
| Comparative Example 1 | 45 | 1 | 100 kg | 1 | 2.5 |
| Comparative Example 2 | 45 | 1 | 100 kg | 1 | 2.5 |
| Comparative Example 3 | 45 | 1 | 100 kg | 1 | 2.5 |
| Comparative Example 4 | 45 | 1 | 100 kg | 1 | 2.5 |
| Comparative Example 5 | 45 | 1 | 100 kg | 1 | 2.5 |

TABLE 3-1

| | Processing member | | | Deformation of | | | Tuck-up of rotating | | | Wear of | Load | |
|---|---|---|---|---|---|---|---|---|---|---|---|---|
| | detachment | | | fitting portion | | | member main portion | | | process- | at the | Toner |
| | 1000-th | 5000-th | 10000-th | 1000-th | 5000-th | 10000-th | 1000-th | 5000-th | 10000-th | ing | replace- | clogging |
| | set | set | set | set | set | set | set | set | set | member | ment | in gap |
| Example 1 | A | A | A | A | A | A | A | A | A | B | A | A |
| Example 2 | A | A | A | A | A | A | A | A | A | B | A | A |
| Example 3 | A | A | A | A | A | A | A | A | A | B | A | A |
| Example 4 | A | A | A | A | A | A | A | A | A | B | A | A |
| Example 5 | A | A | A | A | A | A | A | A | A | B | A | A |
| Example 6 | A | A | A | A | A | A | A | A | A | B | A | A |
| Example 7 | A | A | A | A | A | A | A | A | A | B | A | A |
| Example 8 | A | A | A | A | A | A | A | A | A | B | A | A |
| Example 9 | A | A | A | A | A | A | A | A | A | B | A | A |
| Example 10 | A | A | A | A | A | A | A | A | A | B | A | A |
| Example 11 | A | A | A | A | A | A | A | A | A | B | A | A |
| Example 12 | A | A | A | A | A | A | A | A | A | A | A | A |
| Example 13 | A | A | A | A | A | A | A | A | A | A | A | A |
| Example 14 | A | A | A | A | A | A | A | A | A | A | A | A |
| Example 15 | A | A | A | A | A | A | A | A | A | B | A | A |
| Example 16 | A | A | A | A | A | A | A | A | A | B | A | A |
| Example 17 | A | A | A | A | A | A | A | A | A | B | A | A |
| Example 18 | A | A | A | A | A | A | A | A | A | B | A | A |
| Example 19 | A | A | A | A | A | A | A | A | A | B | A | A |
| Example 20 | A | A | A | A | A | A | A | A | A | B | A | A |
| Example 21 | A | A | A | A | A | A | A | A | A | B | A | A |
| Example 22 | A | A | A | A | A | A | A | A | A | B | A | A |
| Example 23 | A | A | A | A | A | A | A | A | A | B | A | A |
| Example 24 | A | A | A | A | A | A | A | A | A | B | A | A |
| Example 25 | A | A | A | A | A | A | A | A | A | B | A | A |
| Example 26 | A | A | A | A | A | A | A | A | A | B | A | A |
| Example 27 | A | A | A | A | A | A | A | A | B | B | B | A |
| Example 28 | A | A | A | A | A | A | A | A | A | B | A | A |
| Example 29 | A | A | A | A | A | A | A | A | A | B | A | A |
| Example 30 | A | A | A | A | A | A | A | A | A | B | A | A |
| Example 31 | A | A | A | A | A | A | A | A | A | B | A | A |
| Example 32 | A | A | A | A | A | A | A | A | A | B | A | A |
| Example 33 | A | A | A | A | A | A | A | A | A | B | A | A |
| Example 34 | A | A | A | A | A | A | A | A | A | C | A | A |
| Example 35 | A | A | A | A | A | B | A | A | A | C | B | A |
| Example 36 | A | A | B | A | B | B | A | A | A | B | B | A |
| Example 37 | A | A | A | A | A | A | A | A | A | B | A | A |
| Example 38 | A | A | A | A | A | A | A | A | A | B | A | A |
| Example 39 | A | A | A | A | A | A | A | A | A | B | A | A |
| Example 40 | A | A | A | A | A | A | A | A | A | B | A | A |
| Example 41 | A | A | A | A | A | A | A | A | A | B | A | A |
| Example 42 | A | A | A | A | A | A | A | A | A | B | A | A |
| Example 43 | A | A | A | A | A | A | A | A | A | B | A | A |
| Example 44 | A | A | A | A | A | A | A | A | A | B | A | A |
| Example 45 | A | A | A | A | A | A | A | A | A | B | A | A |
| Example 46 | A | A | A | A | A | A | A | A | A | B | A | A |
| Example 47 | A | A | A | A | A | A | A | A | A | B | A | A |
| Example 48 | A | A | A | A | A | A | A | A | A | B | A | A |
| Example 49 | A | A | A | A | A | A | A | A | A | B | A | A |
| Example 50 | A | A | A | A | A | A | A | A | A | B | A | A |

TABLE 3-2

| | Processing member | | | Deformation of | | | Tuck-up of rotating | | | Wear of | Load | |
|---|---|---|---|---|---|---|---|---|---|---|---|---|
| | detachment | | | fitting portion | | | member main portion | | | process- | at the | Toner |
| | 1000-th | 5000-th | 10000-th | 1000-th | 5000-th | 10000-th | 1000-th | 5000-th | 10000-th | ing | replace- | clogging |
| | set | set | set | set | set | set | set | set | set | member | ment | in gap |
| Example 51 | A | A | A | A | A | A | A | A | A | B | A | A |
| Example 52 | A | A | A | A | A | B | A | A | A | B | A | A |
| Example 53 | A | A | A | A | A | A | A | A | A | B | A | A |
| Example 54 | A | A | A | A | A | A | A | A | A | B | A | A |
| Example 55 | A | A | A | A | A | A | A | A | A | B | A | A |
| Example 56 | A | A | A | A | A | A | A | A | A | B | A | A |
| Example 57 | A | B | B | A | A | B | A | B | C | B | C | C |
| Example 58 | A | A | C | A | A | C | A | B | B | B | C | A |
| Example 59 | A | A | C | A | A | C | A | B | B | B | C | A |
| Example 60 | A | A | C | A | A | C | A | B | B | B | C | A |
| Example 61 | A | A | C | A | A | C | A | B | B | B | C | A |
| Example 62 | A | A | C | A | A | C | A | B | B | B | C | A |
| Example 63 | A | B | B | A | A | B | A | B | C | B | C | A |
| Example 64 | A | B | C | A | A | C | A | B | C | B | C | A |
| Example 65 | A | A | B | A | A | A | A | A | A | B | A | A |
| Example 66 | A | A | B | A | A | B | A | A | A | B | A | A |
| Example 67 | A | A | B | A | A | A | A | A | A | B | A | A |
| Example 68 | A | A | B | A | A | A | A | A | A | B | A | A |
| Example 69 | A | A | B | A | A | A | A | A | A | B | A | A |
| Example 70 | A | A | B | A | A | A | A | A | A | B | A | A |
| Example 71 | A | A | B | A | A | A | A | A | A | B | A | A |
| Example 72 | A | A | C | A | A | A | A | A | A | B | A | A |
| Example 73 | A | B | B | A | A | B | A | A | A | B | A | B |
| Example 74 | A | A | A | A | A | A | A | A | A | B | A | A |
| Example 75 | A | A | A | A | A | A | A | A | A | B | A | A |
| Example 76 | A | A | A | A | A | B | A | B | B | B | A | A |
| Example 77 | A | A | A | A | A | A | A | A | A | B | A | A |
| Example 78 | A | A | A | A | A | A | A | A | A | B | A | A |
| Example 79 | A | A | A | A | A | A | A | A | A | B | A | A |
| Example 80 | A | A | A | A | A | A | A | A | A | B | A | A |
| Example 81 | A | A | A | A | A | A | A | A | A | B | A | A |
| Example 82 | A | A | B | A | A | A | A | A | A | B | A | A |
| Example 83 | A | A | B | A | A | A | A | A | A | B | A | A |
| Example 84 | A | A | A | A | A | A | A | A | A | B | A | A |
| Example 85 | A | A | A | A | A | A | A | A | A | B | A | A |
| Example 86 | A | A | A | A | A | A | A | A | A | B | A | A |
| Example 87 | A | A | A | A | A | A | A | A | A | B | B | A |
| C.E. 1 | B | C | D | B | B | C | A | B | C | B | A | B |
| C.E. 2 | B | C | D | D | D | D | B | C | C | B | A | B |
| C.E. 3 | D | D | D | D | D | D | B | C | C | B | A | A |
| C.E. 4 | — | — | — | — | — | — | — | — | — | C | D | — |
| C.E. 5 | B | C | D | B | C | D | A | B | C | B | D | A |

The various items in the tables denote the following.

“Deformation of fitting portion” denotes “Deformation of fitting portion of processing member and rotating member main portion comprising projecting parts”.

“Load at the replacement” denotes “Load at the time of replacement of processing member”.

“Toner clogging in gap” denotes “Toner clogging in gap between rotating member main portion and processing member”.

C.E. denotes Comparative Example.

TABLE 4-1

| | Coverage ratio of | | | Fixing index of | | |
|---|---|---|---|---|---|---|
| | inorganic fine particles | | | inorganic fine particles | | |
| | 1000-th set | 5000-th set | 10000-th set | 1000-th set | 5000-th set | 10000-th set |
| Example 1 | A | A | A | A | A | A |
| Example 2 | A | A | A | A | A | A |
| Example 3 | A | A | A | A | A | A |
| Example 4 | A | A | A | A | A | A |
| Example 5 | A | A | A | A | A | A |
| Example 6 | A | A | A | A | A | A |
| Example 7 | A | A | A | A | A | A |
| Example 8 | A | A | A | A | A | A |
| Example 9 | A | A | A | A | A | A |
| Example 10 | A | A | A | A | A | A |
| Example 11 | A | A | A | A | A | A |
| Example 12 | A | A | A | A | A | A |
| Example 13 | A | A | A | A | A | A |
| Example 14 | A | A | A | A | A | A |
| Example 15 | A | A | A | A | A | A |
| Example 16 | A | A | A | A | A | A |
| Example 17 | A | A | A | A | A | A |
| Example 18 | A | A | A | A | A | A |
| Example 19 | A | A | A | A | A | A |
| Example 20 | A | A | A | A | A | A |
| Example 21 | A | A | A | A | A | A |
| Example 22 | A | A | A | A | A | A |
| Example 23 | A | A | A | A | A | A |
| Example 24 | A | A | A | A | A | A |
| Example 25 | A | A | A | A | A | A |
| Example 26 | A | A | A | A | A | A |
| Example 27 | A | A | A | A | A | A |
| Example 28 | A | A | A | A | A | A |
| Example 29 | A | A | A | A | A | A |
| Example 30 | A | A | A | A | A | A |
| Example 31 | A | A | A | A | A | A |
| Example 32 | A | A | A | A | A | A |
| Example 33 | A | A | A | A | A | A |
| Example 34 | A | A | A | A | A | B |
| Example 35 | A | A | A | A | A | B |
| Example 36 | A | A | B | A | B | B |
| Example 37 | A | A | A | A | A | A |
| Example 38 | A | A | A | A | A | A |
| Example 39 | A | A | A | A | A | A |
| Example 40 | A | A | A | A | A | A |
| Example 41 | A | A | A | A | A | A |
| Example 42 | A | A | A | A | A | A |
| Example 43 | A | A | A | A | A | A |
| Example 44 | A | A | A | A | A | A |
| Example 45 | A | A | A | A | A | A |
| Example 46 | A | A | A | A | A | A |
| Example 47 | A | A | A | A | A | A |
| Example 48 | A | A | A | A | A | A |
| Example 49 | A | A | A | A | A | A |
| Example 50 | A | A | A | A | A | A |

TABLE 4-2

| | Coverage ratio of | | | Fixing index of | | |
|---|---|---|---|---|---|---|
| | inorganic fine particles | | | inorganic fine particles | | |
| | 1000-th set | 5000-th set | 10000-th set | 1000-th set | 5000-th set | 10000-th set |
| Example 51 | A | A | A | A | A | A |
| Example 52 | A | A | A | A | A | B |
| Example 53 | A | A | A | A | A | A |
| Example 54 | A | A | A | A | A | A |
| Example 55 | A | A | A | A | A | A |
| Example 56 | A | A | A | A | A | A |
| Example 57 | A | B | B | A | A | B |
| Example 58 | A | A | C | A | A | C |
| Example 59 | A | A | C | A | A | C |
| Example 60 | A | A | C | A | A | C |
| Example 61 | A | A | C | A | A | C |
| Example 62 | A | A | C | A | A | C |
| Example 63 | A | B | B | A | A | B |
| Example 64 | A | B | C | A | A | C |
| Example 65 | A | A | B | A | A | A |
| Example 66 | A | A | B | A | A | B |
| Example 67 | A | A | B | A | A | A |
| Example 68 | A | A | B | A | A | A |
| Example 69 | A | A | B | A | A | A |
| Example 70 | A | A | B | A | A | A |
| Example 71 | A | A | B | A | A | A |
| Example 72 | A | A | B | A | A | A |
| Example 73 | A | B | B | A | A | B |
| Example 74 | A | A | A | A | A | A |
| Example 75 | A | A | A | A | A | A |
| Example 76 | A | A | A | A | A | B |
| Example 77 | A | A | A | A | A | A |
| Example 78 | A | A | A | A | A | A |
| Example 79 | A | A | A | A | A | A |
| Example 80 | A | A | A | A | A | A |
| Example 81 | A | A | A | A | A | A |
| Example 82 | A | A | B | A | A | A |
| Example 83 | A | A | B | A | A | A |
| Example 84 | A | A | A | A | A | A |
| Example 85 | A | A | A | A | A | A |
| Example 86 | A | A | A | A | A | A |
| Example 87 | A | A | A | A | A | A |
| C.E. 1 | B | C | C | B | B | C |
| C.E. 2 | B | C | D | D | D | D |
| C.E. 3 | D | D | D | D | D | D |
| C.E. 4 | A | B | C | A | B | C |
| C.E. 5 | B | C | D | B | C | D |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2021-138732, filed Aug. 27, 2021, which is hereby incorporated by reference herein in its entirety.

What is claimed is:

1. A toner processing apparatus for processing an object to be processed comprising a toner particle and an external additive,
the toner processing apparatus comprising:
a processing chamber in which the object to be processed is accommodated;
a drive shaft rotatably provided at a bottom portion of the processing chamber; and
a rotating member pivotally supported on the drive shaft; wherein
the rotating member comprises
a rotating member main portion; and
a protruding portion protruding outward in a radial direction from an outer peripheral portion of the rotating member main portion;
the rotating member comprises a processing member processing the object to be processed by colliding against the object to be processed at the protruding portion;
the processing member constitutes a part of the protruding portion or an entirety of the protruding portion;
the rotating member main portion and the processing member can be separated;
the rotating member main portion comprises a projecting parts protruding in a direction in which the rotating member rotates; and
the processing member fits with the projecting parts.

2. A toner processing apparatus for processing an object to be processed comprising a toner particle and an external additive,
the toner processing apparatus comprising:
a processing chamber in which the object to be processed is accommodated;
a drive shaft rotatably provided at a bottom portion of the processing chamber; and
a rotating member pivotally supported on the drive shaft; wherein,
the rotating member comprises
a rotating member main portion; and
a protruding portion protruding outward in a radial direction from an outer peripheral portion of the rotating member main portion;
the rotating member comprises a processing member processing the object to be processed by colliding against the object to be processed at the protruding portion;
the processing member constitutes a part of the protruding portion or an entirety of the protruding portion;
the rotating member main portion and the processing member can be separated;
the rotating member main portion comprises a projecting parts protruding in at least one direction of a circumferential direction of the rotating member; and
the processing member fits with the projecting parts.

3. The toner processing apparatus of claim 1, wherein the processing member fits with the rotating member main portion in a manner so as to pinch the projecting parts in the radial direction.

4. The toner processing apparatus of claim 1, wherein
the rotating member main portion has a supporting member protruding from the rotating member main portion towards the protruding portion, and
the supporting member supports the processing member from a starting point side of a protrusion of the projecting parts.

5. The toner processing apparatus of claim 4, wherein the supporting member has the projecting parts.

6. The toner processing apparatus of claim 4, wherein a surface of the supporting member on a protrusion side of the projecting parts has a surface parallel to a surface of the processing member on the protrusion side of the projecting parts.

7. The toner processing apparatus of claim 1, wherein
the processing member has a substrate and a coating layer of a surface of the substrate;
an HRC hardness of the substrate is higher than an HRC hardness of the rotating member main portion; and
an HRC hardness of the coating layer is higher than the HRC hardness of the substrate.

8. The toner processing apparatus of claim 1, wherein a center of gravity of the processing member is positioned on a protrusion direction side of the projecting parts further than a center of gravity of the protruding portion.

9. A method for producing a toner comprising a toner particle comprising a binder resin and an external additive, wherein,
the method comprising:
(i) a step of producing the toner particle comprising the binder resin; and
(ii) a step of performing a treatment of externally adding an external additive to the toner particle produced in step (i) by using the toner processing apparatus of claim 1.
